(19) United States
(12) Patent Application Publication
(10) Pub. No.: US 2006/0078754 A1
(43) Pub. Date: Apr. 13, 2006

(54) Optical film, polarizing plate and display

(75) Inventors: Takashi Murakami, Tokyo (JP); Isamu Michihata, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA OPTO, INC., Tokyo (JP)

(21) Appl. No.: 11/246,837

(22) Filed: Oct. 6, 2005

(30) Foreign Application Priority Data
Oct. 13, 2004 (JP) JP2004-298635

(51) Int. Cl. B32B 29/00; B29D 7/01; B29C 47/00

(52) U.S. Cl. 428/532; 264/1.34; 264/211; 264/187; 264/203; 264/207

(57) ABSTRACT

A method for producing an optical film comprising steps of mixing a heated and molten cellulose ester having an acylated degree for from 2.5 to 2.9 and at least one of a UV absorbent having at least two benzotriazole skeletons and a UV absorbent having a weight average molecular weight of from 2,000 to 50,000 to form a mixture, and extruding the mixture to form a film.

### FIELD OF THE INVENTION

The present invention relates to an optical film, a polarizing plate and a display, in detail, an optical film produced by simple producing equipment with high product efficiency, a polarizing plate and a display employing the optical film, in which white unevenness of the film caused by chalking is inhibited and unevenness of the hardness of an active radiation hardenable resin layer and line-shaped defect on an antireflection layer are difficultly formed and color unevenness is lowered.

### BACKGROUND OF THE INVENTION

Liquid crystal display (LCD) is widely applied for displaying apparatus such as a word processor, personal computer, television, monitor and mobile information terminal because the display can be operated with low voltage and low electric power consumption and directly connected to an IC circuit and can be made to a thin form. The LCD is basically constituted by, for example, a liquid crystal cell having polarizing plates on both sides thereof.

The polarizing plate is a plate capable of penetrating light polarized in a certain direction. Therefore, the LCD plays an important role for visualizing the variation in the orientation direction of the liquid crystal by an electric field. Consequently, the properties of the LCD are largely depending on those of the polarizing plate. The polarizing plate is generally constituted by a polarizing film such as a poly(vinyl alcohol) film, on which iodine or a dye is adsorbed in an oriented state, and a transparent resin layer is laminated on both of the surfaces of the plate. For the transparent resin layer, cellulose ester film such as triacetyl cellulose film is frequently employed since such the film has low double refractive index and suitable for the protective film.

Recently, the liquid crystal display is developed in stead of CRT for a monitor having large image size and high image quality. Requirements for the protective film for the polarizing plate of the liquid crystal display becomes sever, particularly, high anti-damage ability and anti-reflection ability are required to the polarizing plate protective film to be arranged on the surface of the watching side.

A solution casting method is commonly applied for producing the cellulose ester film; in such the method cellulose ester is dissolved in a solvent such as a halogenized solvent to prepare a solution so called to as dope, and the dope is cast on a rotating endless belt or drum as a support to form the film. After the casting, the film is solidified on the support by evaporation of a part of the solvent and peeled off from the support. After that, the remaining solvent is removed to obtain the cellulose ester film. In such the method, however, massive cost is required for equipment such as a drying line and apparatuses for recovering and recycling the evaporated solvent, drying energy and production since the solvent remaining in the film should be removed. Therefore, the cost reducing causes a problem.

For dissolving such the problem, the optical film described in Patent Document 1, which is cellulose ester film form by a melt-cascade method. It has been found by the inventors that the melt-cascade method tends to cause partial white turbid on the film so called to chalking unevenness and hardness unevenness in the active radiation hardenable resin layer and line-shaped defects in the antireflection layer, and that the optical film excellent in the optical and physical properties without color unevenness can be difficultly obtained even though the above loads to be applied to production is surely reduced by the melt-cascade method.

Patent Document 1: Tokkai 2000-352620

### SUMMARY OF THE INVENTION

Problems to be Solved

An object of the invention is to provide an optical film produced by simple producing equipment with high product efficiency, a polarizing plate and a display employing the optical film, in which white unevenness of the film caused by chalking is inhibited and unevenness of the hardness of an active radiation hardenable resin layer and line-shaped defect on an antireflection layer are difficultly formed and color unevenness is lowered.

Means for Solving the Problems

The object of the invention can be attained by the following constitution.

Item 1: An optical film produced by extruding and cooling a heated molten material comprising a cellulose resin having a total substituting ratio of acyl group of from 2.5 to 2.9, a plasticizer and a UV absorbent having a weight average molecular weight of from 490 to 50,000.

Item 2: The optical film of Item 1, in which the UV absorbent has two or more benzotriazole skeletons as the UV absorbing skeleton.

Item 3: The optical film of Item 1 or 2, in which the UV absorbent contains a UV absorbent having a weight average molecular weight of from 490 to 2,000 and a UV absorbent having a weight average molecular weight of from 2,000 to 50,000.

Item 4: The optical film of one of Items 1 through 3, in which at least one of the UV absorbents is a compound represented by Formula 1.

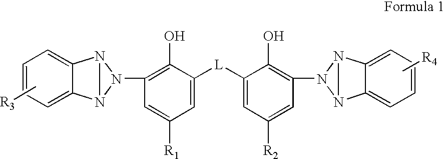

In the above formula, R₁ and R₂ are each a hydrogen atom, a substituted or unsubstituted alkyl group having from 1 to 20 carbon atoms, R₃ and R₄ are each a hydrogen atom or a halogen atom, and L is an alkylene group having from a to 4 carbon atoms.

Item 5: The optical film of one of Items 1 through 4, in which at least one of the UV absorbents is a copolymer of a UV absorbing monomer having a molar adsorption coefficient of not less than 4,000 at 380 nm and a ethylenic unsaturated monomer.

Item 6: The optical film of Item 5, in which the ethylenic unsaturated monomer contains an ethylenic unsaturated monomer having a hydrophilic group.

Item 7: The optical film of one of Items 1 through 6, in which at least one of the UV absorbents contains a polymer derived from a UV absorbing monomer represented by Formula 2

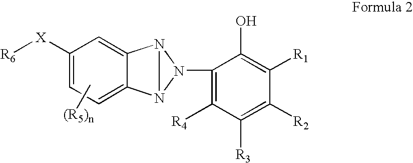

In the above formula, n is an integer of from 0 to 3, R₁ through R₅ are each a hydrogen atom, a halogen tom or a substituent, X is a —COO— group, a —CONR₇— group or an —NR₇CO— group, R₆ is a hydrogen atom, an alkyl group or an aryl group, and R₇ is a hydrogen atom, an alkyl group or an aryl group, provided that the group represented by R₆ has a polymerizable group as a partial structure.

Item 8: The optical film of one of Items 1 through 7, in which the plasticizer contains a phosphoric acid type plasticized in an amount of not more than 40% by weight of the total amount of the plasticizer in the film.

Item 9: The optical film of any one of Items 1 through 8, in which at least one of the plasticizers is selected from the group consisting of a poly-valent alcohol ester type plasticizer, a polyester type plasticizer, a citrate type plasticizer and a phthalate type plasticizer.

Item 10: The optical film of one of Items 1 through 9, in which the optical film contains a hindered amine compound or a hindered phenol compound in an amount of from 0.01 to 5% by weight.

Item 11: The optical film of one of Items 1 through 10, in which a remaining amount of sulfuric acid in the cellulose ester is within the range of from 0.1 to 45 ppm.

Item 12: The optical film of one of Items 1 through 11, in which an active radiation hardenable resin layer is provided on at least one surface of the film.

Item 13: The optical film of Item 12, in which an antireflection layer is provided on the active radiation hardenable resin layer.

Item 14: A polarizing plate having the optical film of one of Items 1 through 13 on one or both of the faces thereof.

Item 15: A displaying apparatus having the optical film of one of Items 1 through 13.

### EFFECTS OF THE INVENTION

An optical film produced by simple producing equipment with high product efficiency, a polarizing plate and a display employing the optical film, can be provided by the invention, in which white unevenness of the film caused by chalking is inhibited and unevenness of the hardness of an active radiation hardenable resin layer and line-shaped defect on an antireflection layer are difficultly formed and color unevenness is lowered.

### PREFERRED EMBODIMENTS OF THE INVENTION

Preferred embodiments of the invention are described in detail below, but the invention is not limited by the embodiments.

The optical film according to the invention, referred to as cellulose ester film in the invention, is characterized in that the film is formed by extruding and cooling a heated molten material comprising cellulose resin having the total acyl group substituting degree of from 2.5 to 2.9, a plasticizer and a UV absorbent having a weight average molecular weight of from 490 to 50,000.

The melt-cascade method in the invention is a method in which cellulose ester is molten by heating substantially with no solvent by a temperature at which the cellulose ester is liquefied, and a molten material containing the fluid cellulose ester is cascaded. In detail, the film formation by the heat-melting method can be classified into a melt-extrusion method, a press formation method, an inflation method, an injection forming method, a blow forming method and a stretching forming method. Among them, the melt-extrusion method is suitable for obtaining the optical film excellent in the mechanical strength and the surface precision. The melt producing method of the film of the invention includes a melt-extrusion method in which the constituting materials of the film is heated for obtaining the fluidity and then extruded out onto a drum or an endless belt to form the film.

Cellulose Ester

The cellulose resin relating to the invention has a cellulose ester structure and is a single or combined acids ester of cellulose containing an aliphatic acid acyl group or a substituted or unsubstituted aromatic acyl group.

The examples of cellulose ester useful for satisfying the object of the invention are described below. However, the cellulose ester is not limited to the followings.

In the aromatic acyl group, when the aromatic ring is a benzene ring, examples of the substituent of the benzene ring include a halogen atom, a cyano group, an alkyl group, an alkoxy group, an aryl group, an aryloxy group, an acyl group, a carbonamido group, a sulfonamido group, a ureido group, an aralkyl group, a nitro group, an alkoxycarbonyl group, an aryloxycarbonyl group, an aralkyloxycarbonyl group, a carbamoyl group, a sulfamoyl group, an acyloxy group, an alkenyl group, an alkynyl group, an alkylsulfonyl group, an arylsulphonyl group, an alkyloxysulfonyl group, an aryloxyslfonyl group, alkylsulfonyloxy group, an aryloxysulfonyl group, an —S—R group, an —NH—CO—OR group, a —PH—R group, a —P(—R)₂ group, a —PH—O—R group, a —P(—R)(—O—R) group, a —P(—O—R)₂ group, a —PH(═O)—R—P(═O)(—R)₂ group, a —PH—(═O)—O—R group, a —P(═O)(—R)(—O—R) group, a —P(═O)(—O—R)₂ group, an —O—PH(═O)—R group, an —O—P(═O)(—R)₂—O—PH—(═O)—O—R group, an —O—P(═O)(—R)(—O—R) group, an —O—P(═O)(—O—R)₂ group, an —NH—PH(═O)—R group, an —NH—P(═O)(—R)(—O—R) group, an —NH—P(═O)(—O—R)₂ group, an —SiH₂—R group, an —SiH(—R)₂ group, an —Si(—R)₃ group, an —O—SiH₂—R group, an —O—SiH(—R)₂ group and an —O—Si(—R)₃ group. In the above, R is an aliphatic group, aromatic group or a heterocyclic group. The number of the substituent is preferably from 1 to 5, more preferably from 1 to 4, further preferably from 1 to 3, and most preferably 1 or 2. As the substituent, the halogen atom, the cyano group, the alkyl group, the alkoxy group, the aryl group, the aryloxy group, the acyl group, the carbonamido group, the sulfonamido group and the ureido group are preferable, the hydrogen atom, the cyano group, the alkyl group, the alkoxy group, the aryloxy group, the acyl group and the carbonamido group are more preferable, the halogen atom, the cyano group, the alkyl group, the alkoxy group, the aryloxy group are further preferable, and the halogen atom, the alkyl group and the alkoxy group are most preferable.

The halogen tom includes a fluorine atom, a chlorine atom, a bromine atom and an iodine atom. The alkyl group may have a cyclic structure or a branched structure. The number of carbon atoms in the alkyl group is preferably from 1 to 20, more preferably from 1 to 12, further preferably from 1 to 6, and most preferably from 1 to 4. Examples of the alkyl group include a methyl group, an ethyl group, a propyl group, an isopropyl group, a butyl group, a t-butyl group, a hexyl group, a cyclohexyl group, an octyl group and a 2-ethylhexyl group. The above alkoxy group may have a cyclic or a branched structure. The number of carbon atoms in the alkoxy group is preferably from 1 to 20, more preferably from 1 to 12, further preferably from 1 to 6, and most preferably from 1 to 4. The alkoxy group may be substituted by another alkoxy group. Examples of the alkoxy group include a methoxy group, an ethoxy group, a 2-methoxyethoxy group, a 2-methoxy-2-ethocyethoxy group, a butoxy group, a hexyloxy group and an octyloxy group.

The number of carbon atom in the above aryl group is preferably from 6 to 20, and more preferably from 6 to 12. Examples of the aryl group a phenyl group and a naphthyl group. The number of carbon atom in the above aryloxy group is preferably from 6 to 20, and more preferably from 6 to 12. Examples of the aryloxy group include a phenoxy group and a naphthoxy group. The number of carbon atom in the above acyl group is preferably from 1 to 20, and more preferably from 1 to 12. Examples of the acyl group include a formyl group, an acetyl group and a benzoyl group. The number of carbon atom in the above carbonamido group is preferably from 1 to 20, and more preferably from 1 to 12. Examples of the carbonamido group include an acetoamido group and a benzamido group. The number of carbon atom in the above sulfonamido group is preferably from 1 to 20, and more preferably from 1 to 12. Examples of the sulfonamido group include a methanesulfonamido group and a p-toluenesulfonamido group. The number of carbon atom in the above ureido group is preferably from 1 to 20, and more preferably from 1 to 12. Examples of the ureido group include a unsubstituted or substituted ureido group.

The number of carbon atom in the above aralkyl group is preferably from 7 to 20, and more preferably from 7 to 12. Examples of the aralkyl group include a benzyl group, a phenethyl group and a naphthylmethyl group. The number of carbon atom in the above alkoxycarbonyl group is preferably from 1 to 20, and more preferably from 2 to 12. Examples of the alkoxycarbonyl group include a methoxycarbonyl group. The number of carbon atom in the above aryloxycarbonyl group is preferably from 7 to 20, and more preferably from 7 to 12. Examples of the aryloxycarbonyl group include a phenoxycarbonyl group. The number of carbon atom in the above aralkyloxy-carbonyl group is preferably from 8 to 20, and more preferably from 8 to 12. Examples of the aralkyloxycarbonyl group include a benzyloxycarbonyl group. The number of carbon atom in the above carbamoyl group is preferably from 1 to 20, and more preferably from 1 to 12. Examples of the carbamoyl group include a (unsubstituted) carbamoyl group and an N-methylcarbamoyl group. The number of carbon atom in the above sulfamoyl group is preferably not more than 20, and more preferably not more than 12. Examples of the sulfamoyl group include a (unsubstituted) sulfamoyl group and an N-methylsulfamoyl group. The number of carbon atom in the above acyloxy group is preferably from 1 to 20, and more preferably from 2 to 12. Examples of the acyloxy group include an acetoxy group and a benzoyloxy group.

The number of carbon atom in the above alkenyl group is preferably from 2 to 20, and more preferably from 2 to 12. Examples of the alkenyl group include a vinyl group, an allyl group and an isopropenyl group. The number of carbon atom in the above alkynyl group is preferably from 2 to 20, and more preferably from 2 to 12. Examples of the alkynyl group include a thienyl group. The number of carbon atom in the above alkylsulfonyl group is preferably from 1 to 20, and more preferably from 1 to 12. The number of carbon atom in the above arylsulfonyl group is preferably from 6 to 20, and more preferably from 6 to 12. The number of carbon atom in the above alkyloxysulfonyl group is preferably from 1 to 20, and more preferably from 1 to 12. The number of carbon atom in the above aryloxysulfonyl group is preferably from 6 to 20, and more preferably from 6 to 12. The number of carbon atom in the above alkylsulfonyloxy group is preferably from 1 to 20, and more preferably from 1 to 12. The number of carbon atom in the above arylsulfonyloxy group is preferably from 6 to 20, and more preferably from 6 to 12.

When the hydrogen atom at the hydroxyl group of the cellulose is forms an aliphatic acid ester with a aliphatic acyl group in the cellulose ester relating to the invention, the aliphatic acid group is a group having 2 to 20 carbon atoms, for example, an acetyl group, a propionyl group, a butylyl group, isobutylyl group, a valeryl group, a pivaloyl group, a hexanoyl group, an octanoyl group, a lauroyl group and a stearoyl group.

In the invention, the above aliphatic acyl group includes ones further having a substituent. As the substituent, ones exemplified as the substituent of the benzene ring of the above aromatic acyl group are applicable.

When the esterized substituent of the cellulose ester is an aromatic ring, the number of the substituent X substituted on the aromatic ring is 0 or 1 to 5, preferably from 1 to 3, and preferably from 1 to 3, and most preferably 1 or 2. When the number of the substituent on the aromatic ring is 2 or more, they may be the same or different and may be combined with together to form a condensed multi-ring compound such as naphthalene, indene, indane, phenanthrene, quinoline, iso-quinoline, chromene, chromane, phthaladine, acrydine, indole and indoline.

The cellulose ester to be employed in the invention has at least one of the substituted or unsubstituted aliphatic acyl group and the substituted or unsubstituted aromatic acyl group. The cellulose ester may be a single or combined acids ester or a mixture of two or more kinds of cellulose ester.

The cellulose ester relating to the invention is characterized in that the total acyl substitution degree is from 2.5 to 2.9.

Cellulose has three hydroxyl groups per a glucose unit, and the acyl substitution degree is a value representing the average number of acyl group bonded per glucose unit. Accordingly, the maximum value of the substituting degree is 3.0. These acyl groups may be equally substituted at the 2-, 3- and 6-position of the glucose unit or substituted with a distribution. The sum of the substitution degree is preferably from 1.5 to 1.95, more preferably from 1.7 to 1.95, and further preferably from 1.73 to 1.93. The acyl substitution degree at the 6-position is preferably 0.7 to 1.00, and more preferably from 0.85 to 0.98. It is preferable that the substitution degree at the 6-position is higher than that at the 2- or 3-position.

The examples of the cellulose ester preferably employable in the invention include a cellulose ester having the total substitution degree of 2.81 and the substitution degree at 6-position of 0.84, a cellulose ester having the total substitution degree of 2.82 and the substitution degree at 6-position of 0.85, a cellulose ester having the total substitution degree of 2.77 and the substitution degree at 6-position of 0.94, a cellulose ester having the total substitution degree of 2.72 and the substitution degree at 6-position of 0.88, a cellulose ester having the total substitution degree of 2.85 and the substitution degree at 6-position of 0.92, a cellulose ester having the total substitution degree of 2.70 and the substitution degree at 6-position of 0.89, a cellulose ester having the total substitution degree of 2.75 and the substitution degree at 6-position of 0.91, a cellulose ester having the total substitution degree of 2.80 and the substitution degree at 6-position of 0.86, a cellulose ester having the total substitution degree of 2.85 and the substitution degree at 6-position of 0.93, a cellulose ester having the total substitution degree of 2.74 and the substitution degree at 6-position of 0.84, a cellulose ester having the total substitution degree of 2.72 and the substitution degree at 6-position of 0.85, a cellulose ester having the total substitution degree of 2.78 and the substitution degree at 6-position of 0.92, a cellulose ester having the total substitution degree of 2.88 and the substitution degree at 6-position of 0.87, a cellulose ester having the total substitution degree of 2.84 and the substitution degree at 6-position of 0.87, a cellulose ester having the total substitution degree of 2.88 and the substitution degree at 6-position of 0.89, a cellulose ester having the total substitution degree of 2.9 and the substitution degree at 6-position of 0.95, a cellulose ester having the total substitution degree of 2.80 and the substitution degree at 6-position of 0.94, a cellulose ester having the total substitution degree of 2.75 and the substitution degree at 6-position of 0.87, a cellulose ester having the total substitution degree of 2.70 and the substitution degree at 6-position of 0.90, a cellulose ester having the total substitution degree of 2.70 and the substitution degree at 6-position of 0.82, and a cellulose ester having the total substitution degree of 2.70 and the substitution degree at 6-position of 0.82, are usable solely or in combination of two or more kinds thereof. In the case of the combination use, it is preferable to use a mixture of cellulose esters different from each other in the total substitution degree of from 0 to 0.5 is preferable, and a mixture of those different from each other in the total substitution degree of from 0.01 to 0.3 is more preferable, and a mixture of those different from each other in the total substitution degree of from 0.02 to 0.1 is further preferable. The total substitution degree is the sum of the substitution degree at the 2-, 3- and 6-positions.

The cellulose ester constituting the optical film of the invention is preferably one selected from cellulose acetate, cellulose propionate, cellulose butylate, cellulose acetate propionate, cellulose acetate butylate, cellulose acetate phthalate and cellulose phthalate.

Among the above, cellulose propionate, cellulose butylate, cellulose acetate propionate and cellulose acetate butylate are particularly preferred.

The preferable cellulose resin contains the combined ester of lower fatty acids such as cellulose acetate propionate and cellulose acetate butylate which has acyl groups each having 2 to 4 carbon atoms and satisfies the following expressions 1 and 2 at the same time when X is the substitution degree of acetyl group and Y is the substitution degree of propionyl group or butylyl group. The substitution degree of the acetyl group and that of the butylyl group are determined according to ASTM-D817-96.
2.5≦X+Y≦2.9 Expression 1
0≦X≦2.5 Expression 2

Among them, cellulose acetate propionate is particularly preferable and that satisfying the relations of 1.9≦X≦2.5 and 0.1≦Y≦0.9 is preferable. It is allowed that cellulose esters each different from each other in the acyl substitution degree are mixed so that the mixture satisfies the above relations in total. The portion of the cellulose not substituted by the acyl group is generally occupied by the hydroxyl group. Such the cellulose esters can be synthesized by a known method.

The cellulose ester preferably has a number average molecular weight of from 70,000 to 230,000, more preferably from 75,000 to 230,000, and further preferably from 78,000 to 120,000.

In the invention, a cellulose ester having a ratio of weight average molecular weight Mw to number average molecular weight Mn of from 1.3 to 5.5 is preferably employed, the ratio is more preferably from 1.5 to 5.0, further preferably from 1.7 to 3.0, and particularly preferably from 2.0 to 3.0.

The viscosity average polymerization degree (polymerization degree) of the cellulose ester to be employed in the invention is preferably from 200 to 700, and more preferably from 250 to 500. The optical film excellent in the mechanical strength can be obtained when the polymerization degree is within the above range.

The viscosity average polymerization degree (DP) is determined by the following method.

Measurement of the viscosity average polymerization degree (DP)

Zero point two grams of absolutely dried cellulose ester is precisely weighed and dissolved in 100 ml of a mixture solvent of methylene chloride and ethanol in a mixing ratio of 9:1 by weight. The falling time of the resultant solution was measured by an Ostwald viscometer at 25° C., and the polymerization degree is calculated by the following equations.
ηᵣₑₗ=T/Ts
[η]=(lnηᵣₑₗ)/C
DP=[η]/Km

In the above, T is the falling time in second of the measured sample, Ts is the falling time in second of the solvent, C is the concentration of the cellulose ester in g/l and Km is 6×10⁻⁴.

The alkali-earth metal content of the cellulose resin to be employed in the invention is preferably within the range of from 1 to 50 ppm. When the content exceeds 50 ppm, the contamination on the die lip is increased or the film tends to be broken on the occasion of the heat stretching or the slitting after the stretching. The film tends to be broken even when the content is less than 1 ppm; the reason of such the phenomenon is not cleared yet. It is also not desirable to reduce the content to less than 1 ppm because the load to the washing process becomes too large. The content is more preferably within the range of from 1 to 30 ppm. The alkali-earth metal content is the total content of calcium and magnesium, which can be measured by an X-ray photoelectron spectroscopic analyzer (XPS).

The remaining sulfuric acid content in the cellulose resin to be employed in the invention is preferably from 0.1 to 45 ppm in terms of sulfur. It is supposed that the sulfuric acid is contained in a salt state. A remaining sulfuric acid content exceeding 45 ppm is not desirable since the contamination on the die lip is increased and the film tends to be broken on the occasion of the heat stretching or the slitting after the stretching. Tough smaller sulfuric acid content is preferable; it is undesirable to reduce the content to less than 0.1 ppm since the load on the washing process becomes too large and the film tends to be broken. Though it is supposed that such the phenomenon is caused by any influence of the increasing of washing times; the reason is not cleared yet. The remaining sulfuric acid content is more preferably within the range of from 1 to 30 ppm. The remaining sulfuric acid content can be measured according to ASTM-D817-96.

The free acid content in the cellulose resin to be employed in the invention is preferably from 1 to 500 ppm. When the free acid content exceeds 500 ppm, the adhering material on the die lip is increased and the film tends to be broken. The content of less than 1 ppm is difficultly attained by washing. The content is more preferably from 1 to 100 ppm. The breaking of the film further difficultly occurs in such the range of the free acid content. The content is particularly preferably within the range of from 1 to 70 ppm. The free acid content can be measured according to ASTM-D817-96. The free acid content in the optical film is preferably from 1 to 500 ppm, though the content is usually less than 3,000 ppm.

The alkali-earth metal content and the remaining sulfuric acid content can be made to within the above range by sufficient washing compared to that in the case of the solution casting method. By such the treatment, the adhesion of the resin onto the die lip and the film excellent in the flatness can be obtained. Thus the film having suitable in the dimension stability, mechanical strength, transparency, anti-humid ability, Rt value and Ro value can be obtained.

The raw cellulose for the cellulose ester to be employed in the invention may be either wood pulp or cotton linter. The wood pulp may be conifer pulp or broad leaved tree pulp, and the conifer pulp is preferred. The cotton linter is preferably employed from the viewpoint of peeling ability on the occasion of film forming. Cellulose esters produced from them can be employed solely or in a suitably mixed state.

For example, cellulose ester derived form the cotton linter, that derived from the conifer pulp and that derived from the broad leaved tree pulp can be employed in a ratio of 100:0:0, 90:10:0, 85: 15:0, 50:50:0, 20:80:0, 10:90:0, 0:100:0, 0:0:100, 80:10:10, 85:0:15 and 40:30:30.

In the invention, a cellulose ether type resin, a vinyl type resin including a poly(vinyl acetate) type resin and a poly(vinyl alcohol) type resin, a cyclic olefin resin, a polyester type resin including an aromatic polyester, an aliphatic polyester and a copolymer thereof, or an acryl type resin including a copolymer thereof may be contained in the optical film in addition to the cellulose ester. The content of the resin other than the cellulose ester is preferably from 0.1 to 30% by weight.

UV Absorbent

The UV absorbent relating to the invention is a UV absorbent having a weight average molecular weight of from 490 to 50,000, and preferably a compound having at least two benzotriazole skeletons as the UV absorbing skeleton. It is preferable that the UV absorbent contains a compound having a weight average molecular weight of from 490 to 2,000 and a compound having a weight average molecular weight of from 2,000 to 50,000.

The UV absorbent relating to the invention is described in detail below.

As the UV absorbent, ones excellent in the absorbing ability for UV rays of wavelength of less than 370 nm and having low absorption for visible rays of not less than 400 nm are preferable from the viewpoint of the degradation prevention of the polarizing plate and the displaying apparatus caused by UV rays, and from the viewpoint of displaying ability of the liquid crystal. For example, an oxybenzophenone type compound, a benzotriazole type compound, a salicylate type compound, a benzophenone type compound, a cyanoacrylate type compound, a triazine type compound and a nickel complex type compound are employable. The UV absorbents described in Tokkai Hei 10-182621 and 8-337574 and the polymer UV absorbents described in Tokkai Hei 6-148430 are also employable.

Among these UV absorbent, ones having a weight average molecular weight within the range of from 490 to 50,000 is necessary for displaying the effects of the invention. When the weight average molecular weight is less than 490, the UV absorbent tend to be oozed out from the film surface and the film tends to be colored accompanied with aging, though the UV absorbent of the molecular weight of not more than 490 is usually employed. When the weight average molecular weight exceeds 50,000, the compatibility of the UV absorbent with the resin of the film tends to be considerably lowered.

It is also preferable embodiment that the UV absorbent relating to the invention contains UV absorbent A having a weight average molecular weight of from 490 to 2,00 and UV absorbent B having a weight average molecular weight of from 2,000 to 50,000. The mixing ratio of UV absorbent A to B is suitably selected from the range of from 1:99 to 99:1.

Example of the UV absorbent having a weight average molecular weight being within the range of the invention and having at least two benzotriazole skeletons is preferably a benzotriazolephenol compound represented by the foregoing Formula 1.

In the foregoing Formula 1, R₁ and R₂ are each a hydrogen atom or a substituted or unsubstituted alkyl group having 1 to 20 carbon atoms, and R₃ and R₄ are each a hydrogen atom, a halogen atom or an alkylene group having 1 to 4 carbon atoms.

Examples of the atom or group of the substituent of the alkyl group include a halogen atom such as a chlorine atom, a bromine atom and a fluorine atom, a hydroxyl group, a phenyl group which may be substituted with an alkyl group of a halogen atom.

Concrete examples of the bisbenzotriazolephenol compound represented by Formula 1 are as follows, but the compound is not limited to the followings.
1) RUVA-100/110 manufactured by Ootsuka Kagaku Co., Ltd.
2) RUVA-206 manufactured by Ootsuka Kagaku Co., Ltd.
3) Tinuvin-360 manufactured by Ciba Specialty Chemicals Co., Ltd.
4) Adecastab LA-31 manufactured by Asahi Denka Co., Ltd.
5) Adecastab LA-31RG manufactured by Asahi Denka Co., Ltd.

Moreover, it is preferable that at least one of the UV absorbents is a copolymer of a UV absorbing monomer having a molar absorption coefficient of not less than 4,000 at 380 nm and an ethylenic unsaturated monomer, and the ethylenic unsaturated monomer haing a hydrophilic group.

According to the invention, the optical film, in which the foregoing problems are solved, can be obtained by that the film contains the UV absorbing copolymer which is the copolymer of the UV absorbing monomer having a molar absorption coefficient of not less than 4,000 at 380 nm and the ethylenic unsaturated monomer and has a weight average molecular weight of from 490 to 50,000.

When the molar absorption coefficient is not less than 4,000, the UV absorbing ability is suitable and satisfactory UV cutting effect can be obtained. Therefore, the problem of yellow coloring of the film itself is solved and the transparency of the film is improved.

The monomer to be employed for the UV absorbing copolymer in the invention preferably has a molar absorption coefficient at 380 nm of not less than 4,000, more preferably not less than 8,000, and further preferably not less than 10,000. When the molar absorption coefficient at 380 nm is less than 4,000, a large adding amount of the UV absorbent is necessary for obtaining the desired UV absorbing ability so that the transparency of the film is considerably lowered by increasing in the haze or precipitation of the UV absorbent and the strength of the film is lowered.

The ratio of the absorbing coefficient at 380 nm to that at 400 nm of the UV absorbing monomer to be employed for the UV absorbing copolymer is preferably not less than 20.

In the invention, it is preferable that the monomer having the UV absorbing ability as higher as possible is contained in the UV absorbing copolymer for inhibiting the light absorption at 400 nm near the visible region and obtaining the required UV absorbing ability.

a. UV Absorbing Monomer

The UV absorbing monomer (UV absorbent) preferably has a molar absorption coefficient at 380 nm of less than 4,000, and a ratio of the absorption coefficient at 380 nm to that at 400 nm is not less than 20.

As the UV absorbing monomer, the following compounds have been known, for example, a salicylic acid type UV absorbent such as phenyl salicylate and p-tert-butyl salicylate, a benzophenone type UV absorbent such as 2,4-dihydroxybenzophenone and 2,2′-dihydroxy-4,4′-dimethoxybenzophenone, a benzotriazole type UV absorbent such as 2-(2′-hydroxy-3′-tert-butyo-5′-methylphenyl)-5-chlorobenzotriazole, 2-(2′-hydroxy-3′,5′-di-tert-butylphenyl-5-chlorobenzotriazole and 2-(2′-hydroxy-3′,5′-di-tert-amylphenyl-benzotriazole, a dicyanoacrylate type UV absorbent such as 2′-ethylhexyl-2-cyano-3,3-diphenyl acrylate and ethyl-2-cyano-3-(3′,4′-methylenedioxyphenyl) acrylate, a triazine type UV absorbent such as 2-(2′-hydroxy-4′-hexyloxyphenyl)-4,6-diphenyltriazine and the compounds described in Tokkai Sho 58-15677.

It is preferable in the invention that basic skeletons are suitable selected from the foregoing various types of UV absorbent, and a substituent having an ethylenic unsaturated bond is introduced in each of the skeletons for forming polymerizable compounds, and then ones having a absorption coefficient of not less than 4,000 are selected from the resultant compounds. In the invention, the benzotriazole type compounds are preferable for the UV absorbing monomer from the viewpoint of the storage stability. Particularly preferable UV absorbing monomer is ones represented by the following Formula 3.

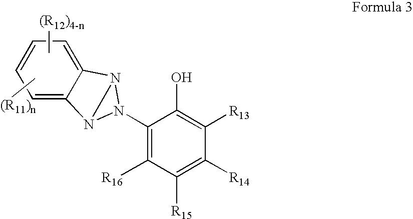

In Formula 3, the substituents represented by R₁₁ through R₁₆ each may have a substituent except that a specific limitation is applied.

In Formula 3, one of groups represented by R₁₁ through R₁₆ has the above-described polymerizable group as a partial structure.

In the formula, L is a di-valent bonding group or a simple bonding hand, and R₁ a hydrogen atom or an alkyl group. R₁ is preferably a hydrogen atom or an alkyl group having 1 to 4 carbon atoms. Though the group containing the foregoing polymerizable group may be any one of the groups represented by R₁₁ through R₁₆, the group represented by R₁₁, R₁₃, R₁₄ or R₁₅ is preferable, and the group represented by R₁₄ is particularly preferable.

In Formula 3, R₁₁ is a halogen atom, an oxygen atom, a nitrogen atom or a group substituting on the benzene ring through a sulfur atom. As the halogen atom, a fluorine atom, a chlorine atom and a bromine atom are applicable, and the chlorine atom is preferable.

Examples of the group substituting on the benzene ring through an oxygen atom include a hydroxyl group, an alkoxy group such as a methoxy group, an ethoxy group, a t-butoxy group and a 2-ethoxyethoxy group, an aryloxy group such as a phenoxy group, a 2,4-di-t-amylphenoxy group and a 4-(4-hydroxyphenyl-sulfonyl)phenoxy group, a heterocycloxy group such as a 4-pyridyloxy group and 2-hexahydropyrtanyloxy group, a carbonyloxy group, for example, an alkylcarbonyloxy group such as an acetyloxy group, a trifluoroacetyloxy group and a pivaloyloxy group, and an arylcarbonyloxy group such as a benzoyloxy group and a pentafluorobenzoyloxy group, a urethane group, for example, an alkylurethane group such as an N-dimethyluretane, and an arylurethane group such as an N-phenylurethane and an N-(p-cyanophenyl)urethane group, a sulfoxy group, for example, an alkylsulfoxy group such as a methanesulfonyloxy group, a trifluoromethanesulfonyloxy group an n-dodecanesulfonyloxy group, and an arylsulfonyloxy group such as a bebzenesulfonyloxy group and a p-toluenesulfonyloxy group. An alkoxy group having 1 to 6 carbon atoms is preferable and an alkyl group having 2 to 4 carbon atoms is particularly preferable.

Examples of the group substituting on the benzene ring through a nitrogen atom include a nitro group, an amino group, for example, an alkylamino group such as a dimethylamino group, a cyclohexylamino group and an n-dodecylamino group, and an arylamino group such as an anilino group and p-t-octylanilino group, a sulfonylamino group, for example, an alkylsuofonylamino group such as a methanesulfonylamino group, a heptafluoropropanesulfonylamino group and a hexadecylsulfonylamino group, and an arylsulfonylamino group such as a p-toluenesulfonylamino group and a pentafluorobenzenesulfonylamino group, a sulfamoylamino group, for example, an alkylsulfamoylamino group such as an N,N-dimethylsulfamoylamino group, and an arylsulfamoylamino group such as an N-phenylsulfamoylamino group, an acylamino group, for example, an alkylcarbonylamino group such as an acetylamino group and a myristoylamino group, and an arylcarbonylamino group such as a benzoylamino group, and a ureido group, for example, an alkylureido group such as an N,N-dimethylaminoureido group, and an arylureido group such as an N-phenylureido group and an N-(p-cyanophenyl)ureido group. Among them, the aminoacyl group is preferable.

Examples of the group substituting on the benzene ring through a sulfur atom include an alkylthio group such as a methylthio group and t-octylthio group, an arylthio group such as a phenylthio group, a heterocyclic-thio group such as a 1-phenylterazole-5-thio group and a 5-methyl-1,3,4-oxadiazole-2-thio group, a sulfinyl group, for example, an alkylsulfinyl group such as a methanesulfinyl group and a trifluoromethanesulfinyl group, and an arylsulfinyl group such as a p-toluenesulfinyl group, a sulfamoyl group, for example, an alkylsulfamoyl group such as a dimethylsulfamoyl group and a 4-(2,4-di-t-amylphenoxy)butylaminosulfamoyl group, and an arylsulfamoyl group such as a phenylsulfamoyl group. The sulfinyl group is preferable and an alkylsulfinyl group having 4 to 12 carbon atoms is particularly preferable.

In Formula 3, n is an integer of from 1 to 4, and preferably 1 or 2. When n is 2 or more, plural groups represented by R₁₁ may be the same as or different from each other. Though the substituting position of the substituent represented by R₁₁ is not specifically limited, 4- or 5-position is preferable.

In Formula 3, R₁₂ is a hydrogen atom or an aliphatic group such as an alkyl group, an alkenyl group and an alkynyl group, an aromatic group such as a phenyl group and a p-chlorophenyl group, or a heterocyclic group such as a 2-tetrahydrofuryl group, a 2-thiophenyl group, a 4-imidazolyl group, an indoline-1-yl group and a 2-pyridyl group. R₁₂ is preferably a hydrogen atom or an alkyl group.

In Formula 3, R₁₃ is, a hydrogen atom, an aliphatic group, an aromatic group or a heterocyclic group. R₁₃ is preferably a hydrogen atom or an alkyl group having 1 to 12 carbon atoms, or a branched alkyl group such as an i-propyl group, a t-butyl group-and a t-amyl group is preferable, which is excellent in the durability.

In Formula 3, R₁₄ is an oxygen atom or a group substituting on the benzene ring through an oxygen atom or a nitrogen atom, concretely a group the same as that the group substituting on the benzene ring through an oxygen atom or a nitrogen atom represented by R₁₁. R₁₄ is preferably an acylamino group or an alkoxy group. When the polymerizable group is contained in R₁₄ as a partial structure, R₁₄ is preferably the followings:

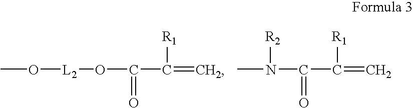

In the above formulas, L₂ is an alkylene group having 1 to 12 carbon atoms, and preferably a strait-chain alkylene group having 3 to 6 carbon atoms, branched-chain or cyclic alkylene group. R₁ is a hydrogen atom or a methyl group, R₂ is an alkyl group having 1 to 12, preferably 2 to 6, carbon atoms.

In Formula 3, R₁₅ is a hydrogen atom, an aliphatic group, an aromatic group or a heterocyclic group. R₁₅ is preferably a hydrogen atom or an alkyl group having 1 to 12 carbon atoms, and particularly preferably a branched-chain alkyl group such as an i-propyl group, a t-butyl group and a t-amyl group.

In Formula 3, R₁₆ is a hydrogen atom, an aliphatic group, an aromatic group or a heterocyclic group, and preferably a hydrogen atom.

Examples of UV absorbing monomer preferably employable in the invention are listed below, but the monomer is not limited to the examples.

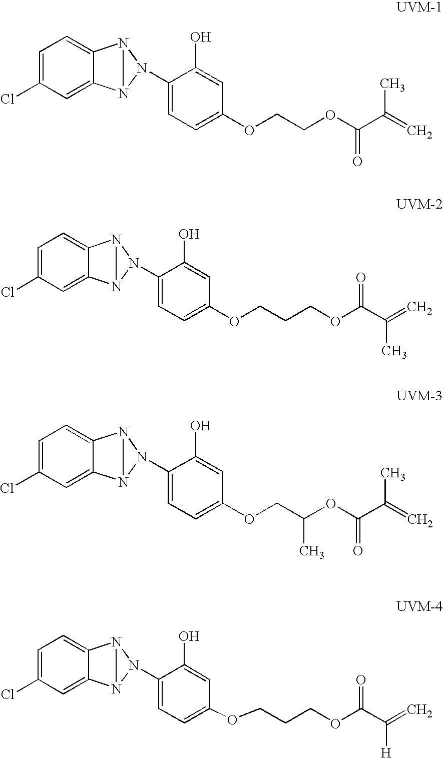

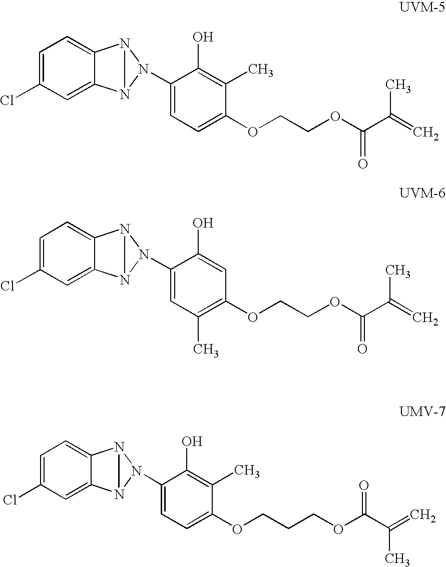

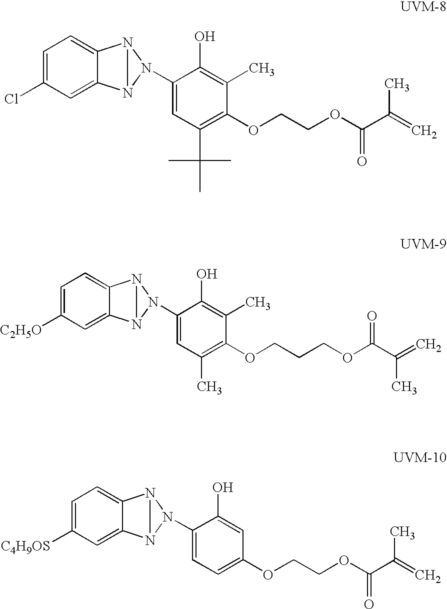

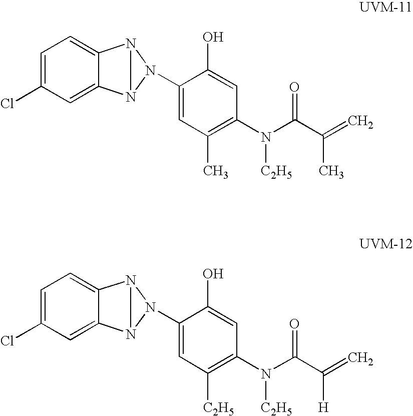

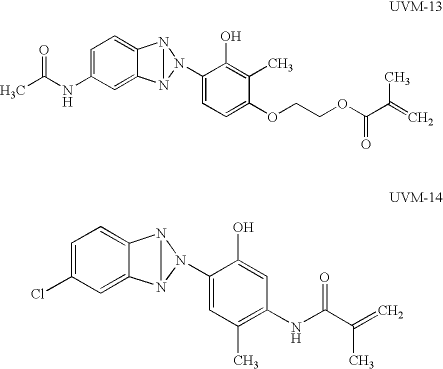

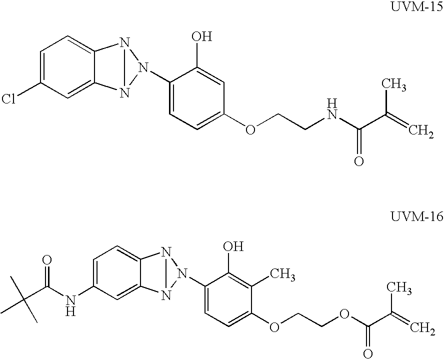

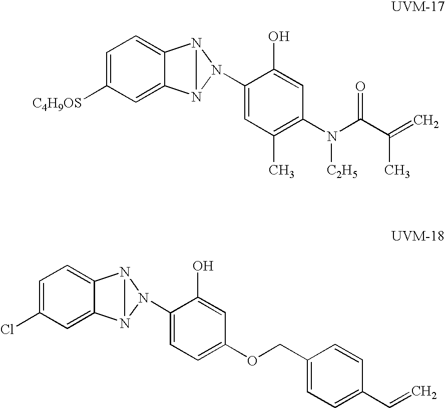

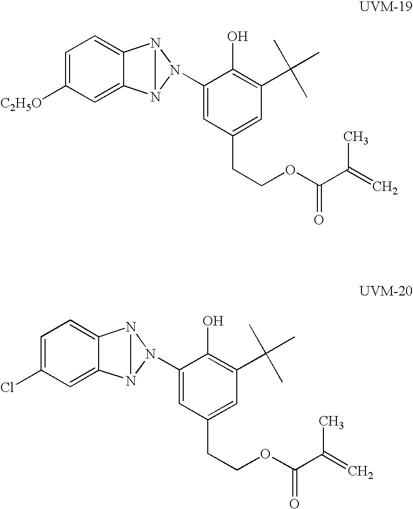

b. Description of Polymer

The UV absorbing polymer to be employed in the invention is a copolymer of the UV absorbing monomer and the ethylenic unsaturated monomer, which is characterized in that the weight average molecular weight is within the range of from 490 to 50,000.

The haze is reduced by the use of the UV absorbent in the state of copolymer and the optical film excellent in the transparency can be obtained. In the invention, the weight average molecular weight of the copolymer is within the range of from 490 to 50,000, preferably from 2,000 to 20,000, and more preferably from 7,000 to 15,000. When the weight average molecular weight is less than 940, the copolymer tends to be oozed out on the film surface and colored during the passing of time. When the weight average molecular weight is more than 50,000, the compatibility of the copolymer with the resin tends to be lowered.

Examples of the ethylenic unsaturated monomer capable of copolymerizing with the UV absorbing monomer include methacrylic acid and a ester thereof such as methyl methacrylate, ethyl methacrylate, propyl methacrylate, butyl methacrylate, i-butyl methacrylate, t-butyl methacrylate, octyl methacrylate, cyclohexyl methacrylate, 2-hydroxyhexyl methacrylate, 2-hydroxypropyl methacrylate, tetrahydroxyfurfuryl methacrylate, benzyl methacrylate, dimethylaminoethyl methacrylate and diethylaminoethyl methacrylate, and acrylic acid and an ester thereof such as methyl acrylate, ethyl acrylate, propyl acrylate, butyl acrylate, i-butyl acrylate, t-butyl acrylate, octyl acrylate, cyclohexyl acrylate, 2-hydroxyethyl acrylate, 2-hydroxypropyl acrylate, tetrahydrofurfuryl acrylate, 2-ethoxyethyl acrylate, Diethylene glycol ethoxylate acrylate, 3-methoxybutyl acrylate, benzyl acrylate and dimethylaminoethyl acrylate, an alkyl vinyl ether such as methyl vinyl ether, ethyl vinyl ether and butyl vinyl ether, an alkyl vinyl ester such as vinyl formate, vinyl butylate, vinyl capronate and vinyl stearate, acrylonitrile, vinyl chloride and styrene.

Among the ethylenic unsaturated monomers, an acrylate and a methacrylate each having a hydroxyl group or an ether bond such as 2-hydroxyethyl methacrylate, 2-hydroxypropyl methacrylate, tetrahydrofurfuryl methacrylate, 2-hydroxyethyl acrylate, 2-hydroxypropyl acrylate, tetrahydrofurfuryl acrylate, 2-ethoxyethyl acrylate, diethylene glycol ethoxylate acrylate and 3-methoxybutyl acrylate are preferable. These monomers can be copolymerized solely or in combination with the UV absorbing monomer.

The ratio of the UV absorbing monomer to the copolymerizable ethylenic unsaturated monomer is decided considering the compatibility of the formed copolymer with the transparent resin, the influence on the transparency and the mechanical strength of the optical film. It is preferably to combine them so that the copolymer contains from 20 to 70%, more preferably from 30 to 60%, by weight of the UV absorbent monomer. When the content of the UV absorbing monomer is less than 20% by weight, a large adding amount of the UV absorbent is necessary for obtaining desired UV absorbing ability so that the transparency of the film is considerably lowered by increasing in the haze or precipitation pf the UV absorbent and the strength of the film tends to be lowered. When the content of the UV absorbing monomer is more than 70% by weight, the compatibility with the transparent resin tends to lowered and the production efficiency of the film is degraded.

c. Description of Polymerization Method

In the invention, the method for polymerizing the UV absorbing copolymer is not specifically limited and known methods such as radical polymerization, anion polymerization and cation polymerization can be widely applied. As the initiator for the radical polymerization, an azo compound and a peroxide compound such as azobisisobutylnitrile (ABIN), a diester of azobisisobutylic acid and benzoyl peroxide, are employable. The solvent for polymerization is not specifically limited, and examples of usable solvent include an aromatic hydrocarbon type solvent such as toluene and chlorobenzene, a halogenized hydrocarbon type solvent such as dichloroethane and chloroform, a an ether type solvent such as tetrahydrofuran and dioxane, an amide type solvent such as dimethylformamide, an alcohol type solvent such as methanol, an ester type solvent such as methyl acetate and ethyl acetate, a ketone type solvent such as acetone, cyclohexanone and methyl ethyl ketone, and an aqueous solvent. Solution polymerization in which the polymerization is carried out in a uniform system, precipitation polymerization in which the formed polymer is precipitated and emulsion polymerization in which the polymerization is carried out in a micelle state are also performed according to selection of the solvent.

The weight average molecular weight of the UV absorbing copolymer can be controlled by known molecular weight controlling methods. For controlling the molecular weight, for example, a method can be applied in which adding a chain transferring agent such as carbon terachloride, laurylmercptane and octyl thioglycolate is employed. The polymerization is usually performed at a temperature of from a room temperature to 130° C., and preferably from 50 to 100° C.

The UV absorbing copolymer is mixed with the transparence resin constituting the optical film preferably in a ratio of from 0.01 to 40%, more preferably from 0.01 to 10%, by weight. On this occasion, the mixing ratio is not limited when the haze is not more than 0.5; the haze is preferably not more than 0.2. It is more preferable that formed optical film has a haze of not more than 0.2 the transparency at 380 nm of not more than 10%.

Moreover, it is also preferable that at least one of the UV absorbents contains a polymer derived from a UV absorbing monomer represented by Formula 2.

In Formula 2, n is an integer of from 0 to 3, and plural groups represented by R₅ may be the same as or different from each other and may be bonded together with to form a 5- through 7-member ring.

R₁ through R₅ are each a hydrogen atom, a halogen atom or a substituent. Examples of the halogen atom include a fluorine atom, a chlorine atom, a bromine atom and an iodine atom, and preferably the fluorine atom and the chlorine atom. Examples of the substituent include an alkyl group such as a methyl group, an ethyl group, an isopropyl group, a hydroxyethyl group, a methoxymethyl group, a trifluoromethyl group and a t-butyl group, an alkenyl group such as a vinyl group, an allyl group and a 3-butene-1-yl group, an aryl group such as a phenyl group, a naphthyl group, a p-tolyl group and a p-chlorophenyI group, a heterocyclic group such as a pyridyl group, a benzimidazolyl group, a benzothiazolyl group and a benzoxazolyl group, an alkoxy group such as a methoxy group, an ethoxy group, an isopropoxy group and an n-butoxy group, an aryloxy group such as a phenoxy group, a heteocycloxy group such as a 1-phenyltetrazole-5-oxy group, a 2-tetrahydropyranyloxy group, an acyloxy group such as an acetoxy group, pivaloyloxy group and a benzoyloxy group, an acyl group such as an acetyl group, an isopropanoyl group and a butyloyl group, an alkoxycarbonyl group such as a methoxycarbonyl group and an ethoxycarbonyl group, an aryloxycarbonyl group such as a phenoxycarbonyl group, a carbamoyl group such as a methylcarbamoyl group, an ethylcarbamoyl group and a dimethylcarbamoyl group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a nitro group, a sulfonamido group such as a methanesulfonamido group and a benzenestlfonamido group, a sulfamoylamino group such as a dimethylsulfamoylamino group, a sulfonyl group such as a methanesulfonyl group, a butanesulfonyl group and a phenylsulfonyl group, a sulfamoyl group such as an ethylsulfamoyl group and dimethylsulfamoyl group, a sulfonylamino group such as a methanesulfonylamino group and a benzenesulfonylamino group, a ureido group such as a 3-methylureido group, a 3,3-dimethylureido group and a 1,3-dimethylureido, an imido group such as a phthalimido group, a silyl group such as a trimethylsilyl group, a triethylsilyl group and t-butyldimethylsilyl group, an alkylthio group such as a methylthio group, an ethylthio group and an n-butylthio group, an arylthio group such as a phenylthio group, and the alkyl group and aryl group are preferable.

In Formula 2, the groups represented by R₁ through R₅ each may have a substituent when the group can be substituted, and adjacent R₁ through R₄ may be bonded to for a 5- to 7-member ring.

R₆ is a hydrogen atom, an alkyl group, an alkenyl group, an alkynyl group, an aryl group or a heterocyclic group. The alkyl group is, for example, a methyl group, an ethyl group, a propyl group, an isopropyl group, an n-butyl group, an isobutyl group, a t-butyl group, an amyl group, an isoamyl group and a hexyl group. The alkyl group may further have a halogen atom or a substituent. The halogen atom is, for example, a fluorine atom, a chlorine atom, a bromine atom and an iodine atom. Examples of the substituent include an aryl group such as a phenyl group, a naphthyl group, a p-tolyl group and a p-chlorophenyl group, an acyl group such as an acetyl group, a propanoyl group and butyloyl group, an alkoxy group such as a methoxy group, an ethoxy group, an isopropoxy group and an n-butoxy group, an aryloxy group-such as a phenoxy group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbamoyl group and ethoxycarbonyl group, and an aryloxycarbonyl group such as phenoxycarbonyl group.

As the cycloalkyl group, a saturated cyclic hydrocarbon group such as a cyclopentyl group, a cyclohexyl group, a norbornyl group and adamantyl group can be exemplified. Such the groups may be unsubstituted or substituted.

Examples of the alkenyl group include a vinyl group, an allyl group, a 1-methyl-2-propenyl group, a 3-butenyl group, a 2-butenyl group, a 3-methyl-2-butenyl group and an oreyl group, and the vinyl group, and the 1-methyl-2-propenyl group is preferable.

Examples of the alkynyl group include an ethynyl group, a butynyl group, a phenylethynyl group, a propalgyl group, a 1-methyl-2-propynyl group, a 2-butynyl group and a 1,1-dimethyl-2-propynyl group, and the ethynyl group and the propalgyl group are preferable.

Examples of the aryl group include a phenyl group, a naphthyl group and an anthranyl group. The aryl group may have a halogen atom or a substituent. As the halogen atom, a fluorine atom, a chlorine atom, a bromine atom and an iodine atom can be exemplified. Examples of the substituent include an alkyl group such as a methyl group, an ethyl group, an isopropyl group, a hydroxyethyl group, a methoxymethyl group, a trifluoromethyl group and a t-butyl group, an acyl group such as an acetyl group, a propanoyl group and a butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylamino group, an acylamino group such as an acetylamino group and a propionyl amino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbonyl group and an ethoxycarbonyl group, and an aryloxycarbonyl group such as a phenoxycarbonyl group.

As the heterocyclic group, a pyridyl group, a benzimidazolyl group, a benzothiazolyl group and a benzoxazolyl group can be exemplified. R₆ is preferably the alkyl group.

In Formula 2, X is a —COO— group, a —CONR₇— group, a —OCO— group or an —NR₇CO— group.

R₇ is a hydrogen atom, an alkyl group, a cycloalkyl group an aryl group or a heterocyclic group. The alkyl group is, for example, a methyl group, an ethyl group, a propyl group, an isopropyl group, an n-butyl group, an-isobutyl group, a t-butyl group, an amyl group, an isoamyl group or a hexyl group. The alkyl group may further have a halogen atom or a substituent. The halogen atom is, for example, a fluorine atom, a chlorine atom, a bromine atom or an iodine atom. Examples of the substituent include an aryl group such as a phenyl group, a naphthyl group, a p-tolyl group and a p-chlorophenyl group, an acyl group such as an acetyl group, a propanoyl group and butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbamoyl group and ethoxycarbonyl group, and an aryloxycarbonyl group such as phenoxycarbonyl group.

As the cycloalkyl group, a saturated cyclic hydrocarbon group such as a cyclopentyl group, a cyclohexyl group, a norbornyl group and adamantyl group can be exemplified. Such the groups may be unsubstituted or substituted.

Examples of the aryl group include a phenyl group, a naphthyl group and an anthranyl group. The aryl group-may further have a halogen atom or a substituent. As the halogen atom, a fluorine atom, a chlorine atom, a bromine atom and an iodine atom can be exemplified. Examples of the substituent include an alkyl group such as a methyl group, an ethyl group, an isopropyl group, a hydroxyethyl group, a methoxymethyl group, a trifluoromethyl group and a t-butyl group, an acyl group such as an acetyl group, a propanoyl group and a butyloyl group, an alkoxy group such as a methoxy group, an ethoxy group, an isopropoxy group and an n-butoxy group, an aryloxy group such as a phenoxy group, an amino group, an alkylamino group such as a methylamino group, an ethylamino group and a diethylamino group, an anilino group such as an anilino group and an N-methylamino group, an acylamino group such as an acetylamino group and a propionylamino group, a hydroxyl group, a cyano group, a carbamoyl group such as a methylcarbamoyl group, an ethylcarbamoyl group and a dimethylcarbamoyl group, an acyloxy group such as an acetoxy group, a pivaloyloxy group and a benzoyloxy group, an alkoxycarbonyl group such as a methoxycarbonyl group and an ethoxycarbonyl group, and an aryloxycarbonyl group such as a phenoxycarbonyl group.

As the heterocyclic group, a pyridyl group, a benzimidazolyl group, a benzothiazolyl group and a benzoxazolyl group can be exemplified. R₇ is preferably the hydrogen atom.

In the invention, the polymerizable group is a unsaturated ethylenic polymerizable group or a di-functional condensation-polymerizable group, and preferably the unsaturated ethylenic polymerizable group. Concrete examples of the unsaturated ethylenic polymerizable group include a vinyl group, an allyl group, an acryloyl group, a methacryloyl group, a styryl group, an acrylamido group, a methacrylamido group, a vinyl cyanide group, a 2-cyanoacryloxy group, a 1,2-epoxy group, a vinylbenzyl group and a vinyl ether group and preferably the vinyl group, the acryloyl group, the methacryloyl group, the acrylamido group and the methacrylamido group. The UV absorbing monomer having the polymerizable group as the partial structure thereof is the monomer in which the polymerizable group is bonded directly or through two or more bonding groups to the UV absorbent, for example an alkylene group such as a methylene group, a 1,2-ethylene group, a 1,3-propylene group, a 1,4-butylene group-and a cyclohexane-1,4-diyl group, an alkenylene group such as an ethane-1,2-diyl group and a butadiene-1,4-diyl group, an alkynylene group such as a etyne-1,2-diyl group, a butane-1,3-diine-1,4-diyl, a bonding group derived from a compound including an aromatic group such as a substituted or unsubstituted benzene, a condensed polycyclic hydrocarbon, an aromatic heterocyclic rings, a combination of aromatic hydrocarbon rings and a combination of aromatic heterocyclic rings, and bonding by a hetero atom such as an oxygen atom, a sulfur atom, a nitrogen atom, a silicon atom and a phosphor atom. The bonding group is preferably the alkylene group and the bonding by the hetero atom. These bonding groups may be combined for forming a composite bonding group. The weight average molecular weight of the polymer derived from the UV absorbing monomer is from 2,000 to 30,000, and preferably from 5,000 to 20,000.

The weight average molecular weight of the UV absorbing copolymer can be controlled by known molecular weight controlling methods. For controlling the molecular weight, for example, a method can be applied in which a chain transferring agent such as carbon terachloride, laurylmercptane and octyl thioglycolate is employed. The polymerization is usually performed at a temperature of from a room temperature to 130° C., and preferably from 50 to 100° C.

The UV absorbing polymer to be employed in the invention is preferably a copolymer of the UV absorbing monomer and another polymerizable monomer. Examples of the other monomer capable of polymerizing include a unsaturated compound, for example, a styrene derivative such as styrene, α-methylstyrene, o-methylstyrene, m-methylstyrene, p-methylstyrene and vinylnephthalene, an acrylate derivative such as methyl acrylate, ethyl acrylate, propyl acrylate, butyl acrylate, i-butyl acrylate, t-butyl acrylate, octyl acrylate, cyclohexyl acrylate and benzyl acrylate, a methacrylate derivative such as methyl methacrylate, ethyl methacrylate, propyl methacrylate, butyl methacrylate, i-butyl methacrylate, t-butyl methacrylate, octyl methacrylate, cyclohexyl methacrylate and benzyl methacrylate, an alkyl vinyl ether such as methyl vinyl ether, ethyl vinyl ether and butyl vinyl ether, an alkyl vinyl ester such as vinyl formate, vinyl acetate, vinyl butylate, vinyl capronate and vinyl stearate, crotonic acid, maleic acid, fumaric acid, itaconic acid, acrylonitrile, methacrylonitrile, vinyl chloride, vinylidene chloride, acrylamide and methacrylamide. Methyl acrylate, methyl methacrylate and vinyl acetate are preferred.

It is also preferable that the component other than the UV absorbing monomer in the polymer derived from the UV absorbing monomer contains a hydrophilic ethylenic unsaturated monomer.

As the hydrophilic ethylenic unsaturated monomer, a hydrophilic compound having a polymerizable unsaturated double bond in the molecular thereof is employable without any limitation. For example, a unsaturated carboxylic acid such as acrylic acid and methacrylic acid, an acrylate and methacrylate each having a hydroxyl group or an ether bond such as 2-hydroxyethyl methaceylate, 2-hydroxypropyl methacrylate, tetrahydrfurfuryl methacrylate, 2-hydroxyethyl acrylate, 2-ydroxypropyl acrylate, 2,3-dihydroxy-2-methylpropyl methacrylate, tetrahydrofurfuryl acrylate, 2-ethoxyethyl acrylate, diethylene glycol ethoxylate acrylate and 3-methoxybutylbutyl acrylate, acrylamide, an N-substituted (meth)acrylamido such as N,N-dimethyl(meth)acrylate, N-vinylpyrrolidone and N-vinyloxazolidone are employable.

As the hydrophilic ethylenic unsaturated monomer, a (meth)acrylate having a hydroxyl group or a carboxyl group in the molecule thereof is preferable, and 2-hydroxyethyl methacrylate, 20hydroxypropyl methacrylate, 2-hydroxyethyl acrylate and 2-hydroxypropyl acrylate are particularly preferable.

These polymerizable monomers can be copolymerized solely or in combination of two or more kinds together with the UV absorbing monomer.

In the invention, the method for polymerizing the UV absorbing copolymer is not specifically limited and known methods such as radical polymerization, anion polymerization and cation polymerization can be widely applied. As the initiator for the radical polymerization, an azo compound and a peroxide compound such as azobisisobutylnitrile (ABIN), a diester of azobisisobutylic acid, benzoyl peroxide and hydrogen peroxide are employable. The solvent for polymerization is not specifically limited, and examples of usable solvent include an aromatic hydrocarbon type solvent such as toluene and chlorobenzene, a halogenized hydrocarbon type solvent such as dichloroethane and chloroform, a an ether type solvent such as tetrahydrofuran and dioxane, an amide type solvent such as dimethylformamide, an alcohol type solvent such as methanol, an ester type solvent such as methyl acetate and ethyl acetate, a ketone type solvent such as acetone, cyclohexanone and methyl ethyl ketone, and an aqueous solvent. Solution polymerization in which the polymerization is carried out in a uniform system, precipitation polymerization in which the formed polymer is precipitated, emulsion polymerization in which the polymerization is carried out in a micelle state and suspension polymerization carried out in a suspended state can be performed according to selection of the solvent.

The using ratio of the UV absorbing monomer, the polymerizable monomer capable of polymerizing with the UV absorbing monomer and the hydrophilic unsaturated monomer is suitably decided considering the compatibility of the obtained UV absorbing copolymer with the other transparent polymer and the influence on the transparency and the mechanical strength of the optical film.

The content of the UV absorbing monomer in the polymer derived from the UV absorbing monomer is preferably from 1 to 70%, and more preferably from 5 to 60%, by weight. When the content of the UV absorbent monomer in the UV absorbing polymer is less than 1%, addition of a large amount of the UV absorbing polymer is necessary for satisfying the desired UV absorbing ability so that increasing in the haze or lowering in the transparency and the mechanical strength by the precipitation is caused. On the other hand, when the content of the UV absorbing monomer in the UV absorbing polymer exceeds 70% by weight, the transparent optical film is difficultly obtained sometimes since the compatibility of the polymer with another polymer is lowered.

The hydrophilic ethylenic unsaturated monomer is preferably contained in the UV absorbing copolymer in a ratio of from 0.1 to 50% by weight. When the content is less than 0.1%, the improvement effect on the compatibility of the hydrophilic ethylenic unsaturated monomer cannot be obtained and when the content is more than 50% by weight, the isolation and purification of the copolymer becomes impossible. More preferable content of the hydrophilic ethylenic unsaturated monomer is from 0.5 to 20% by weight. When the hydrophilic group is substituted to the UV absorbing monomer itself, it is preferable that the total content of the hydrophilic UV absorbing monomer and the hydrophilic ethylenic unsaturated monomer is within the above-mentioned range.

For satisfying the content of the UV absorbing monomer and the hydrophilic monomer, it is preferable that the an ethylenic unsaturated monomer having no hydrophilicity is further copolymerized additionally to the above two monomers.

Two or more kinds of each of the UV absorbing monomer and hydrophilic or non-hydrophilic ethylenic unsaturated monomer may be mixed and copolymerized.

Typical examples of the UV absorbing monomer to be preferably employed in the invention are listed below, but the monomer is not limited to these samples.

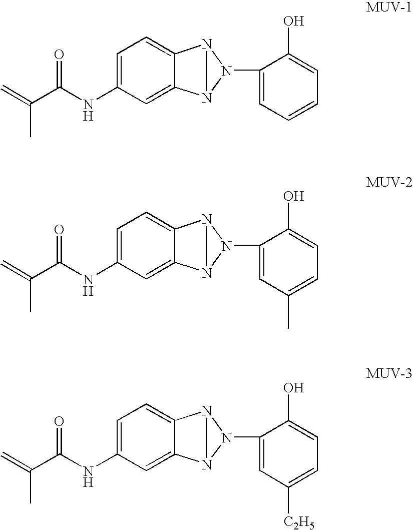

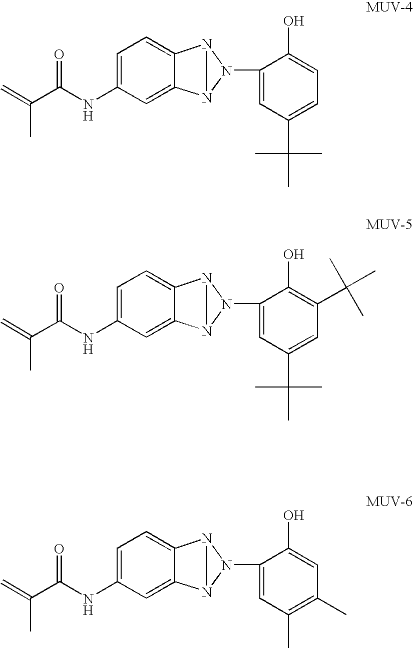

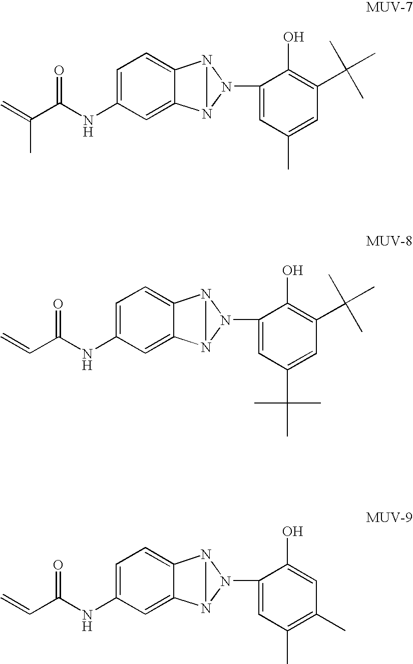

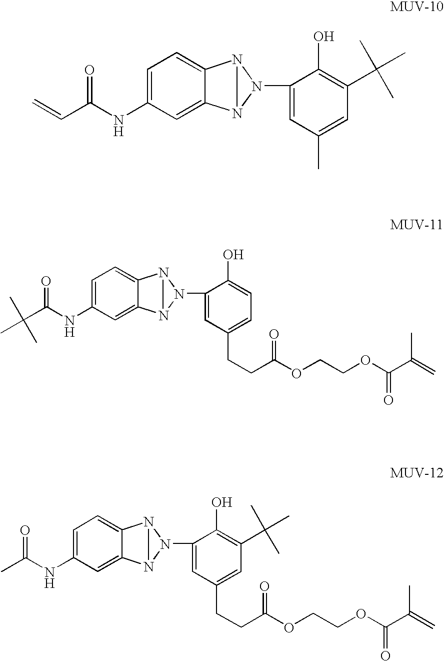

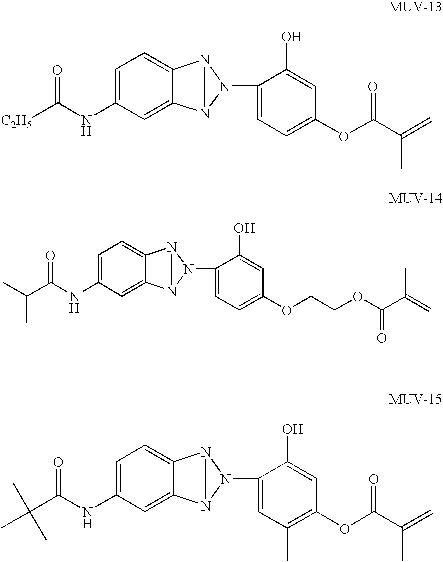

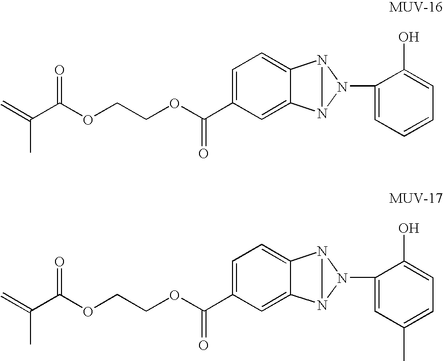

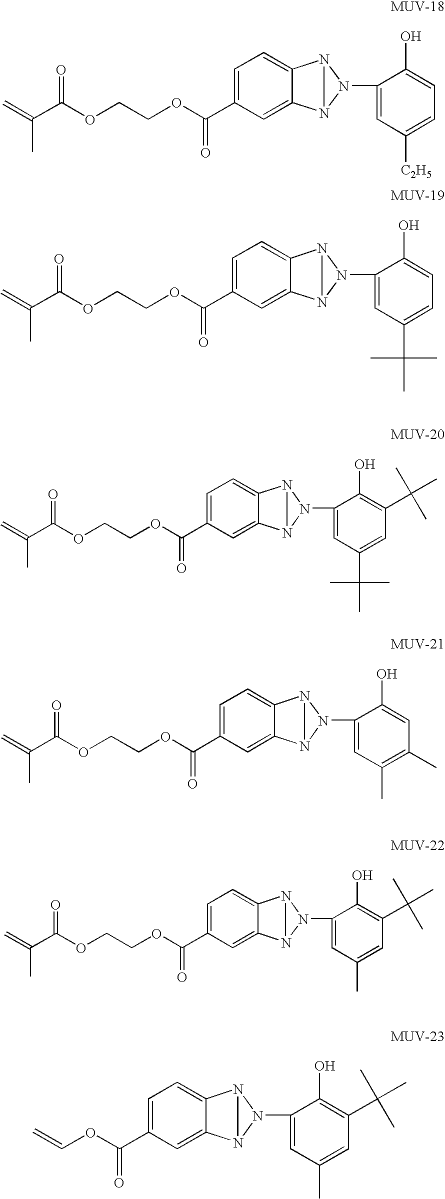

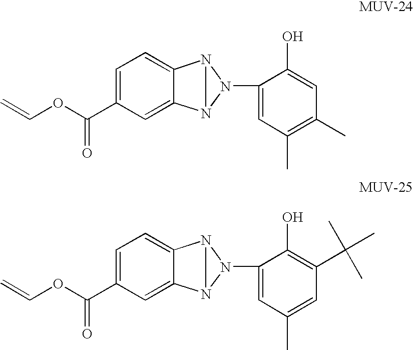

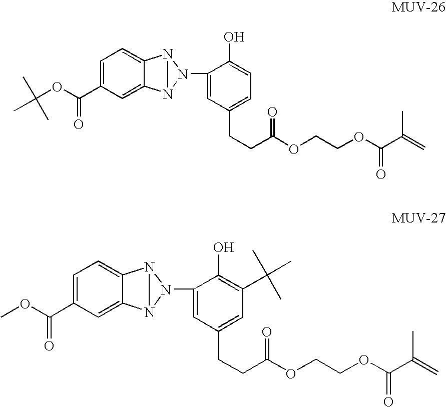

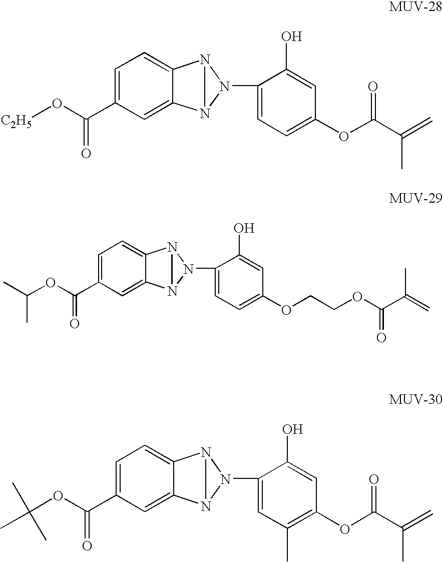

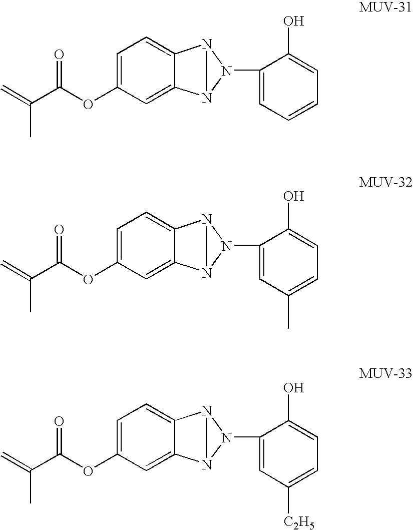

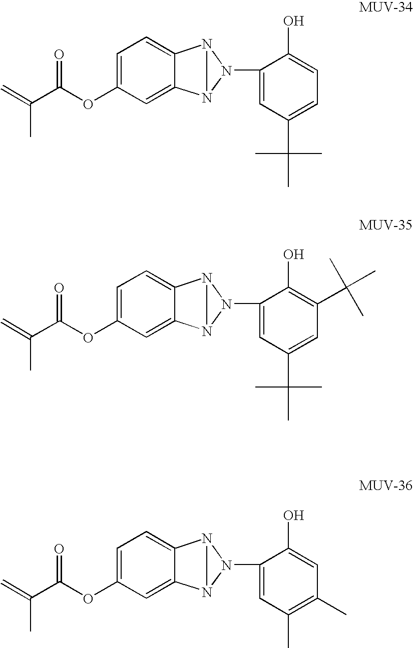

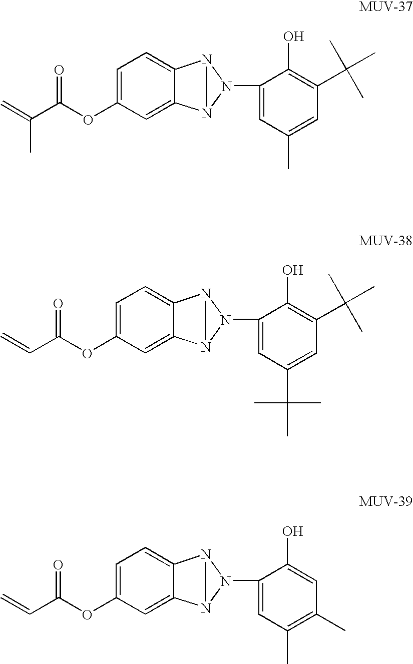

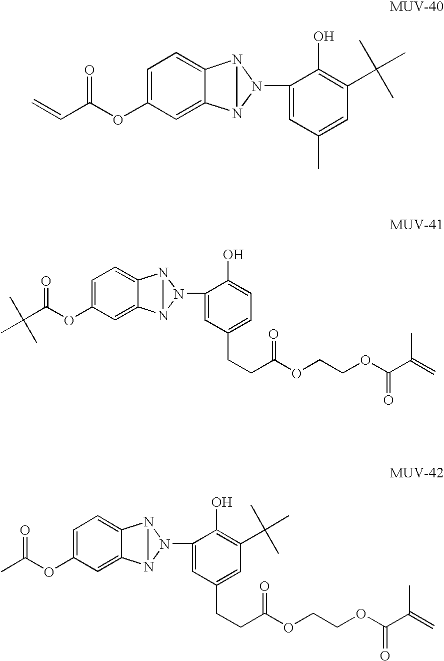

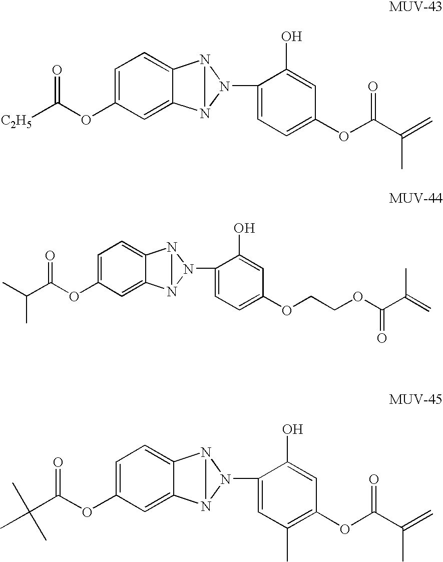

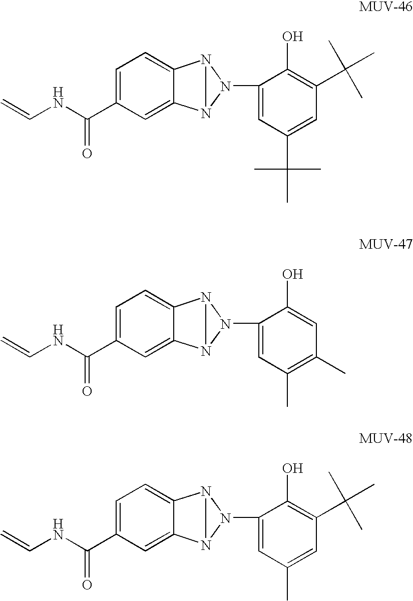

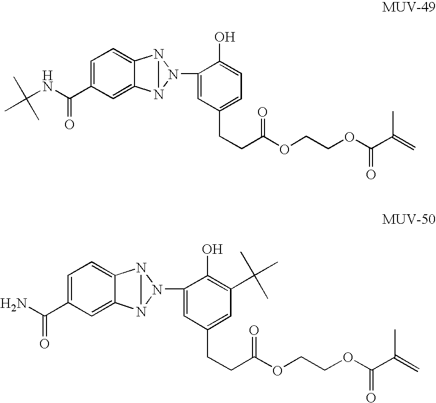

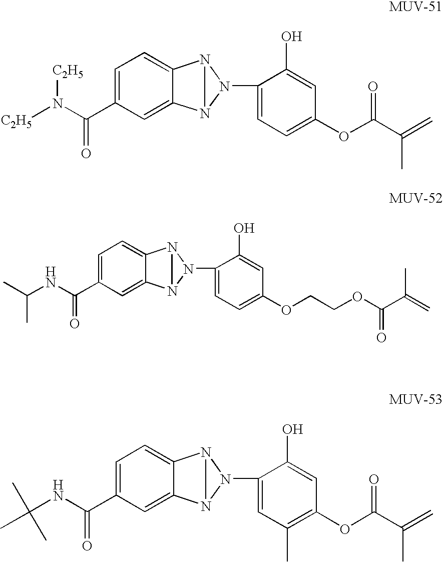

The UV absorbents, UV absorbing monomers and their intermediates to be employed in the invention can be synthesized by referring published documents. For example U.S. Pat. Nos. 3,072,585, 3,159,646, 3,399,173, 3,761,373, 4,028,331 and 5,683,861, European Patent No. 86,300,416, Tokkai Sho 63-2275,75 and 63-185969, “Polymer Bulletin” V. 20 (2), 169-176, and “Chemical Abstracts V. 109, No. 191389 can be referred for synthesizing.

The UV absorbent and the UV absorbing polymer to be used in the invention can be employed together with a low or high molecular weight compound or an inorganic compound according to necessity on the occasion of mixing with the other transparent polymer. For example, it is one of preferable embodiments that the UV absorbent polymer and another relatively low molecular weight UV absorbent are simultaneously mixed with the other transparent polymer. Moreover, simultaneously mixing of an additive such as an antioxidant, a plasticizer and a flame retardant is also one of preferable embodiments.

The UV absorbent or the UV absorbing polymer to be employed in the invention may be added in a state of kneaded with the rein or a solidified state by drying a solution of that together with the resin, though the adding method is not specifically limited.

Though the using amount of the UV absorbent and the UV absorbing polymer is varied depending on the kind of compound and the employing conditions, the amount of the UV absorbent is preferably from 0.1 to 5.0 g, more preferably from 0.4 to 2.0 g, and particularly preferably from 0.5 to 1.5 g, per square meter of the optical film. In the case of the UV polymer, the adding amount is preferably from 0.1 to 10 g, more preferably from 0.6 to 9.0 g, further preferably from 1.2 to 6.0 g, and particularly preferably from 1.5 to 3.0 g, per square meter of the optical film.

As described above, ones are preferable, which have superior absorbing ability to UV rays of not more than 380 nm for preventing degradation of the liquid crystal and low absorbing ability to visible light of not less than 400 nm for displaying ability of the liquid crystal display. In the invention, the transparency at a wavelength of 380 nm is preferably not more than 8%, more preferably not more than 4%, and particularly preferably not more than 1%.

As UV absorbent monomers available on the market, 1-(2-bezotriazole)-2-hydroxy-5-(vinyloxycarbonylethyl)-benzene UVM-1 and a reactive type UV absorbent 1-(2-benzotriazole)-2-hydroxy-5-(2-methacryloyloxyethyl)-benzene UVA 93, each manufactured by Ootsuka Kagaku Co., Ltd., and similar compounds are employable in the invention. They are preferably employed solely or in a state of polymer or copolymer but not limited to them. For example, a polymer UV absorbent available on the market PUVA-30M, manufactured by Ootsuka Kagaku Co., Ltd., is preferably employed. The UV absorbent may be used in combination of two or more kinds thereof.

Plasticizer

The addition of a compound known as plasticizer to the optical film of the invention is preferable for improving the film properties such as mechanical properties, softness and anti-moisture absorbing ability. The object of the addition of the plasticizer in the melt-cascading method according to the invention further includes to make the melting point of the film constituting materials to lower than the glass transition point of the independent cellulose and to make the viscosity of the film constituting material containing the plasticizer to lower than that of the cellulose ester at the same temperature.

In the invention, the melting point of the film constituting material is the temperature of the heated material at the time when the fluidity of the material is appeared.

The independent cellulose ester not fluidized at a temperature lower than the glass transition point since the cellulose ester becomes film state. However, the elasticity or viscosity of the cellulose ester is lowered by heating at a temperature of higher than the glass transition point so that the cellulose ester is fluidized. It is preferable that the plasticizer to be added has a melting point or glass transition point lower than that of the cellulose ester for melting the film constituting material and satisfying the above objects.

Though the plasticizer relating to the invention is not specifically limited, the plasticizer has a functional group capable of interacting by a hydrogen bond with the cellulose derivative or the other additives so that the haze or the bleeding out or evaporation of the plasticizer from the film does not occur.

Examples of such the functional group include a hydroxyl group, an ether group, a carbonyl group, an ester group, a residue of carboxylic acid, an amino group, an imino group, an amido group, a cyano group, a nitro group, a sulfonyl group, a residue of sulfonic acid, a phosphonyl group and a residue of phosphoric acid. The carbonyl group, ester group and phosphonyl group are preferable.

Examples of preferably usable plasticizer include a phosphate type plasticizer, a phthalate type plasticizer, a trimelitate type plasticizer, a pyromelitate type plasticizer, a polyvalent alcohol ester type plasticizer, a glycolate type plasticizer, a citrate type plasticizer, an aliphatic acid ester type plasticizer, a calboxylate type plasticizer and a polyester type plasticizer, and the polyvalent alcohol ester type plasticizer, polyester type plasticizer and citrate type plasticizer are particularly preferable. The addition of these plasticizers to the UV absorbent having a molecular weight of from 490 to 50,000 is preferable for the compatibility.

The poly-valent alcohol ester is the ester of a di- or more-valent alcohol and a mono-carboxylic acid and preferably has an aromatic ring or a cycloalkyl ring in the molecular thereof.

The poly-valent alcohol is represented by the following Formula 4.
R₁—(OH)ₙ Formula 4

In the above, R₁ is an n-valent organic group, and n is an integer of 2 or more.

Examples of preferable poly-valent alcohol include adonitol, arabitol, ethylene glycol, Diethylene glycol, triethylene glycol, tetraethylene glycol, 1,2 -propanediol, 1,3-propanediol, dipeopylene glycol, tripropylene glycol, 1,2-butnaediol, 1,3-butanediol, 1.4-butanediol, dibutylene glycol, 1,2,4-bunanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol, but the invention is not limited to them. Particularly, triethylene glycol, tetraethylene glycol, triethylol propane and xylitol are preferred.

Among them, the poly-valent alcohol esters using a poly-valent alcohol having 5 or more, particularly 5 to 20 carbon atoms are preferable.

As the monocarboxylic acid to be used in the poly-valent alcohol ester, a known aliphatic monocarboxylic acid, alicyclic monocarboxylic acid and aromatic monocarboxylic acid can be employed though the monocarboxylic acid is not limited. The alicyclic monocarboxylic acid and aromatic monocarboxylic acid are preferable for improving the moisture permeation ability and storage ability.

Examples of the preferable monocarboxylic acid are listed below but the invention is not limited to them.

A straight or branched chain carboxylic acid having 1 to 32 carbon atoms is preferably employed. The number of carbon atoms is more preferably from 1 to 20, and particularly preferably from 1 to 10. The addition of acetic acid is preferable for raising the compatibility with the cellulose derivative, and the mixing of acetic acid with another carboxylic acid is also preferable.

As the preferable aliphatic monocarboxylic acid, a saturated fatty acid such as acetic acid, propionic acid, butylic acid, valeric acid, caproic acid, enantic acid, caprylic acid, pelargonic acid, capric acid, 2-ethyl-hexane carboxylic acid, undecylic acid, lauric acid, dodecylic acid, myristic acid, pentadecylic acid, palmitic acid, heptadecylic acid, stearic acid, nonadecanic acid, arachic acid, behenic acid, lignocelic acid, cerotic acid, heptacosanic acid, montanic acid, melisic acid and lacceric acid, and a unsaturated fatty acid such as undecylenic acid, oleic acid, sorbic acid, linolic acid, linolenic acid and arachidonic acid can be exemplified.

Examples of preferable alicyclic carboxylic acid include cyclopentene carboxylic acid, cyclohexane carboxylic acid, cyclooctane carboxylic acid and derivatives thereof.

Examples of preferable aromatic carboxylic acid include ones formed by introducing an alkyl group onto the benzene ring of benzoic acid such as benzoic acid and toluic acid, an aromatic monocarboxylic acid having two or more benzene rings such as biphenylcarboxylic acid, naphthalene carboxylic acid and tetralin carboxylic acid and derivatives of them, and benzoic acid is particularly preferable.

The molecular weight of the poly-valent alcohol is preferably from 300 to 3,000, and more preferably from 350 to 1,500 though the molecular weight is not specifically limited. Larger molecular weight is preferable for low volatility and smaller molecular weight is preferable for the moisture permeability and the compatibility with the cellulose derivative.

The carboxylic acid to be employed in the poly-valent alcohol ester may be one kind or a mixture of two or more kinds of them. The hydroxyl group in the polyvalent alcohol may be entirely esterized or partially leaved.

Concrete compounds of the polyvalent alcohol ester are listed below.

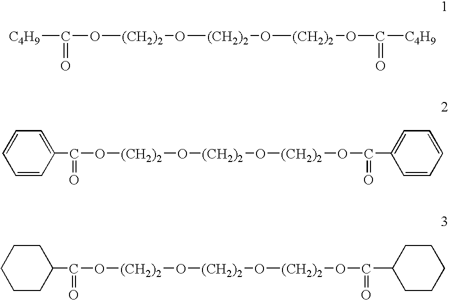

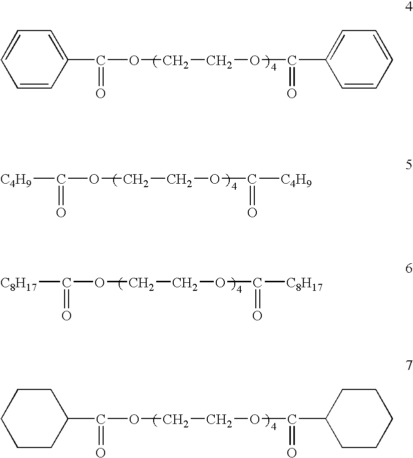

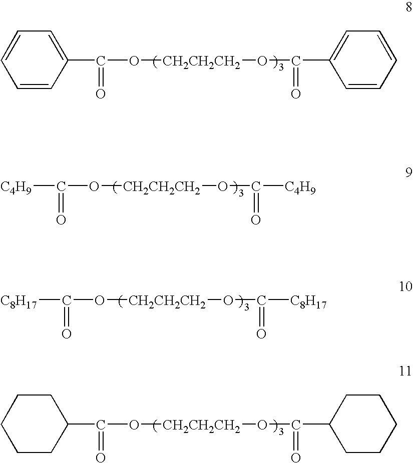

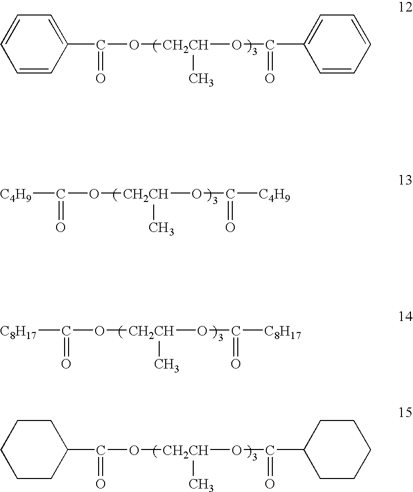

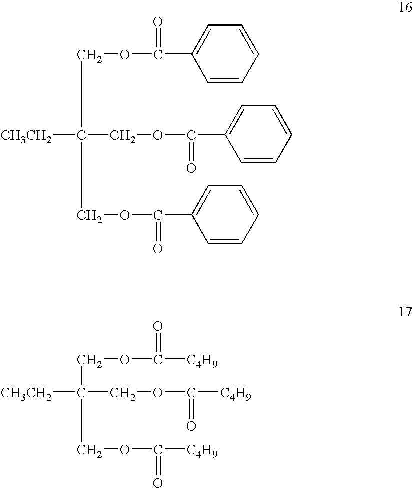

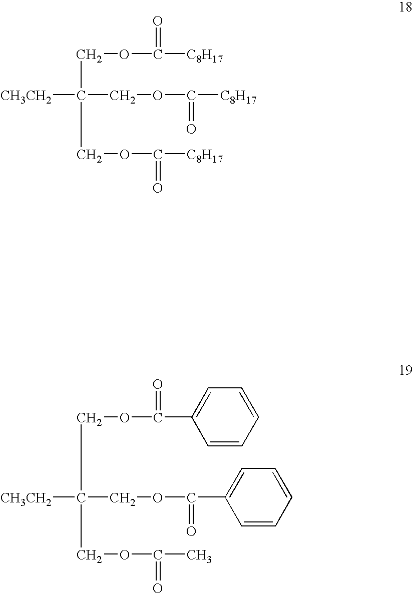

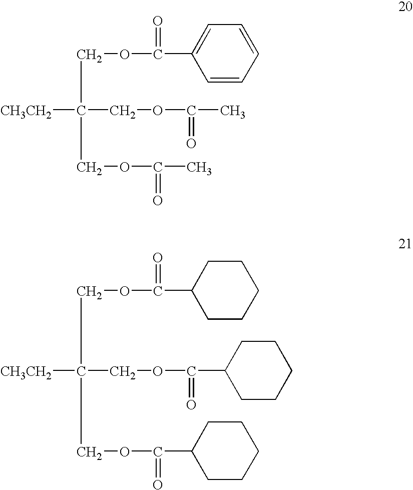

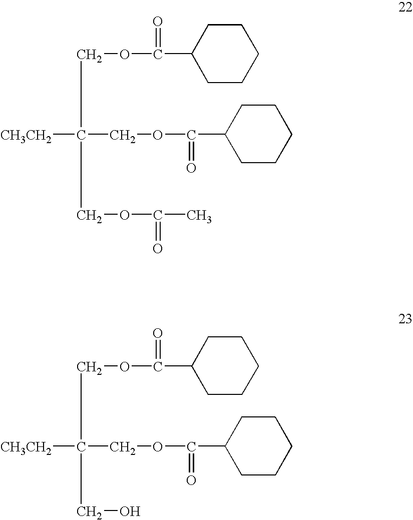

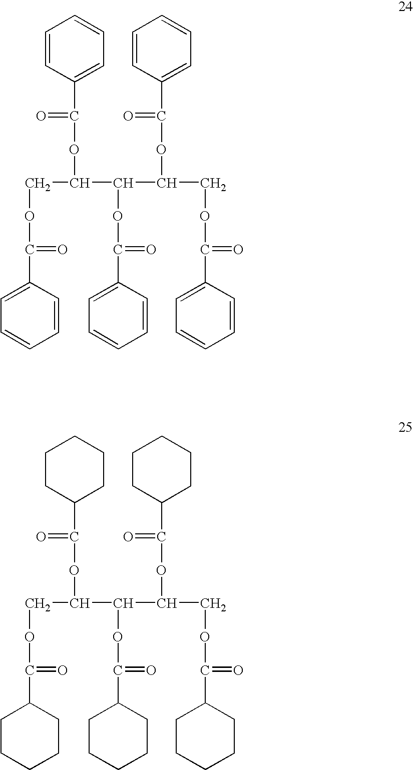

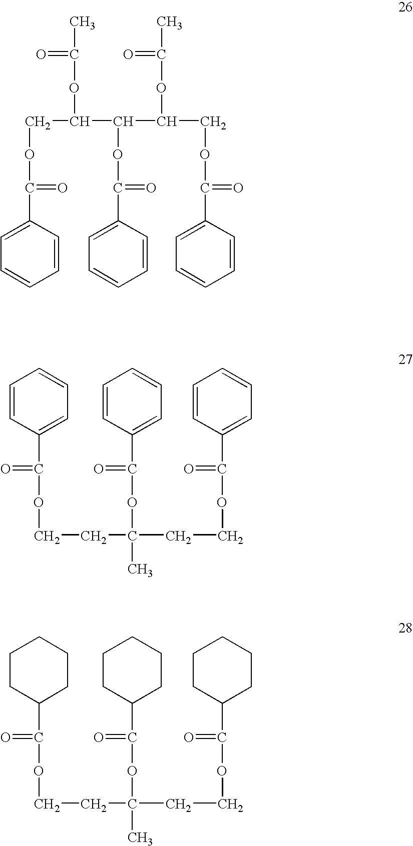

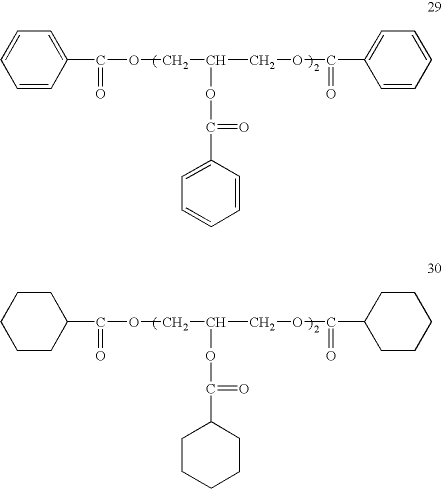

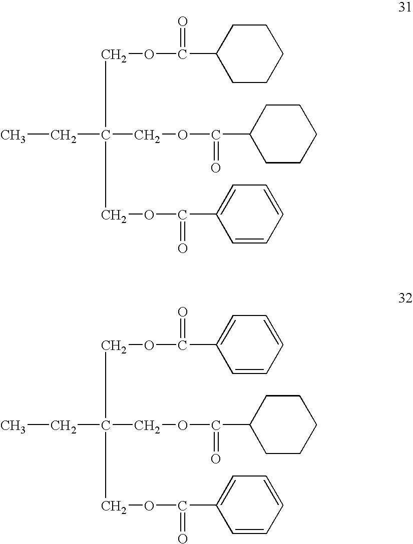

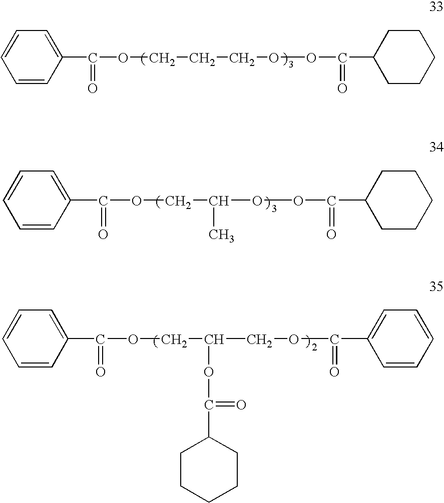

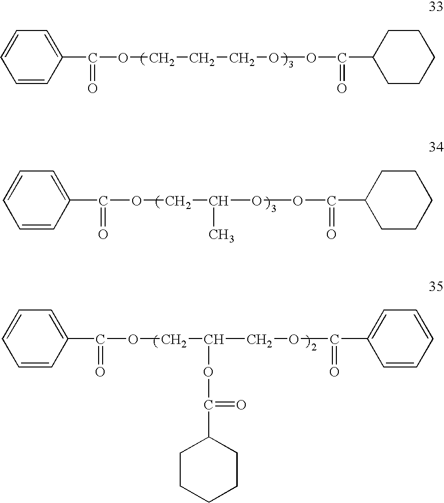

Moreover, a polyester type plasticizer having a cycloalkyl group in the molecule thereof is preferably employed. For example, compounds represented by the following Formula 5 are preferable though the polyester type plasticizer is not specifically limited.
B-(G-A)ₙ-G-B Formula 5

In the above formula, B is a benzene monocarboxylic acid residue, G is an alkylene glycol residue having 2 to 12 carbon atoms, an aryl glycol residue having 6 to 12 carbon atoms or an oxyalkylene glycol residue having 4 to 12 carbon atoms, A is an alkylenecarboxylic acid residue having 4 to 12 carbon atoms or an aryldicarboxylic acid residue having 6 to 12 carbon atoms, and n is an integer of 0 or more.

The polyester type plasticizer is constituted by the benzene monocarboxylic acid residue represented by B, the alkylene glycol residue, the aryl glycol residue or the oxyalkylene glycol residue represented by G, and an alkylenecarboxylic acid residue or an aryldicarboxylic acid residue represented by A; the plasticizer can be obtained by a reaction similar to that for obtaining usual polyester type plasticizer.

As the benzene monocarboxylic acid component of the polyester type plasticizer employed in the invention, for example, benzoic acid, p-tert-butylbenzoic acid, o-toluic acid, m-toluic acid, p-toluic acid, dimethylbenzoic acid, ethylbenzoic acid, n-propylbenzoic acid, aminobenzoic acid and acetoxybenzoic acid are applicable. They can be employed solely or in combination.

Examples of the alkylene glycol with 2 to 12 carbon atoms as the component of the polyester type plasticizer of the invention include ethylene glycol, 1,2 propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2, 2-diethyl-1,3-propanediol(3,3-dimethylolpentane), 2-n-butyl-2-ethyl-1,3-propanediol(3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and 1,12-octadecanediol. These glycols are employed solely or in mixture of two or more kinds thereof.

Examples of the oxyalkylene glycol component with 4 to 12 carbon atoms forming the terminal aromatic ester structure include Diethylene glycol, triethylene glycol, tetraethylene glycol, dipropylene glycol and tripropylene glycol. These glycols can be employed solely or in a combination of two or more kinds.

Examples of the alkylenedicarboxylic acid component with 4 to 12 carbon atoms forming the terminal aromatic ester structure include succinic acid, maleic acid, fumaric acid, glutaric acid, adipic acid, azelaic acid, sebacic acid and dodecanedicarboxylic acid. These acids can be employed solely or in a combination of two or more kinds. The examples of the arylenedicarboxylic acid component having 6 to 12 carbon atoms include phthalic acid, tetraphthalic acid, 1,5-naphthalenedicarboxylic acid and 1,4-naphthalenedicarboxylic acid.

The suitable number average molecular weight of the polyester type plasticizer to be employed in the invention is preferably from 250 to 2,000, and more preferably from 300 to 1,500. The acid value of that is from 0.5 to 25 mg KOH/g, and one having an acid value of not more than 0.3 mg KOH/g and a hydroxyl group value of not more than 15 mg KOH/g is more suitable.

Examples of synthesizing of the aromatic terminal ester type plasticizer are described below.

Sample No. 1 (Sample of Aromatic Terminal Ester)

In a reaction vessel, 365 parts (2.5 moles) of adipic acid, 418 parts (5.5 moles) of 1,2-propylene glycol, 610 parts of (5 moles) of benzoic acid and 0.30 parts of tetraisopropyl titanate as a catalyst were charged at once and stirred in nitrogen gas stream, and heated at a temperature of from 130 to 250° C. until the acid value becomes not more than 2 while formed water was continuously removed and excessive mono-valent alcohol was refluxed by a reflux condenser. After that, distillate was removed under a reduced pressure of not more than 1.33×10 Pa, finally not more than 4×10² Pa at a temperature of from 200 to 230° C., and then the content of the vessel was filtered to obtain an aromatic terminal ester having the following properties.

Viscosity (mPa.s at 25° C.): 815

Acid value: 0.4

Sample No. 2 (Sample of Aromatic Terminal Ester)

An aromatic terminal ester having the following properties was obtained in the same manner as in Sample 1 except that 365 parts (2.5 moles) of adipic acid, 610 parts (5 moles) of benzoic acid, 583 parts (5.5 moles) of diethylene glycol and 0.45 parts of tetraisopropyl titanate as a catalyst were employed.

Viscosity (mPa.s at 25° C.): 90

Acid value: 0.05

Sample No. 3 (Sample of Aromatic Terminal Ester)

An aromatic terminal ester having the following properties was obtained in the same manner as in Sample 1 except that 410 parts (2.5 moles) of phthalic acid, 610 parts (5 moles) of benzoic acid, 737 parts (5.5 moles) of dipropylene glycol and 0.40 parts of tetraisopropyl titanate as a catalyst were employed.

Viscosity (mPa.s at 25° C.): 43,400

Acid value: 0.2

Concrete compounds of the aromatic terminal ester type plasticizer are listed below; the invention is not limited to the listed compounds.

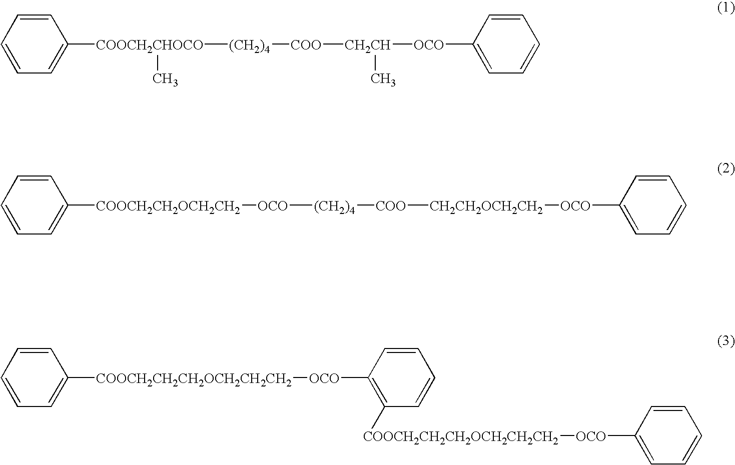

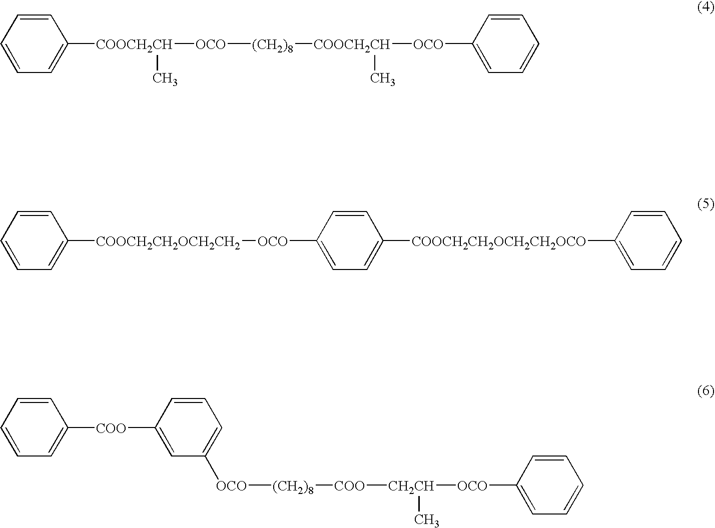

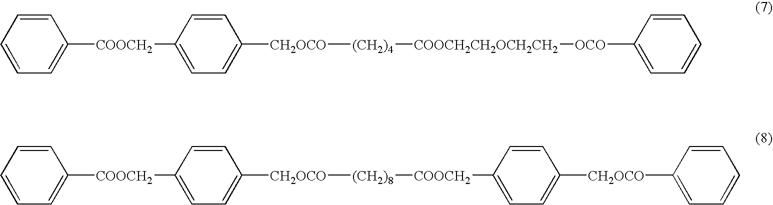

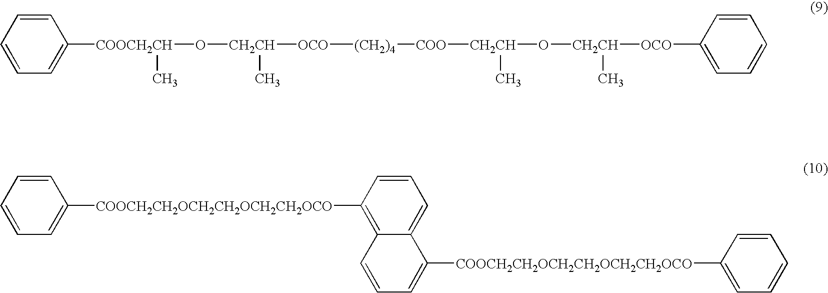

The content of the polyester type plasticizer in the cellulose ester film is preferably from 1 to 20%, and particularly preferably from 3 to 11%, by weight.

The optical film of the invention preferably contains also a plasticizer other than the above-described plasticizer.

The dissolving out of the plasticizer can be reduced by containing two or more kinds of the plasticizer. Tough the reason of such the effect is not cleared; it is supposed that the dissolving out is inhibited by the interaction between the two kinds of the plasticizer and the cellulose ester.

A glycolate type plasticizer having an aromatic ring or a cycloalkyl ring is preferably employed even though there is no specific limitation on the glycolate type plasticizer. Preferably usable glycolate type plasticizers are, for example, butylphthalyl glycolate, ethylphthalylethyl glycolate, and methylphthalylethyl glycolate.

Examples of phthalate type plasticizer include diethyl phthalate, dimethoxethyl phthalate, dimethyl phthalate, dioctyl phthalate, dibutyl phthalate, di-2-ethylhexyl phthalate, dioctyl phthalate, dicyclohexyl phthalate and dicyclohexyl terephthalate.

Moreover, a phthalate dimer represented by Formula 1 described in Tokkai Hei 11-349537 is preferably employed. In concrete, Compounds-1 and Coompound-2 described in paragraphs 23 and 26 of the patent document are preferably employable.

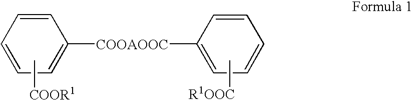

A: —(CH₂)ₙ— or —(CH₂CH₂O)ₙ—

n: An integer of 1 to 10

R¹: An alkyl group having 1 to 12 carbon atoms which may be substituted by an alkoxycarbonyl group.

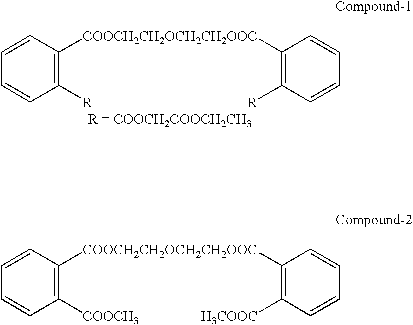

The phthalate type dimer compound is a compound represented by Formula 1, which can be obtained by dehydrating esterification reaction by heating a mixture of two phthalic acids and a di-valent alcohol. The average molecular weight of the phthalate type dimer or the bisphenol type compound having a hydroxyl group at the terminal thereof is preferably from 250 to 3,000, and particularly preferably from 300 to 1,000. When the molecular weight is less than 250, problems are caused in the thermal stability and the volatility and the mobility of the plasticizer. When the molecular weight exceeds 3,000, the compatibility and the plasticizing ability of the plasticizer are lowered and the processing suitability, transparency and the mechanical property of the aliphatic cellulose ester type resin are received bad influences.

As the citrate type plasticizer, acetyltrimethyl citrate, acetyltriethyl citrate and acetyltributyl acetate can be exemplified without any limitation, and the citrate compounds represented by Formula 6 are preferred.

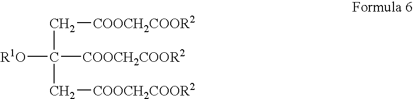

In the above, R¹ is a hydrogen atom or an aliphatic acyl group, and R² is an alkyl group.

In Formula 6, the aliphatic acyl group represented by R¹ is preferably one having 1 to 12, particularly 1 to 5, carbon atoms though the acyl group is not specifically limited. In concrete, a formyl group, an acetyl group, a propionyl group, a butylyl group, a varelyl group, a parmitoyl group and oleyl group can be exemplified. The alkyl group represented by R² is not specifically limited and may be one having a straight chain or a branched chain. The alkyl group is preferably one having 1 to 24, and particularly from 1 to 4, carbon atoms. In concrete, a methyl group, an ethyl group, an n-propyl group, an isopropyl group, an n-butyl group, an isobutyl group, a sec-butyl group and a t-butyl group are exemplified. Particularly, one in which R¹ is a hydrogen atom, R² is a methyl group or an ethyl group, and one in which R¹ is an acetyl group and R² is a methyl group or an ethyl group are preferable as the plasticizer for the cellulose ester type resin.

Production of citrate compound in which R¹ is a hydrogen atom

Among the citrate compounds usable in the invention, ones in which R¹ is a hydrogen atom can be produced by known methods. As the known method, for example, a method described in British Patent No. 931,781 is applicable, in which phthalyl glycolate is produced from a halfester of phallic acid and an alkyl α-halogenized acetate. In concrete, an amount of larger than the stoichiometric amount, preferably 1 to 10 moles, and more preferably from 2 to 5 moles of an alkyl monohalogenized acetate corresponding to R² such as a methyl monochloroacetate trisodium citrate or ethyl monochloroacetate reacts with tripotassium acetate or citric acid, hereinafter referred to as citric acid raw material, preferably 1 mole of trisodium citrate. The presence of water in the reaction system lowers the yield of the objective compound. Therefore, dehydrated material is employed as long as possible. For the reaction, a chain or a cyclic aliphatic tertiary amine such as trimethylamine, triethylamine, tri-n-propylamine, triisopropylamine, tri-n-butylamine and dimethylcyclo-hexylamine can be employed as a catalyst. Among them, triethylamine is preferred. The using amount of the catalyst is from 0.01 to 1.0 moles, preferably from 0.2 to 0.5 moles, per mole of the raw material citric acid. The reaction is performed at a temperature of from 60 to 150° C. for a time of from 1 to 24 hours. A solvent such as toluene, benzene xylene and methyl ethyl ketone may be employed, though it is not essential. After the reaction, for example, byproducts and the catalyst are removed by adding water, and the oil layer is washed by water. And then the leaving raw compounds are separated by distillation to isolate the objective compound.

Production of citrate compound in which R¹ is an aliphatic acyl group

The citrate compounds of the invention in which R¹ is an aliphatic acyl group and R² is an alkyl group can be produced by employing the foregoing compound in which R¹ is a hydrogen atom. Namely, 1 mole of the citrate compound reacts with 1 to 10 moles a halogenized acyl compound corresponding to the aliphatic acyl group represented by R¹ such as formyl chloride or a acetyl chloride. As a catalyst, 0.1 to 2 moles of a basic compound such as pyridine can be employed per moles of the citrate compound. The reaction can be performed without any solvent for a time of from 1 to 5 hours at a temperature of from 80 to 100° C. After the reaction, water and a water insoluble organic solvent such as toluene are added to the reacting mixture so that the objective compound is dissolved in the organic solvent, and then the organic solvent layer is separated from the aqueous layer and the organic solvent layer is washed. Thereafter, the objective compound can be isolated by a usual method such as distillation.

The citrate compound employed in the invention is particularly preferable because occurrences of the chalking and the line-shaped defects in the active radiation hardenable resin layer are inhibited when it is employed in the combination with the UV absorbent having a weight average molecular weight of from 490 to 50,000.

The adding amount of the citrate compound to be added to the cellulose resin is preferably from 5 to 200, particularly from 10 to 200, parts by weight per 100 parts by weight of the cellulose resin.

The content of the citrate compound in the film is preferably from 1 to 30%, and particularly from 2 to 20%, by weight.

As the phosphate type plasticizer, for example, triphenyl phosphate, tricresyl phosphate, cresyl diphenyl phosphate, octyl diphenyl phosphate, diphenyl biphenyl phosphate, trioctyl phosphate and tributyl phosphate are employable, and as the phthalate type plasticizer, for example, diethyl phthalate, dimethoxyethyl phthalate, dimethyl phthalate, dioctyl phthalate, dibutyl phthalate, di-2-ethylhexyl phthalate and-dicyclohexyl phthalate are employable. In the invention, it is preferable that the content of the phosphate type plasticizer is not more than 40%, and more preferably not more than 1%, by weight of the entire amount of plasticizer. No addition of the phosphate type plasticizer is further preferable.

Ethylene glycol ester type plasticizer: In concrete, this type of plasticizer includes an ethylene glycol ester type plasticizer such as ethylene glycol diacetate and ethylene glycol dibutylate, a ethylene glycol cycloalkyl ester type plasticizer such as ethylene glycol dicyclopropylcarboxylate, ethylene glycol dicyclohexyl-carboxylate, and an ethylene glycol aryl ester plasticizer such as ethylene glycol dibenzoate and ethylene glycol 4-methylbenzoate. In the above compounds, the alkylate group, the cycloalkylate group and the allylate group may be the same or different, and may further have a substituent. A mixed ester of the alkylate group, the cycloalkylate group and the allylate group is allowed. These substituents may be bonded with together by a covalent bond. The ethylene glycol moiety may have a substituent, and may be partially or regularly bonded with a polymer in a form of pendant. Moreover, the plasticizer may be included as a partial structure of an additive such as an antioxidant, an acid scavenger and a UV absorbent.

Glycerol ester type plasticizer: In concrete, this type of plasticizer includes a glycerol alkyl ester such as triacetine, tributine, glycerol diacetate caprylate and glycerol oleate propionate, a glycerol cycloalkyl ester such as glycerol tricycropropylpropionate and glycerol tricyclohexylcarboxylate, a glycerol aryl ester such as glycerol tribenzoate and glycerol 4-methylbenzoate, a diglycerol alkyl ester such as diglycerol tetraacetylate, diglycerol tetrapropionate, diglycerol acetate tricaprylate and diglycerol tetralaurate, diglycerol tetracyclobutylcarboxylate and diglycerol tetrapentylcarboxylate, and a diglycerol aryl ester such as diglycerol tetrabenzoate and diglycerol 3-methylbenzoate. In the above compounds, the alkylate group, the cycloalkycarboxylate group and the allylate group may be the same or different, and may further have a substituent. A mixed ester of the alkylate group, the cycloalkylcarboxylate group and the allylate group is allowed. These substituents may be bonded with together by a covalent bond. The ethylene glycol moiety may have a substituent, and may be partially or regularly bonded with a polymer in a form of pendant. Moreover, the plasticizer may be included as a partial structure of an additive such as an antioxidant, an acid scavenger and a UV absorbent.

Dicarboxylate type plasticizer: In concrete, this type of plasticizer includes an alkyl alkyldicarboxylate type plasticizer such as dodecyl marinate (C1), dioctyl adipate (C4) and dibutyl sebacate, a cycloalkyl alkyldicarboxylate type plasticizer such as dicyclopentyl succinate and cyclohexyl adipate, an aryl alkyldicarboxylate plasticizer such as diphenyl succinate and di-4-methylphenyl glutamate, an alkyl cycloalkyldicarboxylate such as Dihexyl 1,4-cyclohexanedicarboxylate and decyl bicyclo[2.2.1]heptane-2,3-dicarboxylate, a cycloalkyl cycloalkyldicarboxylate type plasticizer such as dicyclohexyl 1,2-cyclobutanedicarboxylate and dicyclopropyl 1,2-cyclohexyldicarboxylate, an aryl cycloalkyldicarboxylate type plasticizer such as diphenyl 1,1-cyclopropyl-dicarboxylate and di-2-naphthyl 1,4-cyclohexane-dicarboxylate, an alkyl aryldicarboxylate type plasticizer such as diethyl phthalate, dimethyl phthalate, dioctyl phthalate, dibutyl phthalate and di-2-ethylhexyl phthalate, a cycloalkyl aryldicarboxylate type plasticizer such as dicyclopropyl phthalate and dicyclohexyl phthalate, and an aryl aryldicarboxylate type plasticizer such as diphenyl phthalate and di-4-methylphenyl phthalate. In the above compounds, the alkoxy group and the cycloalkoxy group may be the same or different, and may have a substituent and the substituent may further have a substituent. A mixed ester of the alkoxy group and the cycloalkoxy group is allowed. These substituents may be bonded with together by a covalent bond. The aromatic ring of phthalic acid may have a substituent, and may be a polymer such as a dimer, trimer and a tetramer. A part of the phthalate may be partially or regularly bonded with a polymer in a form of pendant. Moreover, the phthalate may be included as a partial structure of an additive such as an antioxidant, an acid scavenger and a UV absorbent.

Polyvalent-carboxylate type plasticizer: In concrete, this type of plasticizer includes an alkyl alkylpolycarboxylate type plasticizer such as tridodecyl tricabalate and tributyl meso-butane-1,2,3,4-tetrecarboxylate, a cycloalkyl alkylpolycarboxylate type plasticizer such as tricyclohexyl tricarbalate, tricyclopropyl 2-hydroxy-1,2,3-propane-tricarboxylate, an aryl alkylpolycarboxylate type plasticizer such as triphenyl 2-hydroxy-1,2,3-propanetricarboxylate and tetra-3-methylphenyl tetrahydrofuran-2,3,4,5-tetracarboxylate, an alkyl cycloalkylpolycarboxylate type plasticizer such as tetrahexyl 1,2,3,4-cyclobutane-teracarboxylate and tetrabutyl 1,2,3,4-cyclopentane-tetracarboxylate, a cycloalkyl cycloalkylpolycarboxylate type plasticizer such as tetracyclopropyl 1,2,3,4-cyclobutane-tetracarboxylate and tricyclohexyl 1,3,5-cyclohexyl-tricarboxylate, an aryl cycloalkylpolycarboxylate and hexa-4-methylphenyl 1,2,3,4,5,6-cyclohexylhexacarboxylate, an alkyl arylpolycarboxylate type plasticizer such as tridodecyl benznene-1,2,4-tricarboxylate and tetraoctyl benzene-1,2,4,5-tetracarboxylate, a cycloalkyl arylpolycarboxylate type plasticizer such as tricyclopentyl benzne-1,3,50tricarboxylate and tetracyclohexyl benzene-1,2,3,5-tetracarboxylate, and a aryl arylpolycarboxylate type plasticizer such as triphenyl benzene-1,3,5-tetracarboxylate and hexa-4-methylphenyl benzene 1,2,3,4,5,6-hexacarboxylate. In the above compounds, the alkoxy group and the cycloalkoxy group may be the same or different, and may have a substituent and the substituent may further have a substituent. A mixed ester of the alkoxy group and the cycloalkoxy group is allowed. These substituents may be bonded with together by a covalent bond. The aromatic ring of phthalic acid may have a substituent, and may be a polymer such as a dimer, trimer and a tetramer. A part of the phthalate may be partially or regularly bonded with a polymer in a form of pendant. Moreover, the phthalate may be included as a partial structure of an additive such as an antioxidant, an acid scavenger and a UV absorbent.

Polymer plasticizer: In concrete, this type of plasticizer includes an aliphatic hydrocarbon type polymer, an alicyclic hydrocarbon type polymer, an acryl type polymer such as poly(ethyl acrylate) and poly(methyl methacrylate), a vinyl type polymer such as poly(vinyl isobutyl ether) and poly(N-vinylpyrrolidone), a styrene type polymer such as polystyrene and poly(4-hydroxystyrene), a polyeater such as poly(butylene succinate), poly(ethylene terephthalate) and poly(ethylene naphthalate), a polyether such as poly(ethylene oxide) and poly(propylene oxide), polyamide, polyurethane and polyurea. The preferable number average molecular weight of these compounds is approximately from 1,000 to 500,000, and particularly from 5,000 to 200,000. The molecular weight of less than 1,000 causes a problem in the volatility, and that of more than 500,000 causes degradation in the plasticizing ability and bad influences are appeared in the mechanical properties of the cellulose ester derivative composition. These polymer plasticizers may be either a homopolymer composed of one kind of repeating unit or a copolymer having plural kinds of repeating unit. Two or more kinds of the polymer may be employed in combination and another additive such as another plasticizer, an antioxidant, an acid scavenger, a UV absorbent, a slipping agent and a matting agent may be contained.

These plasticizers may be employed solely or in combination of two or more kinds thereof. The total content of the plasticizer in the film of less than 1% by weight is not preferable because the moisture permeation lowering effect becomes insufficient, and that of more than 30% by weight tends to cause problems in the compatibility and the bleeding out and the degradation in the physical property of the film. Therefore, the content is preferably from 1 to 30%, more preferably from 2 to 25%, and particularly preferably from 8 to 20%, by weight.

Mixing of cellulose resin and additive

It is preferable that the cellulose ester is blended with the additives such as the plasticizer and the UV absorbent before melting by heat.

For mixing the additives with the cellulose resin, a method is applicable, in which the cellulose resin is dissolved in a solvent and the additives are dissolved or finely dispersed in the resultant solution, and then the solvent is removed. For removing the solvent, known methods can be applied. For example, a drying in liquid method, a drying in gas method, a solvent co-precipitation method, a freeze drying method and a solution cascading method are applicable. The mixture of the cellulose resin and the additives can be made in a state of powder, granules, pelts and film.

As described above, the mixing of the additives is performed in the solution of the cellulose resin, and the mixing may be performed simultaneously with the precipitation and solidification of the cellulose resin in the course of the production thereof.

In the drying in liquid method, a solution of the cellulose resin and the additives is dispersed into an emulsion state by addition of an aqueous solution of a surfactant such as sodium laurate. And then the solvent is removed under an ordinal or reduced pressure so that a dispersion of the cellulose resin mixed with the additives can be obtained. Moreover, centrifugal separation or decantation is preferably applied for removing the solvent. For the emulsification, various methods can be applied and the use of a emulsifying apparatus by ultrasonic waves, high speed rotation sharing force or high pressure is preferable.

In the emulsifying dispersion by the ultrasonic waves, a batch process and a continuous process can be applied. The batch process is useful for preparing relatively small amount of sample, and the continuous process is suitable for preparing a large amount of sample. In the continuous process, for example, an apparatus such as UH-600SR, manufactured by MST Co., Ltd., can be employed. In the case of the continuous process, the applying time of the ultrasonic waves can be calculated by (dispersing chamber volume)/(flowing rate)×(number of cycling times). When plural ultrasonic wave sources are employed, the applying time is the sum of the applying times of each of the sources. The applying time of the ultrasonic waves is practically not more than 10,000 seconds. When the applying time is over 10,000 seconds, the load on the production process becomes too large and the emulsification time should be shortened by selection of the emulsifying agent in practice. Therefore, the application for longer than 10,000 seconds is unnecessary. The application time of the ultrasonic waves is preferably from 10 to 2,000 seconds.

As the emulsifying apparatus by high speed shearing force, for example, Dispermixer, Homomier and Ultramixer are employable. The type of such the mixer can be selected depending on the viscosity of the liquid to be dispersed.

For the emulsifying by high pressure, for example, LAB2000, manufactured by SMT Co., Ltd., is employable. The emulsifying and dispersing ability of that is depending on the pressure applied to the sample. The pressure is preferably within the range of from 10⁴ to 5×10⁵ kPa.

An anionic surfactant, a cationic surfactant, an amphoteric surfactant and a polymer surfactant can be used as the surfactant, which are selected depending on the kind of solvent or the diameter of the objective emulsion.

In the drying in gas method, the solution containing the cellulose resin and the additives is splayed and dried by using a splay dryer such as GS310, Yamato Kagaku Co., Ltd.

In the solvent co-precipitation method, the solution containing the cellulose resin and the additives is poured into a poor solvent to precipitate the cellulose resin and the additives. The poor solvent is one capable of arbitrarily mixing with the solvent for the cellulose resin. The poor solvent may be a mixed solvent. It is also allowed that the poor solvent is added into the solution of the cellulose resin and the additives.

The precipitated mixture of the cellulose resin and the additives can be separated by filtering and drying.

In the mixture of the cellulose resin and the additives, the particular diameter of the additives is preferably not more than 1 μm, more preferably not more than 500 nm, and particularly preferably not less than 200 μm. Smaller diameter is preferable since the distribution of the mechanical and optical properties of the molten composition can be made uniform.

The mixture of the cellulose resin and the additives and the additive to be added on the occasion of melting by heat is preferably dried before or during the melting by heat. The drying means to remove the moisture absorbed by any raw materials, water or the solvent used for preparing the mixture of the cellulose resin and the additives and a solvent mixed in the additives on the occasion synthesizing thereof.

For removing the water and the solvent, known drying methods such as a heating method, a pressure reducing method, a method by heating under reduced pressure can be applied, and the process can be performed under atmosphere of air or nitrogen as an inactive gas. The drying by the known methods is preferably performed at a temperature range in which the materials are not decomposed for holding the quality of the film.

The amount of remaining water or solvent after the drying process is not less than 10%, preferably not less than 5%, more preferably not less than 1%, and further preferably not less than 0.1%, by weight of the total weight of the materials for constituting the film. The drying temperature is preferably a temperature of not less than 100° C. and less than the Tg of the material to be dried. For avoiding fusion of the material, it is preferably that the drying temperature is within the range of from 100° C. to (Tg-5)° C., and more preferably from 110° C. to (Tg-20)° C. The drying time is preferably from 0.5 to 24 hours, more preferably from 1 to 18 hours, and further preferably from 1.5 to 12 hours. When the time is smaller than the above range, the drying degree is tends to be low or too long time is required. When the material to be dried has a Tg, the material is made to difficultly handle by the fusion thereof if the material is heated at the drying temperature higher than the Tg thereof.

The drying process may be separated into two steps, for example, a step of storing the material in a preliminary drying process and a step of drying just before melting which is performed within the period from just before to 1 week before melting for forming the film.

Additive

As the additive, an antioxidant, an acid capturing agent, a photo-stabilizer, a peroxide substance decomposing agent, a radical capturing agent, a metal inactivator, a metal compound such as a matting agent, a retardation controlling agent, a dye and a pigment may be employed additionally to the foregoing plasticizer and the UV absorbent. Other than the above, an additive which cannot be classified into the above additives may be employed when it has the above function.

The additives are employed for preventing oxidation of the film constituting material, capturing an acid formed by decomposition of the material and inhibiting or preventing the decomposition reaction caused by the radical species so as to inhibiting the deterioration of the material such as the coloring, decreasing in the molecular weight including a not cleared decomposing reaction and occurrence of volatile component, and for giving a function such as moisture permeating ability and a slipping ability.

Besides, the decomposition reaction in the film constituting materials is considerably progressed when the material is molten by heating, and the decomposition reaction some times causes coloring or degradation in the strength of the film constituting material. Moreover, undesirable volatile component tends to occur by the decomposition reaction of the film constituting materials.

The film constituting material preferably contains the above additives on the occasion of melting by heat, such the material is superior in the inhibition of the lowering in the strength caused by the degradation and decomposition of the material and in the keeping of the peculiar strength of the material.

The presence of the additives is effective for inhibiting the formation of a colored substance in the visible light region and for inhibiting or preventing undesirable properties of the optical film such as low transparency and high haze value caused by mixing of the volatile component.

The haze value is preferably less than 1%, and more preferably less than 0.5% because a haze exceeding 1% influences on the displayed image when the optical film is employed in the liquid crystal display having the constitution according to the invention.

A degradation reaction caused by oxygen in the air occurs some times in the storage or in the film forming process of the film constituting materials. In such the case, it is preferable to decrease the oxygen concentration in the air together with the stabilizing effect of the additive. The decreasing in the oxygen concentration can be performed by know methods, for example, the use of inactive gas such as nitrogen and argon, the air exhaustion operation for making reduced pressure to vacuum, and the processing in a closed environment. At least one of the above three methods can be applied together with the use of the foregoing additives. The degradation of the materials can be inhibited by reducing the probability of contacting the materials with oxygen in the air, such the process is preferable for in object of the invention.

The presence of the additives in the film constituting material is preferable for using the film as the polarizing plate protective film from the viewpoint of the improving of the storage durability of the polarizing plate or the polarizing element constituting the polarizing plate.

In the display employing the polarizing plate of the invention, the variation and degradation of the optical film can be inhibited by the presence of the additives so that the durability during the storage can be improved, and the function of the optical compensation design of the optical film is maintained for a long period.

The additives are further described in detail.

Antioxidant

The antioxidant to be employed in the invention is described below.

As the antioxidant, a phenol type antioxidant, a phosphoric acid type antioxidant, a sulfur type antioxidant, a stabilizer against heat processing and an oxygen scavenger are employable, and among them the phenol type antioxidant, and particularly an alkyl-substituted phenol type antioxidant are preferable. The coloring and the lowering in the strength of the formed product caused by the heating and the oxidation on the occasion of the formation can be prevented without any decreasing in the transparence and the anti-heating ability. These antioxidants may be employed solely or in combination of two or more kinds thereof. The adding amount can be optionally decided within the range in which the object of the invention is not disturbed, and is preferably from 0.001 to 5, and more preferably from 0.01 to 1, parts by weight per 100 parts by weight of the polymer relating to the invention.

As the antioxidant, a hindered phenol antioxidant is preferred, which includes 2,6-dialkylphenol derivatives described in U.S. Pat. No. 4,839,405, columns 12 to 14. Such the compounds include ones represented by Formula 7.

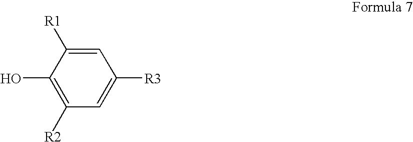

In the above formula, R1, R2 and R3 are each a substituted or unsubstituted alkyl group. Concrete examples of the hindered phenol compound include n-octadecyl 3-(3,5-di-t-butyl-4-hydroxyphenyl)propionate, n-octadecyl 3-(3,5-di t-butyl-4-hydroxyphenyl)acetate, n-octadecyl 3,5-di t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neododecyl 3-(dodecyl P-(3,5-di-t-butyl-4-hydroxyphenyl)propionate, ethyl a-(4-hydroxy-3,5-di-t-butylphenyl)isobutylate, octadecyl a-(4-hydroxy-3,5-di-t-butylphenyl)isobutylate, octadecyl a-(4-hydroxy- 3,5-di-t-butyl-4-hydroxyphenyl)propionate, 2-(n-octyl)ethyl 3,5-di-t-butyl-e-hydroxybenzoate, 2-(n-octyl)ethyl 3,5-di-t-butyl-4-hydroxyphenylacetate, 2-(n-octadecylthio)ethyl 3,5-di-t-butyl-4-hydroxyphenyl-acetate, 2-(n-octadecylthio)ethyl 3,5-di-t-butyl-4-hydroxybenzoate, 2-(2-hydroxyethylthio)ethyl 3,5-di-t-butyl-4-hydroxybenzoate, diethylglycol bis-(3,5-di-t-butyl-4-hydroxyphenyl)propionate, 2-(n-octadecylthio)ethyl 3-(3,5-di-t-butyl-4-hydroxyphenyl)propionate, stearylamido N,N-bis[ethylene 3-(3,5-di-t-butyl-4-hydroxyphenyl)-propionate], n-butylimino N,N-bis-[ethylene 3-(3,5-di-t-butyl-4-hydroxyphenyl)propionate], 2-(2-stearoylo-yethylthio)ethyl 3,5-di-t-butyl-4-hydroxybenzoate, 2-(2-stearoylo-xyethylthio)ethyl 7-(3-methyl-5-t-butyl-4-hydroxyphenyl)heptanoate, 1,2-propylene glycol bis-[3-(3,5-di-t-butyl-4-hydroxyphenyl)propionate], ethylene glycol bis-[3-(3,5-di-t-butyl-4-hydroxyphenyl)-propionate], neopentyl glycol bis-[3-(3,5-di-t-butyl-4-hydroxyphenyl)propionate], ethylene glycol bis-(3,5-di-t-butyl-4-hydroxyphenylacetate), glycerol 1-n-octadecanoate-2,3-bis-(3,5-di-t-butyl-4-hdyroxyphenylacetate), pentaerythrytol tetrakis[3-(3,5-di-t-butyl-4′-hydroxyphenyl)propionate], 1,1,1-trimethylolethane tris[3-(3,5-di-t-butyl-hydroxyphenyl)propionate], sorbitol hexa-[3-(3,5-di-t-butyl-hydroxyphenyl)propionate], 2-hydroxyethyl 7-(3,5-di-t-butyl-hydroxyphenyl)propionate, 2-stearoyloxyethyl 7-(3,5-di-t-butyl-hydroxyphenyl)-heptanoate, 1,6-n-hexanediol bis-[(3,5-di-t-butyl-4-hydroxyphenyl)propionate] and pentaerythrytol tetrakis(3,5-di-t-butyl-4-hydroxycinnamate). The above- described type hindered phenol antioxidant is, for example, available on the market under the commercial name of Irganox 1076 and Irganox 1010 of Ciba Specialty Chemicals.

Concrete examples of another antioxidant include a phosphor type antioxidant such as trisnonylphenyl phosphite and tris(2,4-di-tert-butylphenyl) phosphite, a sulfur type antioxidant such as dilauryl 3,3′-thiopropionate, dimyristyl 3,3′-thiopropionate, distearyl 3,3′-thiopropionate and pentaerythrytyl tetrakis(3-laurylthiopropionate), an antiheating stabilizer such as 2-tert-butyl-6-(3-tert-butyl-2-hydroxy-5-methylbenzyl)-4-methylphenyl-acrylate and 2-[1-(2-hydroxy-3,5-di-tert-pentylphenyl-acrylate, a 3,4-dihydro-2H-1-benzopurane type compound described in Tokkai Hei 8-27508, a 3,3′-spyrodichroman type compound, a 1,1-spyroindan type compound, morpholine, thiomorpholine, thiomorpholine oxide, thiomorpholine dioxide, a compound having piperazine skeleton as a partial structure thereof, and an oxygen scavenger such as a dialkoxybenzene type compound described in Tokkai Hei 3-174150. A part of each of these antioxidants may be partially or regularly bonded with a polymer in a form of pendant. Moreover, the plasticizer may be included as a partial structure of an additive such as an antioxidant, an acid scavenger and a UV absorbent.

Acid Capturing Agent

As the acid capturing agent, ones containing an acid capturing epoxy compound described in U.S. Pat. No. 4,137,201 are preferable. Such the epoxy compounds as the acid capturing agent have been known in the field of the art, and examples thereof include glycidyl ether of various polyethylene glycols, particularly a polyglycol driven by condensation of approximately 8 to 40 moles of ethylene glycol per mole of the polyglycol, diglycidyl ether of glycerol, an metal epoxy compound, for example, ones usually used in a vinyl polymer composition, an epoxide ether condensate, diglycidyl ether of bisphenol A namely 4,4′-dihydroxydiphenyldimethylmthane, an epoxide unsaturated fatty acid ester, particularly an ester of alkyl having 2 to 4 carbon atoms of a fatty acid having 2 to 22 carbon atoms such as butyl epoxystearate, and a triglyceride of one of various epoxide long chain fatty acids, for example, an epoxide soybean oil composition. The examples further include an epoxide of plant oil or another unsaturated natural oil. The epoxide oils are sometimes called as epoxide of natural glyceride or epoxide of unsaturated fatty acid and these fatty acids are each contains 12 to 22 carbon atoms. An epoxy group-containing epoxide resin compound available on the market EPON815c, manufacture by Miller-Stephenson Chemical Co., Ltd., and an epoxide ether oligomer condensation product represented by Formula 8 are particularly preferable.

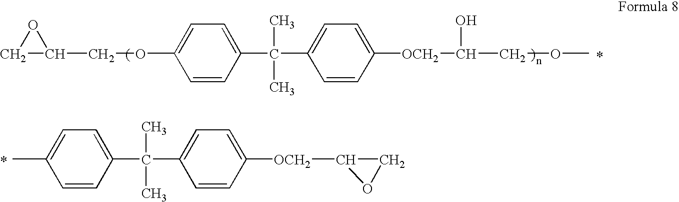

In the above formula, n is an integer of from 0 to 12. Further employable acid capturing agent includes those described in Tokkai Hei 5-194788, paragraphs 87 to 105.

Photo-Stabilizer

As the photo-stabilizer, a hindered amine photo-stabilizer (HALS) is employable, which is known compound and includes a 2,2,6,6-tetra-alkylpiperidine compound and its acid addition salt and a metal complex thereof, as described in U.S. Pat. No. 4,619,956, columns 5 to 11 and U.S. Pat. No. 4,839,504, columns 3 to 5. Such the compounds include a compound represented by Formula 9.

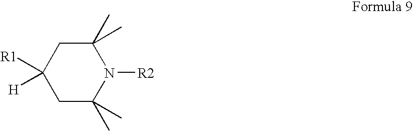

In the above formula, R1 and R2 are each a hydrogen atom or a substituent. Concrete examples of the hindered amine photo-stabilizer include 4-hydroxy-2,2,6,6-tetramethyl-piperidine, a allyl-4-hydroxy-2,2,6,6-tetramethyl-piperidine, 1-benzyl-4-hydroxy-2,2,6,6-tetramethyl-piperidine, 1-(4-t-butyl-2-butenyl)-4-hydroxy-2,2,6,6-tetramethylpiperidine, 4-stearoyloxy-2,2,6,6-tetramethylpiperidine, 1-ethyl-4-saliciloyloxy-2,2,6,6-tetramethylpiperidine, 4-methacryloyloxy-1,2,2,6,6-pentamethylpiperidine, 1,2,2,6,6-pentamethylpiperidine-4-yl-β(3,5-di-t-butyl-4-hydroxyphenyl)-propionate, 1-benzyl-2,2,6,6-tetramethyl-4-piperidinylamleinate, (di-2,2,6,6-tetramethylpiperidine-4-yl)-adipate, (di-2,2,6,6-tetramethylpiperidine-4-yl)-sebacate, (di-1,2,3,6-tetramethyl-2,6-diethyl-piperidine-4-yl)-sebacate, (di-1-allyl-2,2,6,6-tetramethylpiperidine-4-yl)-phthalate, 1-acetyl-2,2,6,6-tetramethylpiperidine-4-yl)-acetate, trimellitic acid ester of tri-(2,2,6,-tetramethyl-piperidine-4-yl), 1-acryloyl-4-benzyloxy-2,2,6,6-tetramthyl-piperidine, di-(1,2,2,6,6-pentamethyl-piperidine-4-yl)dibutylmalonate, di-(1,2,3,6-tetramethyl-2,6-diethylpiperidine-4-yl)dibenzylmlonate, dimethyl-bis-(2,2,6,6-tetramethylpieridine-4-oxy)-silane, tris-(1-propyl-2,2,6,6-tetramethylpieridine-4-yl) phosphite, tris-(1-propyl-2,2,6,6-tetramethylpieridine-4-yl) phosphate, N,N′-bis-(2,2,6,6-tetramethylpieridine-4-yl)-hexamethylene-1,6-di-acetoamide, 1-acetyl-4-(N-cyclohexylacetamido)- 2,2,6,6-tetramethylpieridine, 4-benzylamino-2,2,6,6-tetramethyl-pieridine, N,N′-bis-(2,2,6,6-tetramethyl-pieridine-4-yl)-N,N′-dibutyl-adipamide, N,N′-bis-(2,2,6,6-tetramethylpieridine-4-yl)-N,N′-dicyclohexyl-(2-hydroxypropylene), N,N′-bis-(2,2,6,6-tetramethyl-pieridine-4-yl)-p-xylenediamine, 4-(bis-2-hydroxyethyl)-amino-1,2,2,6,6-pentamethylpiperidine, 4-methacrylamido-1,2,2,6,6-pentamethylpiperidine and methyl α-cyano-β-methyl-β-[N-2,2,6,6-tetramethylpieridine-4-yl)]-amino-acrylate. Preferable hindered amine photo-stabilizer includes the following HALS-1 and HALS-2.

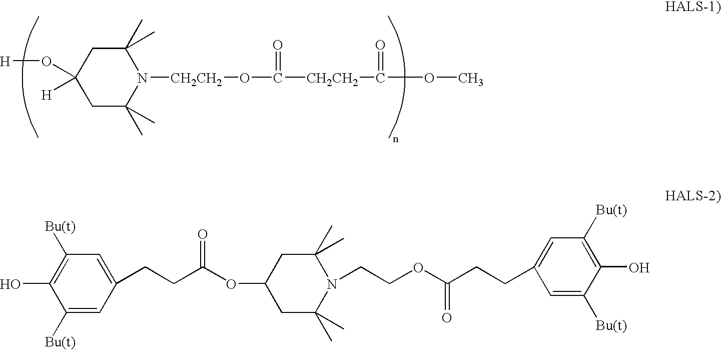

These hindered amine photo-stabilizers may be employed solely or in combination of two or more kinds thereof. The hindered amine photo-stabilizer may be employed together with the additives such as the plasticizer, acid scavenger and UV absorbent, and may be introduced into a part of the structure of the additive. Though the adding amount of the photo-stabilizer is suitably decided within the range in which the object of the invention is not disturbed, and is preferably from 0.01 to 10%, more preferably from 0.01 to 5%, and particularly preferably from 0.05 to 1%, by weight.

Fine Particle Agent

A fine particle agent such as a matting agent can be added to the optical film of the invention for giving slipping ability and improving physical properties of the film. As the fine particle, a fine particle of an inorganic compound and that of an organic compound can be employed. The shape of the fine particle may be spherical, planar, rod-like, needle-like, layer like and irregular shape.

Example of the fine particle include an oxide, hydroxide, silicate, phosphate and carbonate of a metal such as silicon dioxide, titanium dioxide, aluminum oxide, zirconium oxide, calcium carbonate, kaolin, talc, baked calcium silicate, hydrated calcium silicate, aluminum silicate, magnesium silicate and calcium phosphate, and a fine particle of a crosslinked polymer. Among them, silicon dioxide is preferable since the haze of the film can be lowered by it. The fine particle such as the silicon dioxide is frequently subjected to a surface treatment by an organic compound, and the surface treated fine particle is preferable since the haze of the film can be reduced by it.

The preferable organic compound for the surface treatment includes a halosilane, an alkoxysilane, a silazane and siloxane. The fine particle having lager average diameter displays higher slipping effect and one having lower average diameter is superior in the transparency. The average diameter of the fine particle is within the range of from 0.005 to 1.0 μm. The particle may be a primary particle or a secondary particle formed by coagulation. The average diameter of the primary particles is preferably from 5 to 50 nm, and more preferably from 7 to 14 nm. These fine particles can form irregularity of from 0.01 to 1.0 μm on the film surface. The content of the fine particles in the cellulose ester is 0.005 to 10%, and preferably from 0.05 to 5%, by weight of the cellulose ester.

Examples of the fine particle of silicon dioxide inclued Aerosil 200, 200V, 300, R972, R972V, R974, R202, R812, OX50 and TT600, each manufactured by Nihon Aerosil Co., Ltd., and Aerosil 200V, R972, R972V, R974, R202 and R812 are preferable. The fine particles may be employed in a combination of two or more kinds thereof. In such the case, the fine particles different from each other in the average diameter or material may be employed in combination, for example, Aerogil 200V and R972 can be employed within the range of from 0.1:99.9 to 99.9:0.1.

The fine particle can be added by kneading with the resin, furthermore, by kneading together with the plasticizer, the hindered amine compound, the UV absorbent or the acid capturing agent. Besides, one prepared by a method can be employed, in which the fine particle dispersed in a solvent such as methanol and ethanol is sprayed onto the cellulose resin and mixed after dried. Moreover, the fine particle dispersed in the solvent is added to a cellulose resin dissolved in a solvent mainly composed of methylene chloride or methyl acetate and the resultant mixture is dried for solidifying. Thus obtained solid material may be employed for the material of the melt-cascading process. The cellulose resin solution containing the fine particles preferably may further contain a part or whole of the additives such as the plasticizer, the hindered amine compound, the hindered phenol compound, the UV absorbent and the acid capturing agent.

The film having a surface layer containing the fine particles can be formed by a co-extrusion method or a successive extrusion method. By such the method, the surface layer containing fine particles having an average diameter of not more than 1.0 μm can be formed on at least one of the surfaces of the film. When the film has the surface layer containing the fine particles, the fine particles may be contained in the inner base film.

Retardation Inhibiting Agent

Optical compensation function can be given to the optical film of the invention for improving the quality of displayed image by adding a retardation controlling agent or providing a liquid crystal layer by forming a oriented layer for combining the retardation caused by the liquid crystal layer to the optical film. As the compound to be added for controlling the retardation, an aromatic compound having two or more aromatic rings such as that described in European Patent No. 911,656A, ay be employed. For example, the following rod-shaped compounds are applicable. Two or more kinds of the aromatic compound may be employed with together. The aromatic ring of the aromatic compound includes an aromatic heterocycle additionally to an aromatic hydrocarbon ring. The aromatic heterocycle is particularly preferable, and the heterocycle is usually unsaturated heterocycles. Among them, a 1,3,5-triazine ring is preferred.

Rod-Shaped Compound

The optical film according to the invention preferably contains a rod-shaped compound which has the maximum absorption wavelength (λₘₐₓ) in UV absorption spectrum at a wavelength of not longer than 250 nm.

The rod-shaped compound preferably has one or more, and preferably two or more, aromatic rings from the viewpoint of the retardation controlling function. The rod-shaped compound preferably has a linear molecular structure. The linear molecular structure means that the molecular structure of the rod-shaped compound is linear in the thermodynamically most stable structure state. The thermodynamically most stable structure can be determined by crystal structure analyzing or molecular orbital calculation. The molecular structure, by which the heat of formation is made minimum, can be determined on the calculation by, for example, a software for molecular orbital calculation WinMOPAC2000, manufactured by Fujitsu Co., Ltd. The linear molecular structure means that the angle of the molecular structure is not less than 140° in the thermodynamically most stable structure calculated as the above. The rod-shaped compound is preferably one displaying a liquid crystal property. The rod-shaped compound more preferably displays a crystal liquid property by heating (thermotropic liquid crystal property). The phase of the liquid crystal is preferably a nematic phase or a smectic phase.

As the rod-shaped compound, trans-1,4-cyclohexane-dicarboxylic acid esters represented by the following Formula 10 are preferable.
Ar¹-L¹-Ar² Formula 10

In Formula 10, Ar¹ and R² are each independently an aromatic group. The aromatic group includes an aryl group (an aromatic hydrocarbon group), a substituted aryl group, an aromatic heterocyclic group and a substituted heterocyclic group. The aryl group and the substituted alkyl group are more preferable than the aromatic heterocyclic group and the substituted aromatic heterocyclic group. The heterocycle of the aromatic heterocyclic group is usually unsaturated. The aromatic heterocyclic group is preferably a 5-, 6- or 7-member ring, and more preferably a 5- or 6-member ring. The heterocyclic ring usually has the largest number of double bond. The hetero atom is preferably a nitrogen atom, an oxygen atom or a sulfur atom and the nitrogen atom or the oxygen atom is more preferable. Examples of the aromatic heterocyclic ring include a furan ring, a thiophene ring, a pyrrole ring, an oxazole ring, in isoxazole ring, a thiazole ring, an isothiazole ring, an imidazole ring, a pyrazole ring, a furazane ring, a triazole ring, a pyrane ring, a pyridine ring, a pyridazine ring, a pyrimidine ring, a pyrazine ring and a 1,3,5-triazine ring. As the aromatic ring of the aromatic group, a benzene ring, a furan ring, a thiophene ring, a pyrrole ring, an oxazole ring, a thiazole ring, a thiazole ring, an imidazole ring, a triazole ring, a pyridine ring, a pyrimidine ring and pyrazine ring are preferable and the benzene ring is particularly preferable.

Examples of the substituent of the substituted aryl group and the substituted aromatic heterocyclic group include a halogen atom such as a fluorine chlorine atom, a chlorine atom, a bromine atom and an iodine atom, a hydroxyl group, a carboxyl group, a cyano group, an amino group, an alkylamino group such as a methylamino group, an ethylamino group, a utylamno group and a dimethylamino group, a nitro group, a sulfo group, a carbamoyl group, an alkylcarbamoyl group such as an N-methylcarbaamoyl group and an N,N-dimethylcarbamoyl group, a sulfamoyl group, an alkylsulfamoyl group such as an N-methylsulfamoyl group, an N-ethylsulfamoyl group and an N,N-dimethylsulfamoyl group, a ureido group, an alkylureido group such as an N-methylureido group, an N,N-dimethylureido group and N,N,N-trimethylureido group, an alkyl group such as a methyl group, an ethyl group, a propyl group, a butyl group, a pentyl group, a heptyl group, an octyl group, an isopropyl group, an s-butyl group, a t-amyl group, a cyclohexyl group and a cyclopentyl group, an alkenyl group such as a vinyl group, an allyl group and a hexenyl group, an alkynyl group such as an ethynyl group and a butynyl group, an acyl group such as a formyl group, an acetyl group, a butylyl group, a hexanoyl group and a lauryl group, an acyloxy group such as an acetoxy group, a butylyloxy group, a hexanoyloxy group and lauryloxy group, an alkoxy group such as a methoxy group, an ethoxy group, a propoxy group, a butoxy group, a pentyloxy group, a heptyloxy group and an octyloxy group, an aryloxy group such as a phenoxy group, an alkoxycarbonyl group such as a methoxycarbonyl group, an ethoxycarbonyl group, a propoxycarbonyl group, a butoxycarbonyl group, a pentyloxycarbonyl group and a heptyloxycarbonyl group, an aryloxycarbonyl group such as a phenoxycarbonyl group, a an alkoxycarbonylamino group such as a butoxycarbonylamino group and a hexyloxycarbonylamino group, an alkylthio group such as a methylthio group, an ethylthio group, a propylthio group, butylthio group, a pentylthio group, a heptylthio group and an octylthio group, an arylthio group such as a thiophenyl group, an alkylsulfonyl group such as a methylsulfonyl group, an ethylsulfonyl group, a propylsulfonyl group, a butylsulfonyl group, a pentylsulfonyl group, a heptylsulfonyl group and an octylsulfonyl group, an amido group such as an acetoamido group, a butylamido group, a hexylamido group and an octylamido group, and a non-aromatic heterocyclic group such as a morpholyl group and a pyradinyl group.

As the substituent of the substituted aryl group and the substituted aromatic heterocyclic group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferable. The alkyl moiety of the alkylamino group, the alkoxycarbonyl group, the alkoxy group and the alkylthio group, and the alkyl group each may further have a substituent. Examples of the substituent of the alkyl moiety or the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. The halogen atom, the hydroxyl group, an amino group, an alkylamino group, an acyl group, an acyloxy group, an acylamino group, an alkoxycarbonyl group and an alkoxy group are preferable as the substituent of the alkyl moiety or the alkyl group.

In Formula 10, L¹ is a di-valent bonding group selected from the group consisting of an alkylene group, an alkenylene -group, an alkynylene group, a di-valent saturated heterocyclic group, an —O— atom, a —CO— group and a combination of them. The alkylene group may have a cyclic structure. As the cyclic alkylene group, a cyclohexylene group is preferable, and 1,4-cyclohexylene group is more preferable. As the chain-shaped alkylene group, a straight-chain alkylene group is more preferable than a branched-chain alkylene group. The number of carbon atoms of the alkylene group is preferably from 1 to 20, more preferably from 1 to 15, further preferably from 1 to 10, further more preferably from 1 to 8, and most preferably from 1 to 6.

The alkenylene group and the alkynylene group each having a cyclic structure are more preferable than those having a chain structure, and a straight-chain structure is more preferably to a branched-chain structure. The number of carbon atom of the alkenylene group and the alkynylene group is preferably 2 to 10, more preferably from 2 to 8, further preferably from 2 to 6, and further more preferably 2 to 4, and most preferably 2, namely a vinylene or an ethynylene group. The di-valent saturated heterocyclic group is preferably from a 3- to 9-member heterocyclic ring. The hetero atom of the heterocyclic ring is preferably an oxygen atom, a nitrogen atom, a boron atom, a sulfur atom, a silicon atom, a phosphor atom or a germanium atom. Examples of the saturated heterocyclic ring include a piperidine ring, a piperazine ring, a morpholine ring, a pyrrolidine ring, an imidazolidine ring, a tetrahydrofuran ring, a tetrahydropyrane ring, a 1-3-dioxane ring, a 1,4-dioxane ring, a terahydrothiophene ring, a 1,3-thiazolidine ring, a 1,3-oxazolidine ring, a 1,3-dioxoran ring, a 1,3-dithiosilane ring and a 1,3,2-dioxoboran ring. Particularly preferable di-valent saturated heterocyclic group is a piperazine-1,4-diylene group, a 1,3-dioxane-2,5-diylene group and a 1,3,2-dioxobororane-2,5-diylene group.

Examples of divalent bonding group composed of a combination of groups are listed as follows.

L-1: —O—CO-alkylene-CO—O—

L-2: —CO—O-alkylene-O—CO—

L-3: —O—-CO-alkenylene-CO—O—

L-4: —CO—O-alkenylene-O—CO—

L-5: —O—CO-alkynylene-CO—O—

L-6: —CO—O-alkynylene-O—CO—

L-7: —O—-CO-divalent saturated heterocyclic group-CO—O—

L-8: —CO—O-divalent saturated heterocyclic group —O—CO—

In the structure of Formula 10, the angle formed by Ar¹ and Ar² through L¹ is preferably not less than 140°. Compounds represented by Formula 11 are further preferable as the rod-shaped compound.
Ar¹-L²-X-L³-Ar² Formula 11

In Formula 11, Ar¹ and Ar² are independently a di-valent bonding group selected from the group consisting of an alkylene group, an —O— atom, a —CO— group and a combination of them. The alkylene group having a chain structured is preferably to that having a cyclic structure, and a straight-chain structure is more preferably to a branched-chain structure. The number of carbon atoms in the alkylene group is preferably from 1 to 10, more preferably from 1 to 8, further preferably from 1 to 6, further more preferably 1 to 4, and most preferably 1 or 2, namely a methylene group or an ethylene group. L² and L³ are particularly preferably an —O—CO— group or a-CO—O— group.

In Formula 11, X is 1,4-cyclohexylene group, a vinylene group or a ethynylene group. Concrete examples of the compound represented by Formula 11 are listed below.

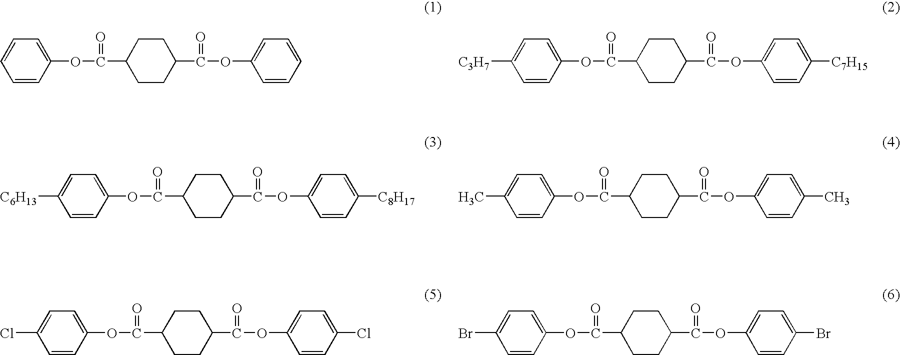

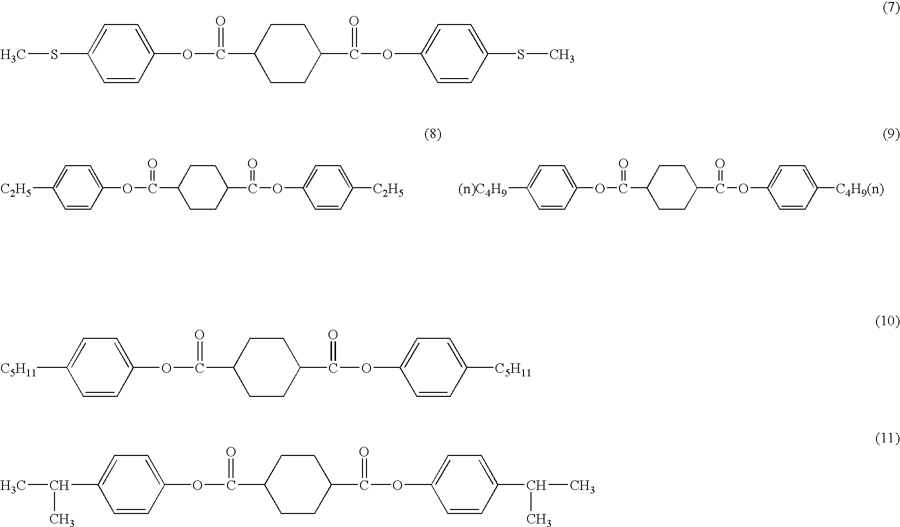

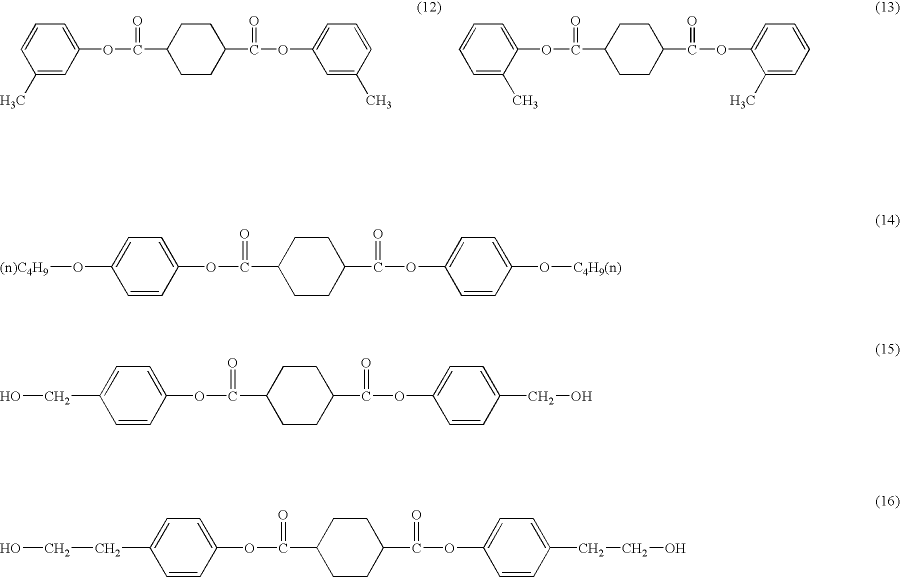

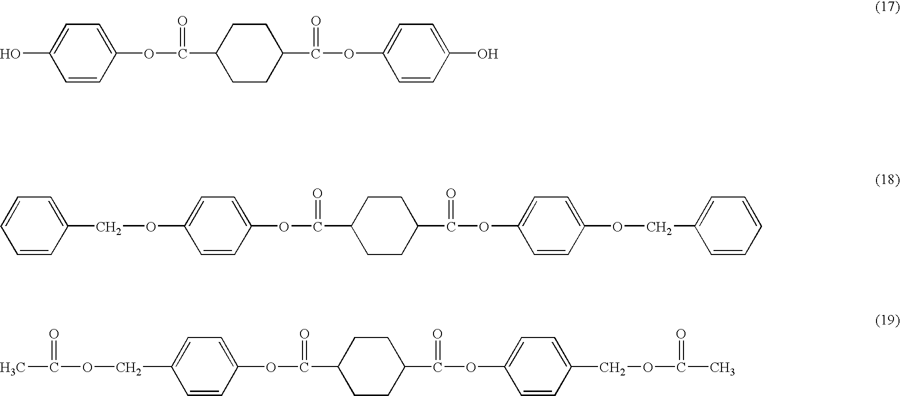

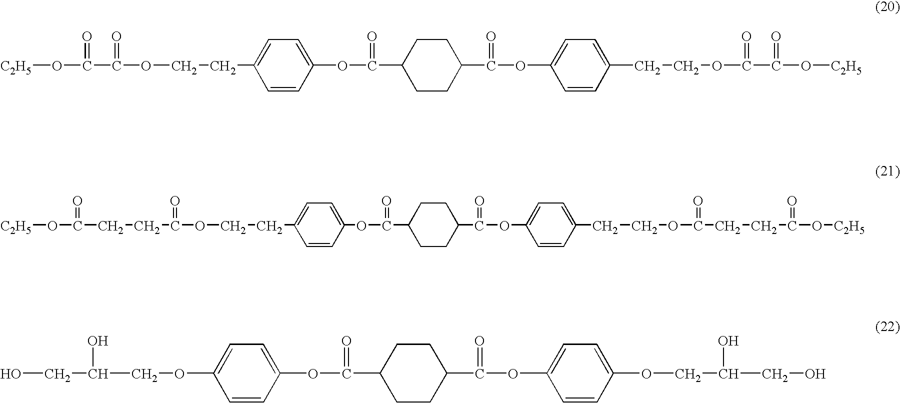

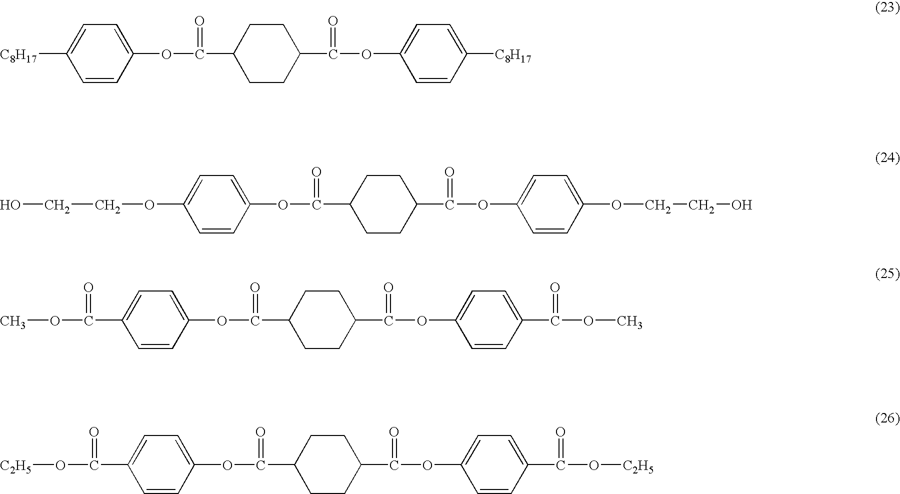

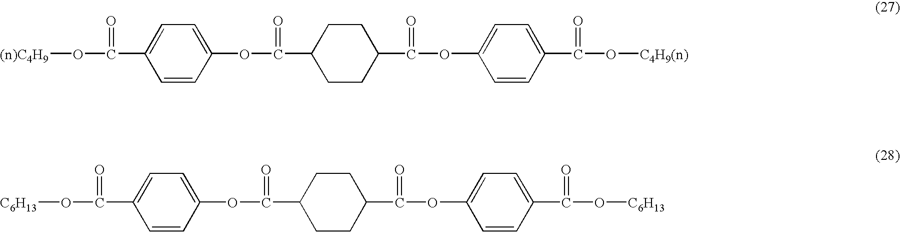

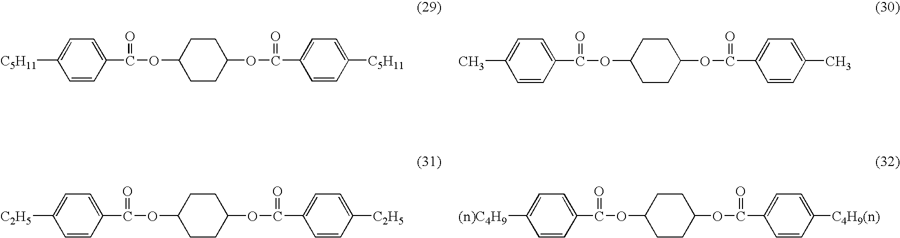

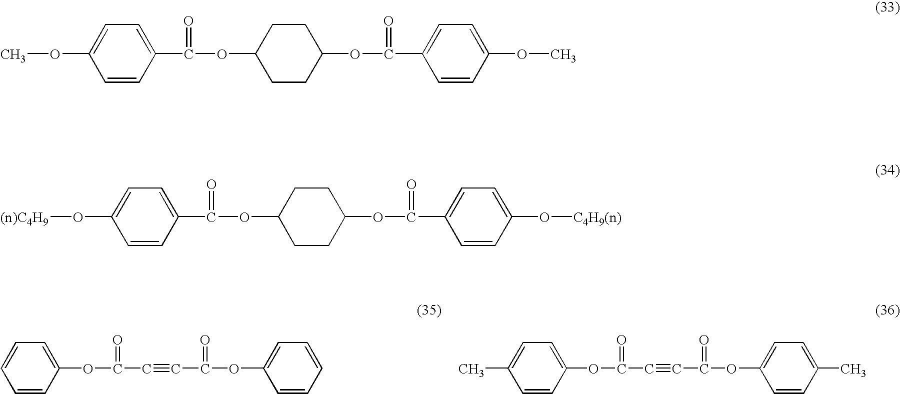

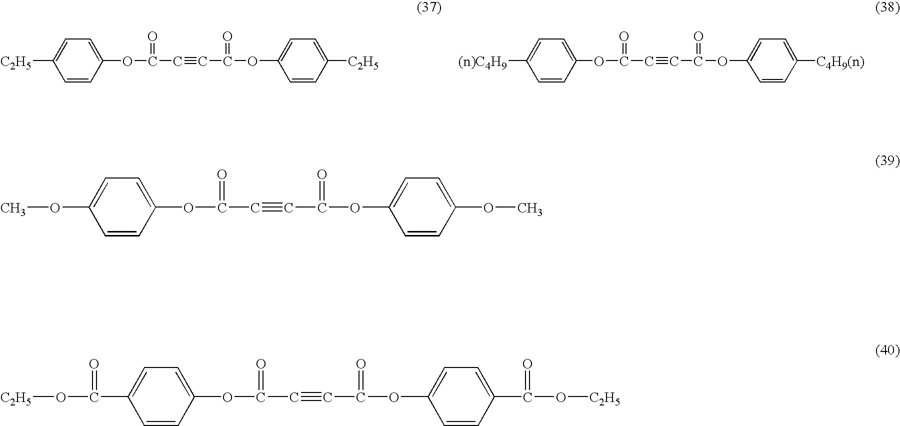

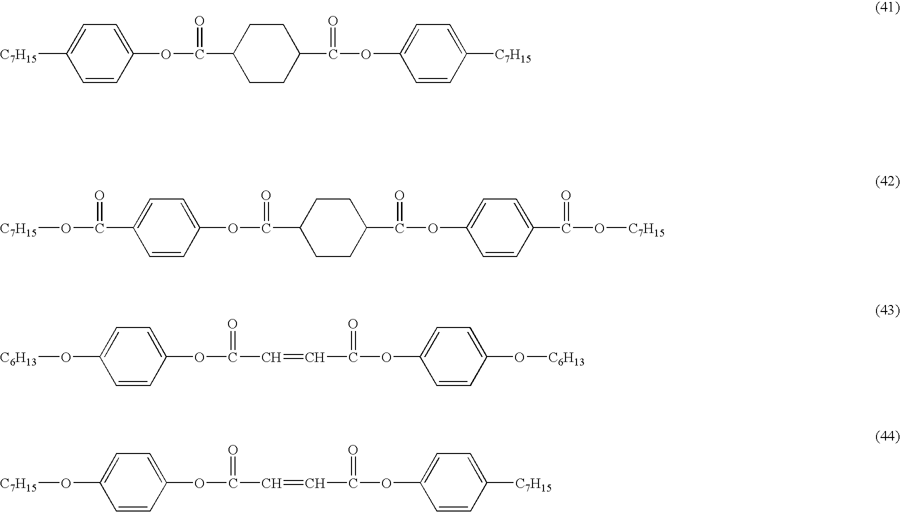

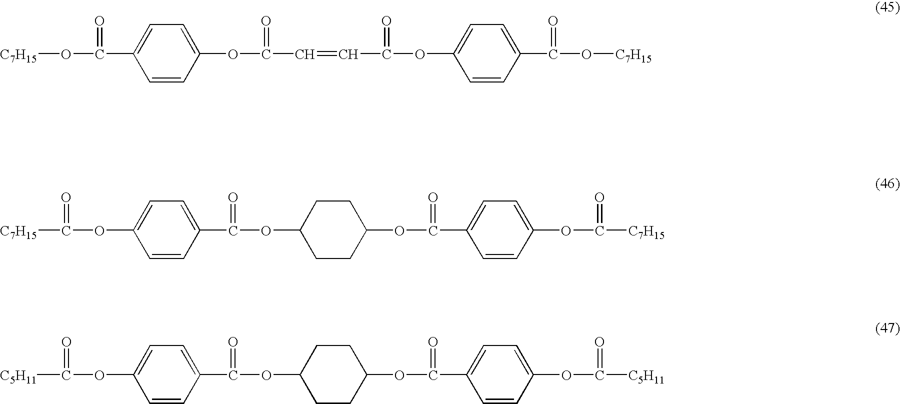

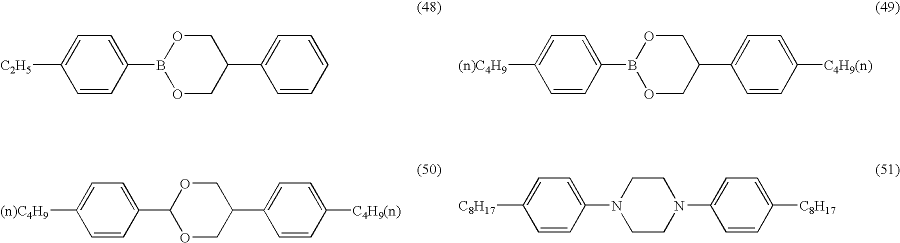

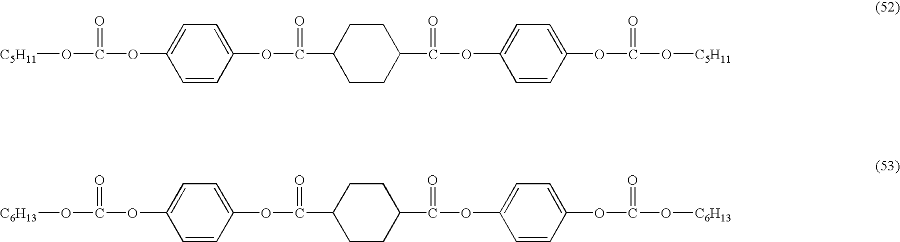

Exemplified compounds 1 to 34, 41, 42, 46, 47, 52 and 53 each has two asymmetric carbon atoms at 1- and 4-positions of the cyclohexane ring. However, Exemplified compounds 1, 4 to 34, 41, 42, 46, 47, 52 and 53 have no optical isomerism (optical activity) since they have symmetrical meso form molecular structure, and there are only geometric isomers thereof. Exemplified compound 1 in trans-form (1-trans) and that in cis-form (1-cis) are shown below.

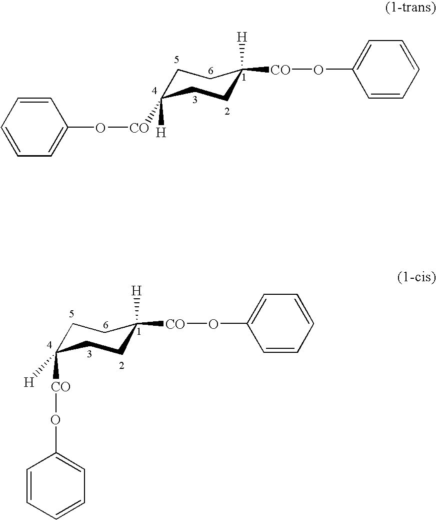

As above-mentioned, the rod-shaped compound preferably has a linear molecular structure. Therefore, the trans form is preferably to, the cis-form. Exemplified compounds 2 and 3 have optical isomers additionally to the geometric isomers (four isomers in total). Regarding the geometric isomers, the trans-form is more preferable than the cis-form. There is no difference between the optical isomers and d-, 1- and racemic-body are all employable. In Exemplified compounds 43 to 45, cis-form and trans-form are formed at the vinylene bond. The trans-form is preferable than the cis-form by the above-described reason.

Two kinds of the rod-shaped compounds each having the maximum absorption at a wavelength shorter than 250 nm may be employed in combination. “Mol. Cryst. Liq. Cryst.” vol. 53, p. 229, 1979, ibid. vol. 89, p. 93, 1982, ibid. vol. 145, p. 111, 1987, and ibid. vol. 170, p.43, 1989, “J. Am. Chem. Soc.” Vol. 113, p. 1349, 1991, ibid. vol. 118, p. 5346, 1996, and ibid. vol. 92, p. 1582, 1970, “J. Org. Chem.” Vol. 40, p. 420, 1975, and “Tetrahedron” vol. 48, No. 16, p. 3437, 1992 can be cited as relating documents.

As a disc-shaped compound relating to the invention, a compound having a 1,3,5-triazine ring can be preferably employed.

Among compounds having the 1,3,5-triazine ring, compounds represented by the following Formula 12 are preferable.

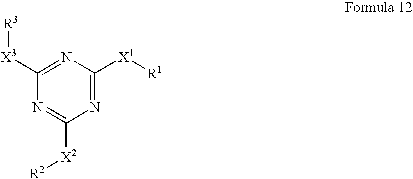

In Formula 12, X¹ is a single bond, an —NR₄— group, an —O— atom or an —S— atom; X² is a single bond, an —NR₅— group, an —O— atom or an —S— atom; X³ is a single bond, an —NR₆— group, an —O— atom or an —S— atom; R¹, R² and R³ are each an alkyl group, an alkenyl group, an aryl group or a heterocyclic group; and R₄, R₅ and R₆ are each a hydrogen atom, an alkyl group, an alkenyl group, an aryl group or a heterocyclic group. The compound represented by Formula 12 is particularly preferably a melamine compound.

In the melamine compound of Formula 12, it is preferable that the X¹, X² and X³ are each the —NR₄—, —NR₅— and —HR₆—, respectively, or the X¹, X² and X³ are each a single bond and the R¹, R² and R³ are each a heterocyclic group having a free valency at the nitrogen atom thereof. The —X¹—R , —X²—R² and —X³—R³ are preferably the same substituting group. The R¹, R² and R³ are particularly preferably an aryl group. The R₄, R₅ and R₆ are each particularly preferably a hydrogen atom.

The alkyl group is more preferably a chain alkyl group than a cyclic alkyl group. A straight-chain alkyl group is more preferably to a branched-chain alkyl group.

The number of carbon atom of the alkyl group is preferably from 1 to 30, more preferably from 1 to 20, further preferably from 1 to 10, further more preferably from 1 to 8, and most preferably from 1 to 6. The alkyl group may have a substituent.

Concrete examples of the substituent include a halogen atom, an alkoxy group such as a methoxy group, an ethoxy group and an epoxyethyloxy group, and a acyloxy group such as an acryloyl group and a methacryloyl group. The alkenyl group is more preferably a chain alkenyl group than a cyclic alkenyl group. A straight-chain alkenyl group is preferably to a branched-chain alkenyl group. The number of carbon atom of the alkenyl group is preferably from 2 to 30, more preferably from 2 to 20, further preferably from 2 to 10, further more preferably from 2 to 8, and most preferably from 2 to 6. The alkyl group may have a substituent.

Concrete examples of the substituent include a halogen atom, an alkoxy group such as a methoxy group, an ethoxy group and an epoxyethyloxy group, and a acyloxy group such as an acryloyl group and a methacryloyl group.

The aryl group is preferably a phenyl group or a naphthyl group, and the phenyl group is particularly preferable. The aryl group may have a substituent.

Concrete examples of the substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamido group, a carbamoyl group, an alkyl-substituted carbamoyl group, an alkenyl-substituted carbamoyl group, an aryl-substituted carbamoyl group, an amido group, an alkylthio group, an alkenylthio group, an arylthio group and an acyl group. The above alkyl group is the same as the foregoing alkyl group.

The alkyl moiety of the alkoxyl group, acyloxy group, alkoxycarbonyl group, alkyl-substituted sulfamoyl group, sulfonamido group, alkyl-substituted carbamoyl group, amido group, alkylthio group and acyl group is the same as the foregoing alkyl group.

The above alkenyl group is the same as the forgoing alkenyl group.

The alkenyl moiety of the alkenyloxy group, acyloxy group, alkenyloxycarbonyl group, alkenyl-substituted sulfamoyl group, sulfonamido group, alkenyl-substituted carbamoyl group, amido group, alkenylthio group and acyl group is the same as the foregoing alkenyl group.

Concrete examples of the aryl group include a phenyl group, an α-naphthyl group, a β-naphthyl group, a 4-methoxyphenyl group, a 3,4-diethoxyphenyl group, a 4-octyloxyphenyl group and a 4-dodecyloxyphenyl group.

The aryl moiety of the aryloxy group, acyloxy group, aryloxycarbonyl group, aryl-substituted sulfamoyl group, sulfonamido group, arylsubstituted carbamoyl group, amido group, arylthio group and acyl group is the same as the foregoing aryl group.

The heterocyclic group is preferably has aromaticity, when the X¹, X² and X³ are an —NR— group, an —O— atom or an —S— group.

The heterocycle in the heterocyclic group having aromaticity is usually a unsaturated heterocycle, preferably a heterocycle having highest number of double bond. The heterocycle is preferably a 5-, 6- or 7-member ring, more preferably the 5- or 6-member ring and most preferably the 6-member ring.

The hetero atom in the heterocycle is preferably a nitrogen atom, a sulfur atom or an oxygen atom, and the nitrogen atom is particularly preferable.

As the heterocycle having aromaticity, a pyridine ring such as a 2-pyridyl group and a 4-pyridyl group is particularly preferable. The heterocyclic group may have a substituent. Examples of the substituent are the same as the substituent of the foregoing aryl moiety.

When X¹, X² and X³ are each the single bond, the heterocyclic group preferably has a free valency at the nitrogen atom. The heterocyclic group having the free valency at the nitrogen atom is preferably 5-, 6- or 7-member ring, more preferably the 5- or 6-member ring, and most preferably the 5-member ring. The heterocyclic group may have plural nitrogen atoms.

The heterocyclic group may have a hetero-atom other than the nitrogen atom such as an oxygen atom and a sulfur atom. The heterocyclic group may have a substituent. Concrete examples of the heterocyclic group are the same as those of the aryl moiety.

Examples of the heterocyclic group having the free valency at the nitrogen atom are listed below.

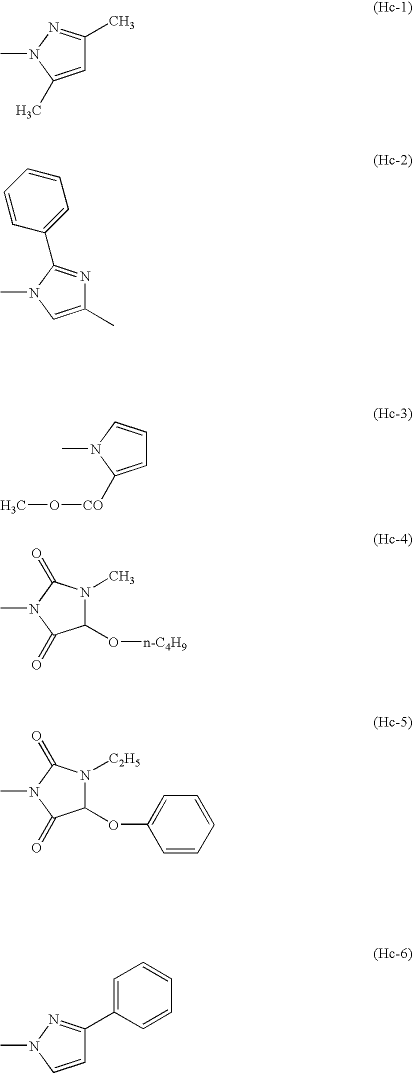

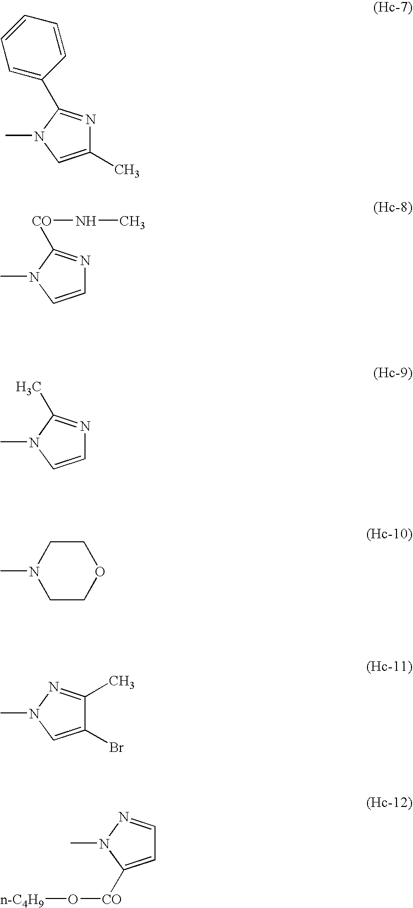

The molecular weight of the compound having a 1.3.5-triazine ring is preferably from 300 to 2,000. The boiling point of these compounds is preferably not less than 260° C. The boiling point can be measured by a measuring apparatus available on the market such as TG/DTA100, manufactured by Seiko Denshi Kogyo Co., Ltd.

Concrete examples of the compound having the 1,3,5-triazine ring are shown below.

In the followings, plural Rs each represent the same group. 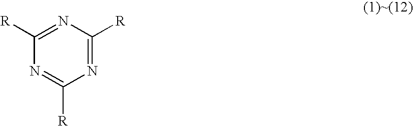
(1) Butyl
(2) 2-mthoxy-2-ethoxyethyl
(3) Undecenyl
(4) Phenyl
(5) 4-ethoxycarbonylphenyl
(6) 4-butozyphenyl
(7) p-biphenylyl
(8) 4-pyridyl
(9) 2-naphthyl
(10) 2-methylphenyl
(11) 3,4-dimethoxyphenyl
(12) 2-furyl
(13) 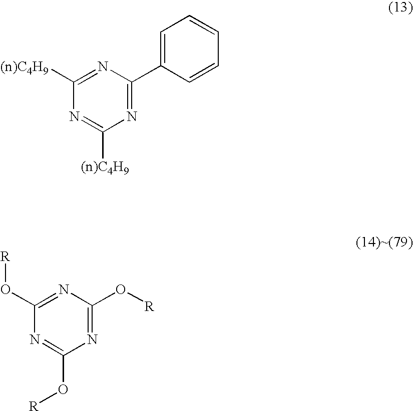
(14) phenyl
(15) 3-ethoxycarbonylphenyl
(16) 3-butoxyphenyl
(17) m-biphenyryl
(18) 3-phenylthiophenyl
(19) 3-chlorophenyl
(20) 3-benzoylphenyl
(21) 3-acetoxyphenyl
(22) 3-benzoyloxyphenyl
(23) 3-phenoxycarbonylphenol
(24) 3-methoxyphenyl
(25) 3-anilinophenyl
(26) 3-isobutyrylaminophenyl
(27) 3-phenoxycarbonylaminophenyl
(28) 3-(3-ethylureido)phenyl
(29) 3-(3,3-diethylureido)phenyl
(30) 3-methylphenyl
(31) 3-phenoxyphenyl
(32) 3-hydroxyphenyl
(33) 4-ethoxycarbonylphenyl
(34) 4-butoxyphenyl
(35) p-biphenyryl
(36) 4-phenylthiophenyl
(37) 4-chlorophenyl
(38) 4-benzoylphenyl
(39) 4-actoxyphenyl
(40) 4-benzoyloxyphenyl
(41) 4-phenoxycarbonylphenyl
(42) 4-methoxyphenyl
(43) 4-anilinophenyl
(44) 4-isobutyrylaminophenyl
(45) 4-phenoxycarbonylaminophenyl
(46) 4-(3-ethylureido)phenyl
(47) 4-(3,3-diethylureido)phenyl
(48) 4-methylphenyl
(49) 4-phenoxyphenyl
(50) 4-hydroxyphenyl
(51) 3,4-diethoxycarbonylphenyl
(52) 3,4-dibutoxyphenyl
(53) 3,4-diphenylphenyl
(54) 3,4-diphenylthiophenyl
(55) 3,4-dichlorophenyl
(56) 3,4-dibenzoylphenyl
(57) 3,4-diactoxyphenyl
(58) 3,4-dibenzoyloxyphenyl
(59) 3,4-diphenoxycarbonylphenyl
(60) 3,4-dimethoxyphenyl
(61) 3,4-dianilinophenyl
(62) 3,4-dimethylphenyl
(63) 3,4-diphenoxyphenyl
(64) 3,4-dihydroxyphenyl.
(65) 2-naphthyl
(66) 3,4,5-triethoxycarbonylphenyl
(67) 3,4,5-tributoxyphenyl
(68) 3,4,5-triphenylpenyl
(69) 3,4,5-triphenylthiophenyl
(70) 3,4,5-trichlorophenyl
(71) 3,4,5-tribenzoylphenyl
(72) 3,4,5-triacetoxyphenyl
(73) 3,4,5-tribenzoyloxyphenyl
(74) 3,4,5-triphenoxycarbonylphenyl
(75) 3,4,5-trimethoxyphenyl
(76) 3,4,5-trianilinophenyl
(77) 3,4,5-trimethylphenyl
(78) 3,4,5-triphenoxyphenyl
(79) 3,4,5-trihydroxyphenyl 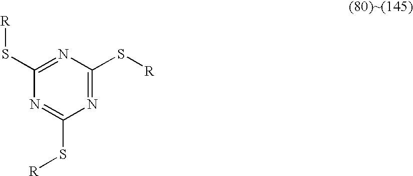
(80) phenyl
(81) 3-ethoxycarbonylphenyl
(82) 3-butoxyphenyl
(83) m-biphenyryl
(84) 3-phenylthiophenyl
(85) 3-chlorophenyl
(86) 3-benzoylphenyl
(87) 3-acetoxyphenyl
(88) 3-benzoyloxyphenyl
(89) 3-phenoxycarbonylphenol
(90) 3-methoxyphenyl
(91) 3-anilinophenyl
(92) 3-isobutyrylaminophenyl
(93) 3-phenoxycarbonylaminophenyl
(94) 3-(3-ethylureido)phenyl
(95) 3-(3,3-diethylureido)phenyl
(96) 3-methylphenyl
(97) 3-phenoxyphenyl
(98) 3-hydroxyphenyl
(99) 4-ethoxycarbonylphenyl
(100) 4-butoxyphenyl
(101) p-biphenyryl
(102) 4-phenylthiophenyl
(103) 4-chlorophenyl
(104) 4-benzoylphenyl
(105) 4-actoxyphenyl
(106) 4-benzoyloxyphenyl
(107) 4-phenoxycarbonylphenyl
(108) 4-methoxyphenyl
(109) 4-anilinophenyl
(110) 4-isobutyrylaminophenyl
(111) 4-phenoxycarbonylaminophenyl
(112) 4-(3-ethylureido)phenyl
(113) 4-(3,3-diethylureido)phenyl
(114) 4-methylphenyl
(115) 4-phenoxyphenyl
(116) 4-hydroxyphenyl
(117) 3,4-diethoxycarbonylphenyl
(118) 3,4-dibutoxyphenyl
(119) 3,4-diphenylphenyl
(120) 3,4-diphenylthiophenyl
(121) 3,4-dichlorophenyl
(122) 3,4-dibenzoylphenyl
(123) 3,4-diactoxyphenyl
(124) 3,4-dibenzoyloxyphenyl
(125) 3,4-diphenoxycarbonylphenyl
(126) 3,4-dimethoxyphenyl
(127) 3,4-dianilinophenyl
(128) 3,4-dimethylphenyl
(129) 3,4-diphenoxyphenyl
(130) 3,4-dihydroxyphenyl
(131) 2-naphthyl
(132) 3,4,5-triethoxycarbonylphenyl
(133) 3,4,5-tributoxyphenyl
(134) 3,4,5-triphenylpenyl
(135) 3,4,5-triphenylthiophenyl
(136) 3,4,5-trichlorophenyl
(137) 3,4,5-tribenzoylphenyl
(138) 3,4,5-triacetoxyphenyl
(139) 3,4,5-tribenzoyloxyphenyl
(140) 3,4,5-triphenoxycarbonylphenyl
(141) 3,4,5-trimethoxyphenyl
(142) 3,4,5-trianilinophenyl
(143) 3,4,5-trimethylphenyl
(144) 3,4,5-triphenoxyphenyl
(145) 3,4,5-trihydroxyphenyl 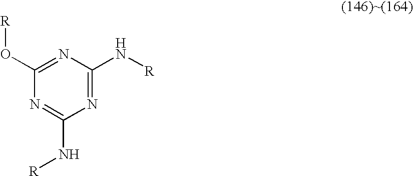
(146) phenyl
(147) 4-ethoxycarbonylphenyl
(148) 4-butoxyphenyl
(149) p-biphenyryl
(150) 4-phenylthiophenyl
(151) 4-chlorophenyl
(152) 4-benzoylphenyl
(153) 4-acetoxyphenyl
(154) 4-benzoyloxyphenyl
(155) 4-phenoxycarbonylphenol
(156) 4-methoxyphenyl
(157) 4-anilinophenyl
(158) 4-isobutyrylaminophenyl
(159) 4-phenoxycarbonylaminophenyl
(160) 4-(3-ethylureido)phenyl
(161) 4-(3,3-diethylureido)phenyl
(162) 4-methylphenyl
(163) 4-phenoxyphenyl
(164) 4-hydroxyphenyl 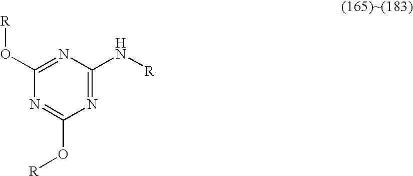
(165) phenyl
(166) 4-ethoxycarbonylphenyl
(167) 4-butoxyphenyl
(168) p-biphenyryl
(169) 4-phenylthiophenyl
(170) 4-chlorophenyl
(171) 4-benzoylphenyl
(172) 4-acetoxyphenyl
(173) 4-benzoyloxyphenyl
(174) 4-phenoxycarbonylphenol
(175) 4-methoxyphenyl
(176) 4-anilinophenyl
(177) 4-isobutyrylaminophenyl
(178) 4-phenoxycarbonylaminophenyl
(179) 4-(3-ethylureido)phenyl
(180) 4-(3,3-diethylureido)phenyl
(181) 4-methylphenyl
(182) 4-phenoxyphenyl
(183) 4-hydroxyphenyl 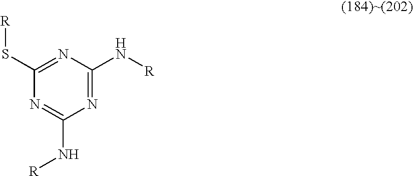
(184) phenyl
(185) 4-ethoxycarbonylphenyl
(186) 4-butoxyphenyl
(187) p-biphenyryl
(188) 4-phenylthiophenyl
(189) 4-chlorophenyl
(190) 4-benzoylphenyl
(191) 4-acetoxyphenyl
(192) 4-benzoyloxyphenyl
(193) 4-phenoxycarbonylphenol
(194) 4-methoxyphenyl
(195) 4-anilinophenyl
(196) 4-isobutyrylaminophenyl
(197) 4-phenoxycarbonylaminophenyl
(198) 4-(3-ethylureido)phenyl
(199) 4-(3,3-diethylureido)phenyl
(200) 4-methylphenyl
(201) 4-phenoxyphenyl
(202) 4-hydroxyphenyl 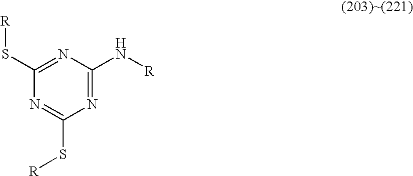
(203) phenyl
(204) 4-ethoxycarbonylphenyl
(205) 4-butoxyphenyl
(206) p-biphehyryl
(207) 4-phenylthiophenyl
(208) 4-chlorophenyl
(209) 4-benzoylphenyl
(210) 4-acetoxyphenyl
(211) 4-benzoyloxyphenyl
(212) 4-phenoxycarbonylphenol
(213) 4-methoxyphenyl
(214) 4-anilinophenyl
(215) 4-isobutyrylaminophenyl
(216) 4-phenoxycarbonylaminophenyl
(217) 4-(3-ethylureido)phenyl
(218) 4-(3,3-diethylureido)phenyl
(219) 4-methylphenyl
(220) 4-phenoxyphenyl
(221) 4-hydroxyphenyl 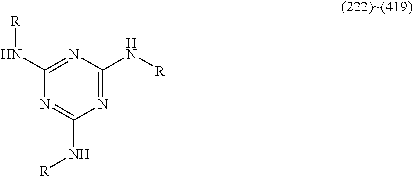
(222) phenyl
(223) 4-butylphenyl
(224) 4-2-methoxy-2-ethoxyethyl)phenyl
(225) 4-(5-nenenyl)phenyl
(226) p-biphenyryl
(227) 4-ethoxycarbonylphenyl
(228) 4-butoxyphenyl
(229) 4-methylphenyl
(230) 4-chlorophenyl
(231) 4-phenylthiophenyl
(232) 4-benzoylphenyl
(233) 4-aceoxyphenyl
(234) 4-benzoyloxyphenyl
(235) 4-phenoxycarbonylphenyl
(236) 4-methoxyphenyl
(237) 4-anilinophenyl
(238) 4-isobutyrylaminophenyl
(239) 4-phenoxycarbonylaminophenyl
(240) 4-(3-ethylureido)phenyl
(241) 4-(3,3-diethylureido)phenyl
(242) 4-phenoxyphenyl
(243) 4-hydroxyphenyl
(244) 3-butylphenyl
(245) 3-(2-methoxy-2-ethoxyethyl)phenyl
(246) 3-(5-nonenyl)phenyl
(247) m-biphenyryl
(248) 3-ethoxycarbonylphenyl
(249) 3-butoxyphenyl
(250) 3-methylphenyl
(251) 3-chlorophenyl
(252) 3-phenylthiophenyl
(253) 3-benzoylphenyl
(254) 3-actoxyphenyl
(255) 3-benzoyloxyphenyl
(256) 3-phenoxycarbonylphenyl
(257) 3-methoxyphenyl
(258) 3-anilinophenyl
(259) 3-isobutyrylaminophenyl
(260) 3-phenoxycarbonylaminophenyl
(261) 3-(3-ethylureido)phenyl
(262) 3-(3,3-diethylureido)phenyl
(263) 3-phenoxyphenyl
(264) 3-hydroxyphenyl
(265) 2-butylphenyl
(266) 2-(2-methoxy-2-ethoxyethyl)phenyl
(267) 2-(5-nonenyl)phenyl
(268) o-biphenyryl
(269) 2-ethoxycarbonylphenyl
(270) 2-butoxyphenyl
(271) 2-methylphenyl
(272) 2-chlorophenyl
(273) 2-phenylthiophenyl
(274) 2-benzoylphenyl
(275) 2-aceoxyphenyl
(276) 2-benzoyloxyphenyl
(277) 4-phenoxycarbonylphenyl
(278) 2-methoxyphenyl
(279) 2-anilinophenyl
(280) 2-isobutyrylaminophenyl
(281) 2-phenoxycarbonyl aminophenyl
(282) 2-(3-ethylureido)phenyl
(283) 2-(3,3-dimethylureido)phenyl
(284) 2-phenoxyphenyl
(285) 2-hydroxyphenyl
(286) 3,4-dibutylphenyl
(287) 3,4-di(2-methoxy-2-ethoxyethyl)phenyl
(288) 3,4-diphenylphenyl
(289) 3,4-diethoxycarbonylphenyl
(290) 3,4-didodecyloxyphenyl
(291) 3,4-dimethylphenyl
(292) 3,4-dichlorophenyl
(293) 3,4-dibenzoylphenyl
(294) 3,4-diacetoxyphenyl
(295) 3,4-dimethoxyphenyl
(296) 3,4-di-N-methylaminophenyl
(297) 3,4-diisobutyrylaminophenyl
(298) 3,4-diphenoxyphenyl
(299) 3,4-dihydroxyphenyl
(300) 3,5-dibutylphenyl
(301) 3,5-di(2-methoxy-2-ethoxyethyl)phenyl
(302) 3,5-diphenylphenyl
(303) 3,5-diethoxycarbonylphenyl
(304) 3,5-didodecyloxyphenyl
(305) 3,5-dimethylphenyl
(306) 3,5-dichlorophenyl
(307) 3,5-dibenzoylphenyl
(308) 3,5-diacetoxyphenyl
(309) 3,5-dimethoxyphenyl
(310) 3,5-di-N-methylaminophenyl
(311) 3,5-diisobutyrylaminophenyl
(312) 3,5-diphenoxyphenyl
(313) 3,5-dihydroxyphenyl
(314) 2,4-dibutylphenyl
(315) 2,4-di(2-methoxy-2-ethoxyethyl)phenyl
(316) 2,4-diphenylphenyl
(317) 2,4-diethoxycarbonylphenyl
(318) 2,4-didodecyloxyphenyl
(319) 2,4-dimethylphenyl
(320) 2,4-dichlorophenyl
(321) 2,4-dibenzoylphenyl
(322) 2,4-diacetoxyphenyl
(323) 2,4-dimethoxyphenyl
(324) 2,4-di-N-methylaminophenyl
(325) 2,4-diisobutyrylaminophenyl
(326) 2,4-diphenoxyphenyl
(327) 2,4-dihydroxyphenyl
(328) 2,3-dibutylphenyl
(301) 3,5-di(2-methoxy-2-ethoxyethyl)phenyl
(302) 3,5-diphenylphenyl
(303) 3,5-diethoxycarbonylphenyl
(304) 3,5-didodecyloxyphenyl
(305) 3,5-dimethylphenyl
(306) 3,5-dichlorophenyl
(307) 3,5-dibenzoylphenyl
(308) 3,5-diacetoxyphenyl
(309) 3,5-dimethoxyphenyl
(310) 3,5-di-N-methylaminophenyl
(311) 3,5-diisobutyrylaminophenyl
(312) 3,5-diphenoxyphenyl
(313) 3,5-dihydroxyphenyl
(314) 2,4-dibutylphenyl
(315) 2,4-di(2-methoxy-2-ethoxyethyl)phenyl
(316) 2,4-diphenylphenyl
(317) 2,4-diethoxycarbonylphenyl
(318) 2,4-didodecyloxyphenyl
(319) 2,4-dimethylphenyl
(320) 2,4-dichlorophenyl
(321) 2,4-dibenzoylphenyl
(322) 2,4-diacetoxyphenyl
(323) 2,4-dimethoxyphenyl
(324) 2,4-di-N-methylaminophenyl
(325) 2,4-diisobutyrylaminophenyl
(326) 2,4-diphenoxyphenyl
(327) 2,4-dihydroxyphenyl
(328) 2,3-dibutylphenyl
(329) 2,3-di(2-methoxy-2-ethoxyethyl)phenyl
(330) 2,3-diphenylphenyl
(331) 2,3-diethoxycarbonylphenyl
(332) 2,3-didodecyloxyphenyl
(333) 2,3-dimethylphenyl
(334) 2,3-dichlorophenyl
(335) 2,3-dibenzoylphenyl
(336) 2,3-diacetoxyphenyl
(337) 2,3-dimethoxyphenyl
(338) 2,3-di-N-methylaminophenyl
(339) 2,3-diisobutyrylaminophenyl
(340) 2,3-diphenoxyphenyl
(341) 2,3-dihydroxyphenyl
(342) 2,6-dibutylphenyl
(343) 2,6-di(2-methoxy-2-ethoxyethyl)phenyl
(344) 2,6-diphenylphenyl
(345) 2,6-diethoxycarbonylphenyl
(346) 2,6-didodecyloxyphenyl
(347) 2,6-dimethylphenyl
(348) 2,6-dichlorophenyl
(349) 2,6-dibenzoylphenyl
(350) 2,6-diacetoxyphenyl
(351) 2,6-dimethoxyphenyl
(352) 2,6-di-N-methylaminophenyl
(353) 2,6-diisobutyrylaminophenyl
(354) 2,6-diphenoxyphenyl
(355) 2,6-dihydroxyphenyl
(356) 3,4,5-tributylphenyl
(357) 3,4,5-tri(2-methoxy-2-ethoxyethyl)phenyl
(358) 3,4,5-triphenylphenyl
(359) 3,4,5-triethoxycarbonylphenyl
(360) 3,4,5-tridodecyloxyphenyl
(361) 3,4,5-trimethylphenyl
(362) 3,4,5-trichlorophenyl
(363) 3,4,5-tribenzoylphenyl
(364) 3,4,5-triacetoxyphenyl
(365) 3,4,5-trimethoxyphenyl
(366) 3,4,5-tri-N-methylaminophenyl
(367) 3,4,5-triisobutyrylaminophenyl
(368) 3,4,5-triphenoxyphenyl
(369) 3,4,5-trihydoxyphenyl
(370) 2,4,6-tributylphenyl
(371) 2,4,6-tri(2-methoxy-2-ethoxyethyl)phenyl
(372) 2,4,6-triphenylphenyl
(373) 2,4,6-triethoxycarbonylphenyl
(374) 2,4,6-tridodecyloxyphenyl
(375) 2,4,6-trimethylphenyl
(376) 2,4,6-trichlorophenyl
(377) 2,4,6-tribenzoylphenyl
(378) 2,4,6-triacetoxyphenyl
(379) 2,4,6-trimethoxyphenyl
(380) 2,4,6-tri-N-methylaminophenyl
(381) 2,4,6-triisobutyrylaminophenyl
(382) 2,4,6-triphenoxyphenyl
(383) 2,4,6-trihydoxyphenyl
(384) pentafluorophenyl
(385) pentachlorophenyl
(386) pentamethoxyphenyl
(387) 6-N-methylsulfamoyl-8-methoxy-2-naphthyl
(388) 5-N-methylsulfamoyl-2-naphthyl
(389) 6-N-phenylsufamoyl-2-naphtyl
(390) 5-ethoxy-7-N-methylsulfamoyl-2-naphthyl
(391) 3-methoxy-2-naphthyl
(392) 1-ethoxy-2-naphthyl
(393) 6-N-phenylsulfamoyl-8-methoxy-2-naphthyl
(394) 5-methoxy-7-N-phenylsulfamoyl-2-naphthyl
(395) 1-(4-methylphenyl)-2-naphthyl
(396) 6,8-di-N-methylsufamoyl-2-naphthyl
(397) 6-N-2-acetoxyethylsulfamoyl-8-methoxy-2-naphthyl
(398) 5-acetoxy-7-N-phenylsulfamoyl-2-naphthyl
(399) 3-benzoyloxy-2-naphthyl
(400) 5-acetylamino-1-naphthyl
(401) 2-methoxy-1-naphthyl
(402) 4-phenoxy-1-naphthyl
(403) 5-N-methylsulfamoyl-1-naphthyl
(404) 3-N-methylcarbamoyl-4-hydroxy-1-naphthyl
(405) 5-methoxy-6-N-ethylsulfamoyl-1-naphthyl
(406) 7-tetradecyloxy-1-naphthyl
(407) 4-(4-methylphenoxy)-1-naphthyl
(408) 6-N-methylsulfamoyl-1-naphthyl
(409) 3-N,N-dimethylcarbamoyl-4-methoxy-1-naphthyl
(410) 5-m ethoxy-6-N-benzylsulfamoyl-1-naphthyl
(411) 3,6-di-N-phenylsulfamoyl-1-naphthyl
(412) methyl
(413) ethyl
(414) butyl
(415) octyl
(416) dodecyl
(417) 2-butoxy-2-ethoxyethyl
(418) benzyl
(419) 4-methoxybenzyl 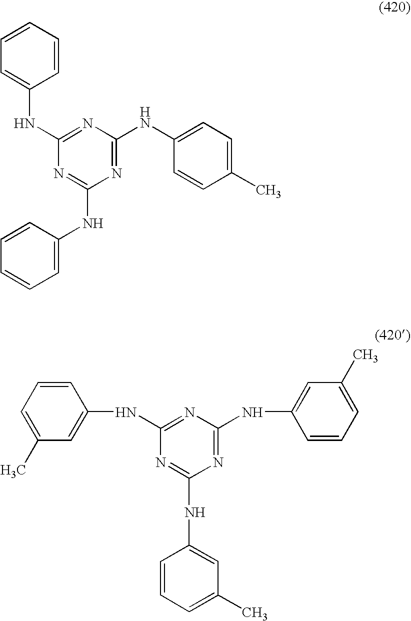 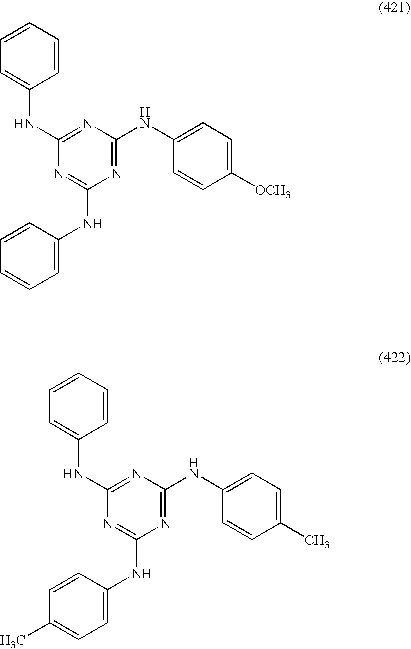 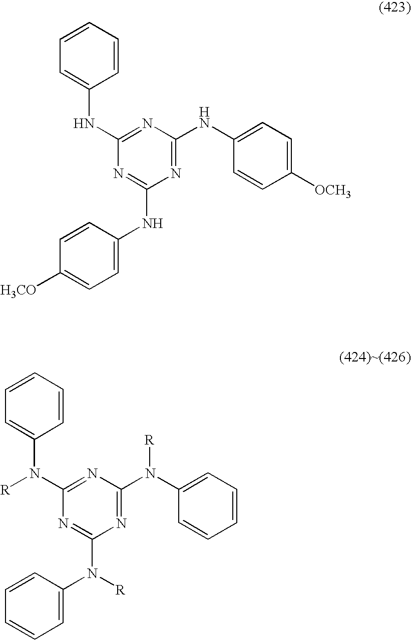
(424) methyl
(425) phenyl
(426) butyl 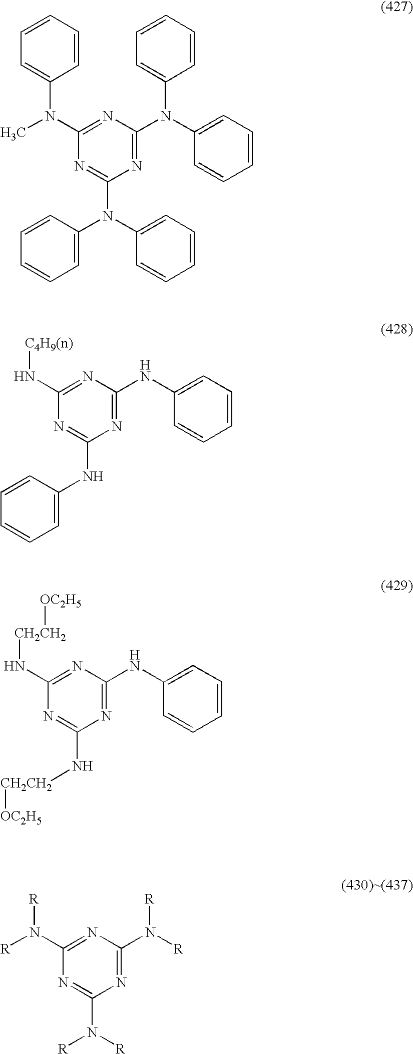
(430) methyl
(431) ethyl
(432) butyl
(433) octyl
(434) dodecyl
(435) 2-butoxy-2-ethoxyethyl
(436) benzyl
(437) 4-methoxybenzyl

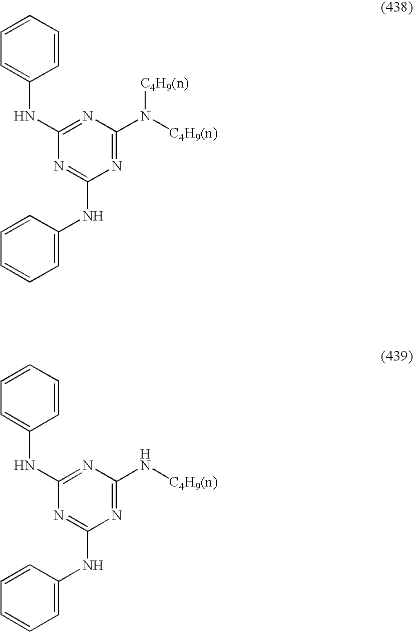

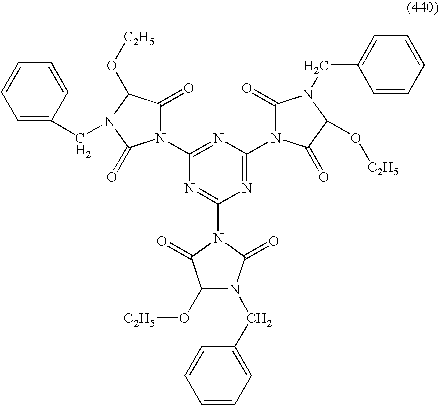

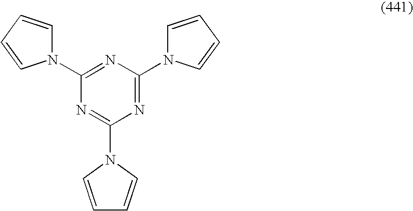

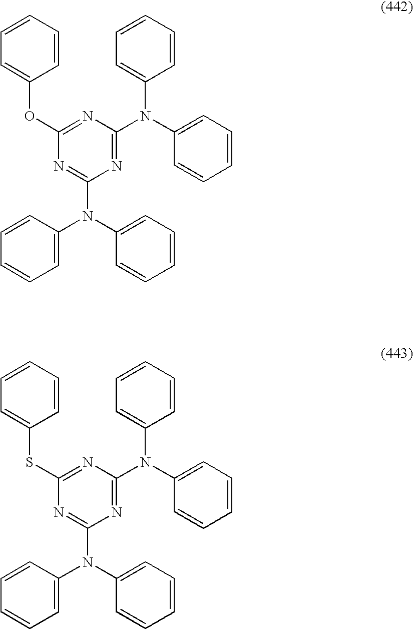

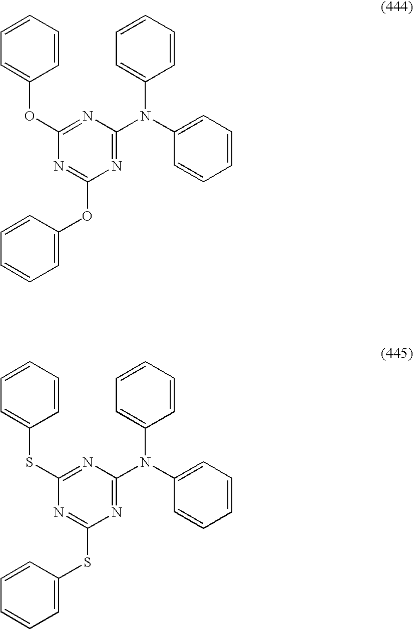

in the present invention, employed as a compound having a 1,3,5-triazine ring may be melamine polymers. It is preferable that the above melamine polymers are synthesized employing a polymerization reaction of the melamine compounds represented by formula (13) below with carbonyl compounds.

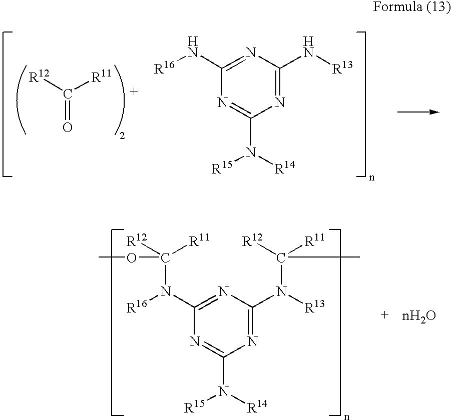

In the above synthesis reaction scheme, R¹¹, R¹², R¹³, R¹⁴, R¹⁵, and R¹⁶ each represent a hydrogen atom, an alkyl group, an alkenyl group, an aryl group or a heterocyclyl group.

The above alkyl group, alkenyl group, aryl group, and heterocyclyl group, as well as those substituents are as defined for each group and also the substituents described in above Formula (4).

The polymerization reaction of melamine compounds with carbonyl compounds is performed employing the same synthesis method as for common melamine resins (for example, a melamine-formaldehyde resin). Further, employed may be commercially available melamine polymers (being melamine resins).

The molecular weight of melamine polymers is preferably 2,000-400,000. Specific examples of repeating units of melamine polymers are shown below. 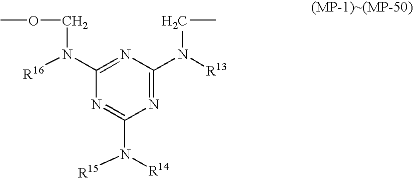
MP-1: R¹³, R¹⁴, R¹⁵, R¹⁶:CH₂OH
MP-2: R¹³, R¹⁴, R¹⁵, R¹⁶:CH₂OCH₃
MP-3: R¹³, R¹⁴, R¹⁵, R¹⁶:CH₂O-i-C₄H₉
MP-4: R¹³, R¹⁴, R¹⁵, R¹⁶:CH₂O-n-c₄H₉
MP-5: R¹³, R¹⁴, R¹⁵, R¹⁶:CH₂NHCOCH═CH₂
MP-6: R¹³, R¹⁴, R¹⁵, R¹⁶:CH₂NHCO(CH₂)₇CH═CH(CH₂)₇CH₃
MP-7: R¹³, R¹⁴, R¹⁵:CH₂H; R¹⁶ CH₂OCH₃
MP-8: R¹³, R¹⁴, R¹⁶:CH₂OH; R¹⁵:CH₂OCH₃,
MP-9: R¹³, R¹⁴, CH₂OH; R¹⁵, R¹⁶:CH₂OCH₃
MP-10: R¹³, R¹⁶:CH₂OH; R¹⁴, R¹⁵:CH₂OCH₃
MP-11: R³:CH₂OH; R¹⁴, R¹⁵, R¹⁶:CH₂OCH₃
MP-12: R¹³, R¹⁴, R¹⁶:CH₂OCH₃; R¹⁵:CH₂OH
MP-13: R¹³, CH₂OCH₃; R¹⁴, R¹⁵:CH₂OH
MP-14: R¹³, R¹⁴, R¹⁵:CH₂OH; R¹⁶:CH₂O-i-C₄H₉
MP-15: R¹³, R¹⁴, R¹⁶:CH₂OCH₃; R¹⁵:CH₂O-i-C₄H₉
MP-16: R¹³, R¹⁴:CH₂OH; R¹⁵, R¹⁶:CH₂O-i-C₄H₉
MP-17: R¹³, R¹⁶:CH₂OH; R¹⁴, R¹⁵:CH₂O-i-C₄H₉
MP-18: R¹³:CH₂OH; R¹⁴, R¹⁵, R¹⁶:CH₂O-i-C₄H₉
MP-19: R¹³, R¹⁴, R¹⁶:CH₂O-i-C₄H₉; R¹⁵:CH₂OH
MP-20: R¹³, R¹⁶:CH₂O-i-C₄H₉; R¹⁵:CH₂OH
MP-21: R¹³, R¹⁴, R¹⁵:CH₂OH; R¹⁶:CH₂O-n-C₄H₉
MP-22: R¹³, R¹⁴, R¹⁶:CH₂OH; R¹⁵:CH₂O-n-C₄H₉
MP-23: R¹³, R¹⁴:CH₂OH; R¹⁵, R¹⁶:CH₂O-n-C₄H₉
MP-24: R¹³, R¹⁶:CH₂OH; R¹⁴, R¹⁵:CH₂O-n-C₄H₉
MP-25: R¹³:CH₂OH; R¹⁴ R¹⁵, R¹⁶:CH₂O-n-C₄H₉
MP-26: R¹³, R¹⁴, R¹⁶:CH₂O-n-C₄H₉; R¹⁵:CH₂OH
MP-27: R¹³, R¹⁶:CH₂O-n-C₄H₉; R¹⁴, R¹⁵:CH₂OH
MP-28: R¹³, R¹⁴:CH₂OH; R¹⁵:CH₂OCH₃; R¹⁶:CH₂O-n-C₄H₉
MP-29: R¹³, R¹⁴:CH₂OH; R¹⁵:CH₂-n-C₄H₉; R¹⁶:CH₂OCH₃
MP-30: R¹³, R¹⁶:CH₂OH; R¹⁴:CH₂OCH₃; R¹⁵:CH₂O-n-C₄H₉
MP-31: R¹³:CH₂OH ; R¹⁴, R¹⁵:CH₂OCH₃; R¹⁶:CH₂O-n-C₄H₉
MP-32: R¹³:CH₂OH ; R¹⁴, R¹⁶:CH₂OCH₃; R¹⁵:CH₂O-n-C₄H₉
MP-33: R¹³:CH₂OH ; R¹⁴:CH₂OCH₃; R¹⁵, R¹⁶:CH₂O-n-C₄H₉
MP-34: R¹³:CH₂OH ; R¹⁴, R¹⁵:CH₂O-n-C₄H₉; R¹⁶:CH₂OCH₃
MP-35: R¹³, R¹⁴:CH₂OCH₃; R¹⁵:CH₂OH; R¹⁶:CH₂O-n-C₄H₉
MP-36: R¹³, R¹⁶:CH₂OCH₃; R¹⁴:CH₂OH; R¹⁵:CH₂O-n-C₄H₉
MP-37: R¹³:CH₂OCH₃; R¹⁴, R¹⁵:CH₂OH; R¹⁶:CH₂O-n-C₄H₉
MP-38: R¹³, R¹⁶:CH₂O-n-C₄H₉; R¹⁴:CH₂OCH₃; R¹⁵:CH₂OH
MP-39: R¹³:CH₂OH; R¹⁴:CH₂OCH₃; R¹⁵:CH₂O-n-C₄H₉; R¹⁶:CH₂NHCOCH═CH₂
MP-40: R¹³:CH₂OH; R¹⁴:CH₂OCH₃; R¹⁵:CH₂NHCOCH═CH₂; R¹⁶ CH₂O-n-C₄H₉
MP-41: R¹³:CH₂OH; R¹⁴:CH₂O-n-C₄H₉; R¹⁵:CH₂NHCOCH═CH₂; R¹⁶:CH₂OCH₃
MP-42: R¹³:CH₂OCH₃; R¹⁴:CH₂OH; R¹⁵; CH₂O-n-C₄H₉; R¹⁶:CH₂NHCOCH═CH₂
MP-43: R¹³:CH₂OCH₃; R¹⁴:CH₂OH; R¹⁵:CH₂NHCOCH═CH₂; R¹⁶:CH₂O-n-C₄H₉
MP-44: R¹³:CH₂O-n-C₄H₉; R¹⁴:CH₂OCH₃; R¹⁵:CH₂OH ; R¹⁶:CH₂NHCOCH═CH₂
MP-45: R¹³:CH₂OH ; R¹⁴:CH₂OCH₃; R¹⁵:CH₂NHCO(CH₂)₇CH═CH(CH₂)₇CH₃; R¹⁶:CH₂NHCOCH═CH₂
MP-46: R¹³:CH₂OH; R¹⁴:CH₂OCH₃; R¹⁵:CH₂NHCO═CH₂ ; R₁₆:CH₂NHCO(CH₂)₇CH═CH(CH₂)₇CH₃
MP-47: R¹³:CH₂OH ; R¹⁴:CH₂NHCO(CH₂)₇CH═CH(CH₂)₇CH₃ ; R¹⁵ CH₂NHCOCH═CH₂:R¹⁶:CH₂OCH₃
MP-48: R¹³:CH₂OCH₃; R¹⁴:CH₂OH; R¹⁵:CH₂NHCO(CH₂)₇CH═CH(CH₂)₇CH₃; R¹⁶:CH₂NHCOCH═CH₂
MP-49: R¹³:CH₂OCH₃; R¹⁴:CH₂OH; R¹⁵:CH₂NHCOCH═CH₂; R¹⁶:CH₂NHCO(CH₂)₇CH═CH(CH₂)₇CH₃
MP-50 :R¹³ :CH₂NHCO(CH₂)₇CH═CH(CH₂)₇CH₃; R¹⁴:CH₂OCH₃ ; CH₂OH; R¹⁶:CH₂NHCOCH═CH₂ 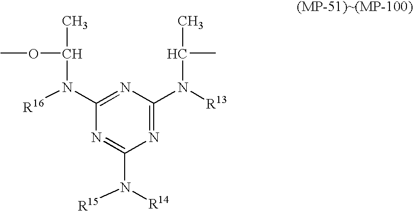
MP-51: R¹³, R¹⁴, R¹⁵, R¹⁶:CH₂OH
MP-52: R¹³, R¹⁴, R¹⁵, R¹⁶:CH₂OCH₃
MP-53: R¹³, R¹⁴, R¹⁵, R¹⁶:CH₂O-i-C₄H9
MP-54: R¹³, R¹⁴, R¹⁵, R¹⁶:CH₂O-n-C₄H₉
MP-55: R¹³, R¹⁴, R¹⁵, R¹⁶:CH₂NHCOCH═CH₂
MP-56: R¹³, R¹⁴, R¹⁵, R¹⁶:CH₂NHCO(CH₂)₇CH═CH(CH₂)₇CH₃
MP-57: R¹³, R¹⁴, R¹⁵:CH₂OH; R¹⁶ CH₂OCH₃
MP-58: R¹³, R¹⁴, R¹⁶:CH₂OH; R¹⁵:CH₂OCH₃,
MP-59: R¹³, R¹⁴:CH₂OH:R¹⁵, R¹⁶:CH₂OCH₃
MP-60: R¹³, R¹⁶:CH₂OH; R¹⁴, R¹⁵:CH₂OCH₃
MP-61: R¹³:CH₂OH; R¹⁴ R¹⁵, R¹⁶:CH₂OCH₃
MP-62: R¹³, R¹⁴, R¹⁶:CH₂OCH₃; R¹⁵:CH₂OH
MP-63: R¹³, R¹⁶:CH₂OCH₃; R¹⁴, R¹⁵:CH₂OH
MP-64: R¹³, R¹⁴, R¹⁵:CH₂OH; R¹⁶:CH₂O-i-C₄H₉
MP-65: R¹³, R¹⁴, R¹⁶:CH₂OCH₃; R¹⁵:CH₂O-i-C₄H₉
MP-66: R¹³, R¹⁴:CH₂OH; R¹⁵, R¹⁶:CH₂O-i-C₄H₉
MP-67: R¹³, R¹⁶:CH₂OH; R¹⁴, R¹⁵:CH₂O-i-C₄H₉
MP-68: R¹³:CH₂OH; R¹⁴ R¹⁵, R¹⁶:CH₂O-i-C₄H₉
MP-69: R¹³, R¹⁴, R¹⁶:CH₂O-i-C₄H₉; R¹⁵:CH₂OH
MP-70: R¹³, R¹⁶:CH₂O-i-C₄H₉; R¹⁴, R¹⁵:CH₂OH
MP-71: R¹³, R¹⁴, R¹⁵:CH₂OH; R¹⁶:CH₂O-n-C₄H₉
MP-72: R¹³, R¹⁴, R¹⁶:CH₂OH; R¹⁵:CH₂O-n-C₄H₉
MP-73: R¹³, R¹⁴, CH₂OH; R¹⁵, R¹⁶:CH₂O-n-C₄H₉
MP-74: R¹³, R¹⁶:CH₂OH; R¹⁴, R¹⁵:CH₂O-n-C₄H₉
MP-75: R¹³:CH₂OH; R¹⁴ R¹⁵, R¹⁶:CH₂O-n-C₄H₉
MP-76: R¹³, R¹⁴, R¹⁶:CH₂O-n-C₄H₉; R¹⁵:CH₂O H
MP-77: R¹³, R¹⁶:CH₂O-n-C₄H₉; R¹⁴, R¹⁵:CH₂OH
MP-78: R¹³, R¹⁴:CH₂OH; R¹⁵:CH₂OCH₃; R¹⁶:CH₂O-n-C₄H₉
MP-79: R¹³, R¹⁴:CH₂OH; R¹⁵:CH₂-n-C₄H₉; R¹⁶:CH₂OCH₃
MP-80: R¹³, R¹⁶:CH₂OH; R¹⁴:CH₂OCH₃; R¹⁵:CH₂O-n-C₄H₉
MP-81: R¹³:CH₂OH; R¹⁴, R¹⁵:CH₂OCH₃; R¹⁶:CH₂O-n-C₄H₉
MP-32: R¹³:CH₂OH; R¹⁴, R¹⁶:CH₂OCH₃; R¹⁵:CH₂O-n-C₄H₉
MP-83: R¹³:CH₂OH; R¹⁴:CH₂OCH₃; R¹⁵, R¹⁶:CH₂O-n-C₄H₉
MP-84: R¹³:CH₂OH; R¹⁴, R¹⁵:CH₂O-n-C₄H₉; R¹⁶:CH₂OCH₃
MP-85: R¹³, R¹⁴:CH₂OCH₃; R¹⁵:CH₂OH; R¹⁶:CH₂O-n-C₄H₉
MP-86: R¹³, R¹⁶:CH₂OCH₃; R¹⁴:CH₂OH; R¹⁵:CH₂O-n-C₄H₉
MP-87: R¹³:CH₂OCH₃; R¹⁴, R¹⁵:CH₂OH; R¹⁶:CH₂O-n-C₄H₉
MP-88: R¹³, R¹⁶:CH₂O-n-C₄H₉; R¹⁴:CH₂OCH₃; R¹⁵:CH₂OH
MP-89: R¹³:CH₂OH; R¹⁴:CH₂OCH₃; R¹⁵:CH₂O-n-C₄H₉; R¹⁶:CH₂NHCOCH═CH₂
MP-90: R¹³:CH₂OH; R¹⁴:CH₂OCH₃; R¹⁵:CH₂NHCOCH═CH₂; R¹⁶ CH₂O-n-C₄H₉
MP-91: R¹³:CH₂OH; R¹⁴:CH₂O-n-C₄H₉; R¹⁵:CH₂NHCOCH═CH₂; R¹⁶:CH₂OCH₃
MP-92: R¹³:CH₂OCH₃; R¹⁴:CH₂OH; R¹⁵:CH₂O-n-C₄H₉; R¹⁶:CH₂NHCOCH═CH₂
MP-93: R¹³:CH₂OCH₃; R¹⁴:CH₂OH; R¹⁵:CH₂NHCOCH═CH₂; R¹⁶:CH₂O-n-C₄H₉
MP-94: R¹³:CH₂O-n-C₄H₉; R¹⁴:CH₂OCH₃; R¹⁵:CH₂OH; R¹⁶:CH₂NHCOCH═CH₂
MP-95: R¹³:CH₂OH; R¹⁴:CH₂OCH₃; R¹⁵:CH₂NHCO(CH₂)₇CH═CH(CH₂)₇CH₃; R¹⁶:CH₂NHCOCH═CH₂
MP-96: R¹³:CH₂OH; R¹⁴:CH₂OCH₃; R¹⁵:CH₂NHCO═CH₂; R₁₆:CH₂NHCO(CH₂)₇CH═CH(CH₂)₇CH₃
MP-97: R¹³:CH₂OH ; R¹⁴:CH₂NHCO(CH₂)₇CH═CH(CH₂)₇CH₃; R¹⁵ CH₂NHCOCH═CH₂:R¹⁶:CH₂OCH₃
MP-98: R¹³:CH₂OCH₃; R¹⁴:CH₂OH; R¹⁵:CH₂NHCO(CH₂)₇CH═CH(CH₂)₇CH₃; R¹⁶:CH₂NHCOCH═CH₂
MP-99: R¹³:CH₂OCH₃; R¹⁴:CH₂OH; R¹⁵:CH₂NHCOCH═CH₂; R¹⁶:CH₂NHCO(CH₂)₇CH═CH(CH₂)₇CH₃
MP-100: R¹³:CH₂NHCO(CH₂)₇CH═CH(CH₂)₇CH₃; R¹⁴:CH₂OCH₃; R¹⁵:CH₂OH ; R¹⁶:CH₂NHCOCH═CH₂ 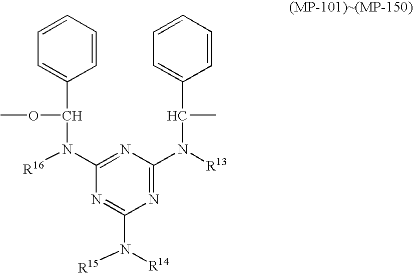
MP-101: R¹³, R¹⁴, R¹⁵, R¹⁶:CH₂OH
MP-102: R¹³, R¹⁴, R¹⁵, R¹⁶:CH₂OCH₃
MP-103: R¹³, R¹⁴, R¹⁶:CH₂O-i-C₄H₉
MP-104: R¹³, R¹⁴, R¹⁵, R¹⁶:CH₂O-n-C₄H₉
MP-105: R¹³, R¹⁴, R¹⁵, R¹⁶:CH₂NHCOCH═CH₂
MP-106: R¹³, R¹⁴, R¹⁵, R¹⁶:CH₂NHCO(CH₂)₇CH═CH(CH₂) ₇CH₃
MP-107: R¹³, R¹⁴, R¹⁵:CH₂OH; R¹⁶ CH₂OCH₃
MP-108: R¹³, R¹⁴, R¹⁶:CH₂OH; R¹⁵:CH₂OCH₃
MP-109: R¹³, R¹⁴:CH₂OH; R¹⁵, R¹⁶:CH₂OCH₃
MP-110: R¹³, R¹⁶:CH₂OH; R¹⁴, R¹⁵:CH₂OCH₃
MP-111: R¹³:CH₂OH; R¹⁴ R¹⁵, R¹⁶:CH₂OCH₃
MP-112: R¹³, R¹⁴, R¹⁶:CH₂OCH₃; R¹⁵:CH₂OH
MP-113: R¹³, R¹⁶:CH₂OCH₃; R¹⁴, R¹⁵:CH₂OH
MP-114: R¹³, R¹⁴, R¹⁵:CH₂OH; R¹⁶:CH₂O-i-C₄H₉
MP-115: R¹³, R¹⁴, R¹⁶:CH₂OH; R¹⁵:CH₂O-i-C₄H₉
MP-116: R¹³, R¹⁴:CH₂H; R¹⁵, R¹⁶:CH₂O-i-C₄H₉
MP-117: R¹³, R¹⁶:CH₂OH; R¹⁴, R¹⁵:CH₂O-i-C₄H₉
MP-118: R¹³:CH₂OH; R¹⁴ R¹⁵, R¹⁶:CH₂O-i-C₄H₉
MP-119: R¹³, R¹⁴, R¹⁶:CH₂O-i-C₄H₉; R¹⁵:CH₂OH
MP-120: R¹³, R¹⁶:CH₂O-i-C₄H₉; R¹⁴, R¹⁵:CH₂OH
MP-121: R¹³, R¹⁴, R¹⁵:CH₂OH; R¹⁶:CH₂O-n-C₄H₉
MP-122: R¹³, R¹⁴, R¹⁶:CH₂OH; R¹⁵:CH₂O-n-C₄H₉
MP-123: R¹³, R¹⁴:CH₂OH; R¹⁵, R¹⁶:CH₂O-n-C₄H₉
MP-124: R¹³, R¹⁶:CH₂OH; R¹⁴, R¹⁵:CH₂O-n-C₄H₉
MP-125: R¹³:CH₂OH; R¹⁴ R¹⁵, R¹⁶:CH₂O-n-C₄H₉
MP-126: R¹³, R¹⁴, R¹⁶:CH₂O-n-C₄H₉; R¹⁵:CH₂OH
MP-127: R¹³, R¹⁶:CH₂O-n-C₄H₉; R¹⁴, R¹⁵:CH₂OH
MP-128: R¹³, R¹⁴:CH₂OH; R¹⁵:CH₂OCH₃; R¹⁶:CH₂O-n-C₄H₉
MP-129: R¹³, R¹⁴:CH₂OH; R¹⁵:CH₂-n-C₄H₉; R¹⁶:CH₂OCH₃
MP-130: R¹³, R¹⁶:CH₂OH; R¹⁴:CH₂OCH₃; R¹⁵:CH₂O-n-C₄H₉
MP-131: R¹³:CH₂OH; R¹⁴, R¹⁵:CH₂OCH₃; R¹⁶:CH₂O-n-C₄H₉
MP-132: R¹³:CH₂OH; R¹⁴, R¹⁶:CH₂OCH₃; R¹⁵:CH₂O-n-C₄H₉
MP-133: R¹³:CH₂OH; R¹⁴:CH₂OCH₃; R¹⁵, R¹⁶:CH₂O-n-C₄H₉
MP-134: R¹³:CH₂OH; R¹⁴, R¹⁵:CH₂O-n-C₄H₉; R¹⁶:CH₂OCH₃
MP-135: R¹³, R¹⁴:CH₂OCH₃; R¹⁵:CH₂OH; R¹⁶:CH₂O-n-c₄H₉
MP-136: R¹³, R¹⁶:CH₂OCH₃; R¹⁴:CH₂OH ; R¹⁵:CH₂O-n-C₄H₉
MP-137: R¹³:CH₂OCH₃; R¹⁴, R¹⁵:CH₂OH; R¹⁶:CH₂O-n-C₄H₉
MP-138: R¹³, R¹⁶:CH₂O-n-C₄H₉; R¹⁴:CH₂OCH₃; R¹⁵:CH₂OH
MP-139: R¹³:CH₂OH; R¹⁴:CH₂OCH₃; R¹⁵:CH₂O-n-C₄H₉; R¹⁶:CH₂NHCOCH═CH₂
MP-140: R¹³:CH₂OH; R¹⁴:CH₂OCH₃; R¹⁵:CH₂NHCOCH═CH₂; R¹⁶ CH₂O-n-C₄H₉
MP-141: R¹³:CH₂OH; R¹⁴:CH₂O-n-C₄H₉; R¹⁵:CH₂NHCOCH═CH₂; R¹⁶:CH₂OCH₃
MP-142: R¹³:CH₂OCH₃; R¹⁴:CH₂OH; R¹⁵:CH₂0-n-C₄H₉; R¹⁶:CH₂NHCOCH═CH₂
MP-143: R¹³:CH₂OCH₃; R¹⁴:CH₂OH; R¹⁵:CH₂NHCOCH═CH₂; R¹⁶:CH₂O-n-C₄H₉
MP-144: R¹³:CH₂O-n-C₄H₉; R¹⁴:CH₂OCH₃; R¹⁵:CH₂OH; R¹⁶:CH₂NHCOCH═CH₂
MP-145: R¹³:CH₂OH; R¹⁴:CH₂OCH₃; R¹⁵:CH₂NHCO(CH₂)₇CH═CH(CH₂)₇CH₃; R¹⁶:CH₂NHCOCH═CH₂
MP-146: R¹³:CH₂OH; R¹⁴:CH₂OCH₃; R¹⁵:CH₂NHCO═CH₂; R₁₆:CH₂NHCO(CH₂)₇CH═CH(CH₂)₇CH₃
MP-147: R¹³:CH₂OH; R¹⁴:CH₂NHCO(CH₂)₇CH═CH(CH₂)₇CH₃; R¹⁵ CH₂NHCOCH═CH₂:R¹⁶:CH₂OCH₃
MP-148: R¹³:CH₂OCH₃; R¹⁴:CH₂OH; R¹⁵:CH₂NHCO(CH₂)₇CH═CH(CH₂)₇CH₃; R¹⁶:CH₂NHCOCH═CH₂
MP-149: R¹³:CH₂OCH₃; R¹⁴:CH₂OH ; R¹⁵:CH₂NHCOCH═CH₂; R¹⁶:CH₂NHCO(CH₂)₇CH═CH(CH₂)₇CH₃
MP-150: R¹³:CH₂NHCO(CH₂)₇CH═CH(CH₂)₇CH₃; R¹⁴:CH₂OCH₃; R¹⁵:CH₂OH; R¹⁶:CH₂NHCOCH═CH₂ 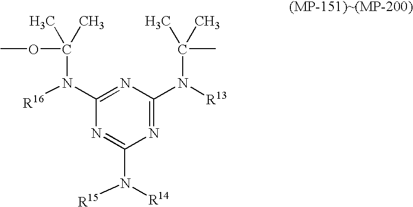
MP-151: R¹³, R¹⁴, R¹⁵, R¹⁶:CH₂OH
MP-152: R¹³, R¹⁴, R¹⁵, R¹⁶:CH₂OCH₃
MP-153: R¹³, R¹⁴, R¹⁵, R¹⁶:CH₂O-i-C₄H₉
MP-154: R¹³, R¹⁴, R¹⁵, R¹⁶:CH₂O-n-C₄H₉
MP-155: R¹³, R¹⁴, R¹⁵, R¹⁶:CH₂NHCOCH═CH₂
MP-156: R¹³, R¹⁴, R¹⁵, R¹⁶:CH₂NHCO(CH₂)₇CH═CH(CH₂)₇CH₃
MP-157: R¹³, R¹⁴, R¹⁵:CH₂OH; R¹⁶ CH₂OCH₃
MP-158: R¹³, R¹⁴, R¹⁶:CH₂OH; R¹⁵:CH₂OCH₃,
MP-159: R¹³, R¹⁴:CH₂OH; R¹⁵, R¹⁶:CH₂OCH₃
MP-160: R¹³, R¹⁶:CH₂OH ; R¹⁴, R¹⁵:CH₂OCH₃
MP-161: R¹³:CH₂OH; R¹⁴ R¹⁵, R¹⁶:CH₂OCH₃
MP-162: R¹³, R¹⁴, R¹⁶:CH₂OCH₃; R¹⁵:CH₂OH
MP-163: R¹³, R¹⁶:CH₂OCH₃; R¹⁴, R¹⁵:CH₂OH
MP-164: R¹³, R¹⁴, R¹⁵:CH₂OH; R¹⁶:CH₂O-i-C₄H₉
MP-165: R¹³, R¹⁴, R¹⁶:CH₂OH; R¹⁵:CH₂O-i-C₄H₉
MP-166: R¹³, R¹⁴:CH₂OH; R¹⁵, R¹⁶:CH₂O-i-C₄H₉
MP-167: R¹³, R¹⁶:CH₂OH; R¹⁴, R¹⁵:CH₂O-i-C₄H₉
MP-168: R¹³:CH₂OH; R¹⁴ R¹⁵, R¹⁶:CH₂O-i-C₄H₉
MP-169: R¹³, R¹⁴, R¹⁶:CH₂O-i-C₄H₉; R¹⁵:CH₂OH
MP-170: R¹³, R¹⁶:CH₂O-i-C₄H₉; R¹⁴, R¹⁵:CH₂OH
MP-171: R¹³, R¹⁴, R¹⁵:CH₂OH; R¹⁶:CH₂O-n-C₄H₉
MP-172: R¹³, R¹⁴, R¹⁶:CH₂OH; R¹⁵:CH₂O-n-C₄H₉
MP-173: R¹³, R¹⁴:CH₂OH; R¹⁵, R¹⁶:CH₂O-n-C₄H₉
MP-174: R¹³, R¹⁶:CH₂OH; R¹⁴, R¹⁵:CH₂O-n-c₄H₉
MP-175: R¹³:CH₂OH; R¹⁴ R¹⁵, R¹⁶:CH₂O-n-C₄H₉
MP-126: R¹³, R¹⁴, R¹⁶:CH₂O-n-C₄H₉; R¹⁵:CH₂OH
MP-177: R¹³, R¹⁶:CH₂O-n-C₄H₉; R¹⁴, R¹⁵:CH₂OH
MP-178: R¹³, R¹⁴:CH₂OH; R¹⁵:CH₂OCH₃; R¹⁶:CH₂O-n-C₄H₉
MP-179: R¹³, R¹⁴:CH₂OH; R¹⁵:CH₂-n-C₄H₉; R¹⁶:CH₂OCH₃
MP-180: R¹³, R¹⁶:CH₂OH; R¹⁴:CH₂OCH₃; R¹⁵:CH₂O-n-C₄H₉
MP-181: R¹³:CH₂OH; R¹⁴, R¹⁵:CH₂OCH₃; R¹⁶:CH₂O-n-C₄H₉
MP-182: R¹³:CH₂OH; R¹⁴, R¹⁶:CH₂OCH₃; R¹⁵:CH₂O-n-C₄H₉
MP-183: R¹³:CH₂OH; R¹⁴:CH₂OCH₃; R¹⁵, R¹⁶:CH₂O-n-C₄H₉
MP-184: R¹³:CH₂OH; R¹⁴, R¹⁵:CH₂O-n-C₄H₉; R¹⁶:CH₂OCH₃
MP-185: R¹³, R¹⁴:CH₂OCH₃; R¹⁵:CH₂OH ; R¹⁶:CH₂O-n-C₄H₉
MP-186: R¹³, R¹⁶:CH₂OCH₃; R¹⁴:CH₂OH; R¹⁵:CH₂O-n-C₄H₉
MP-187: R¹³:CH₂OCH₃; R¹⁴, R¹⁵:CH₂OH; R¹⁶:CH₂O-n-C₄H₉
MP-188: R¹³, R¹⁶:CH₂O-n-C₄H₉; R¹⁴:CH₂OCH₃; R¹⁵:CH₂OH
MP-189: R¹³:CH₂OH ; R¹⁴:CH₂OCH₃; R¹⁵:CH₂O-n-C₄H₉; R¹⁶:CH₂NHCOCH═CH₂
MP-190: R¹³:CH₂OH; R¹⁴:CH₂OCH₃; R¹⁵:CH₂NHCOCH═CH₂; R¹⁶ CH₂O-n-C₄H₉
MP-191: R¹³:CH₂OH; R¹⁴:CH₂O-n-C₄H₉; R¹⁵:CH₂NHCOCH═CH₂; R¹⁶:CH₂OCH₃
MP-192: R¹³:CH₂OCH₃; R¹⁴:CH₂OH; R¹⁵:CH₂O-n-C₄H₉; R¹⁶:CH₂NHCOCH═CH₂
MP-193: R¹³:CH₂OCH₃; R¹⁴:CH₂OH; R¹⁵:CH₂NHCOCH═CH₂ ; R¹⁶:CH₂O-n-C₄H₉
MP-194: R¹³:CH₂O-n-C₄H₉; R¹⁴:CH₂OCH₃; R¹⁵:CH₂OH; R¹⁶:CH₂NHCOCH═CH₂
MP-195: R¹³:CH₂OH; R¹⁴:CH₂OCH₃; R¹⁵:CH₂NHCO(CH₂)₇CH═CH(CH₂)₇CH₃; R¹⁶:CH₂NHCOCH═CH₂
MP-196: R¹³:CH₂OH; R¹⁴:CH₂OCH₃; R¹⁵:CH₂NHCO═CH₂; R₁₆:CH₂NHCO(CH₂)₇CH═CH(CH₂)₇CH₃
MP-197: R¹³:CH₂OH; R¹⁴:CH₂NHCO(CH₂)₇CH═CH(CH₂)₇CH₃; R¹⁵ CH₂NHCOCH═CH₂:R¹⁶:CH₂OCH₃
MP-198: R¹³:CH₂OCH₃; R¹⁴:CH₂OH; R¹⁵:CH₂NHCO(CH₂)₇CH═CH(CH₂)₇CH₃; R¹⁶:CH₂NHCOCH═CH₂
MP-199: R¹³:CH₂OCH₃; R¹⁴:CH₂OH; R¹⁵:CH₂NHCOCH═CH₂ ; R¹⁶:CH₂NHCO(CH₂)₇CH═CH(CH₂)₇CH₃
MP-200: R¹³:CH₂NHCO(CH₂)₇CH═CH(CH₂)₇CH₃; R¹⁴:CH₂OCH₃; R¹⁵:CH₂OH; R¹⁶:CH₂NHCOCH═CH₂

In the present invention, employed may be copolymers in which at least two types of the above repeating units are combined.

Further, simultaneously employed may be at least two types of compounds having a 1,3,5-triazine ring. Also simultaneously employed may be at least two types of disk shaped compounds (for example, compounds having a 1,3,5-triazine ring and compounds having a porphyrin skeleton).

The used amount of these additives is preferably 0.2-30 percent by weight with respect to the optical film, but is particularly preferably 1-20 percent by weight.

(Polymer Materials)

Suitable polymer materials, other than cellulose esters, and oligomers may be selected and mixed with the optical film of the present invention. The above polymer materials and oligomers which exhibit excellent compatibility with cellulose ester are preferred. When modified to film, the resulting transmittance is preferably at least 80 percent, more preferably 90. percent, but is still more preferably at least 92 percent. The purpose of mixing at least one of polymer materials and oligomers other than cellulose ester is to enhance physical properties during thermal fusion, viscosity control, and the final treated film. In this case, they may include other additives described above.

(Casting)

It is possible to cast the optical film of the present invention with reference to the methods described, for example, in Japanese Patent Publication Nos. 49-4554, 49-5614, 60-27562, 61-39890, and 62-4208.

The optical film of the present invention is commonly prepared as follows. For example, a mixture of cellulose resins and additives, which has been subjected to hot air drying or vacuum drying, is subjected to melt extrusion in the form of film employing a T-type die, and the resulting film is allowed to adhere onto a cooling drum employing an electrostatic application method, cooled, and solidified, whereby it is possible to obtain a film which is not stretched. It is preferable that the temperature of the cooling drum is maintainted it the range of 90-150° C.

Melt extrusion is performed employing a uniaxial extruder and a biaxial extruder. Further, the uniaxial extruder may be linked downstream of the biaxial extruder. In view of the mechanical and optical characteristics of the resulting film, it is preferable to employ a uniaxial extruder. Further, it is preferable that a raw material charging and melting processes which are performed employing, for example, a raw material tank, raw material charging section, and the interior of the extruder are subjected to replacement by inert gases such as nitrogen or a decrease in pressure.

The temperature during the above extrusion of the present invention is preferably in the range of 150-250° C., but is more preferably in the range of 200-240° C.

The content of volatile components during melting of film constituting materials is commonly at most 1 percent by weight, preferably at most 0.5 percent by weight, but is more preferably at most 0.1 percent by weight. In the present invention, weight decrease was determined from 30 to 350° C., employing a differential thermal weight measurement instrument (TG/DTA200, produced by Seiko Electronic Industry Co.) and the resulting weight was designated as the content of volatile components.

The optical film of the present invention is prepared in such a manner that a melted resinous composition is extruded to form a film, which cooled via a cooled roller.

It is preferable that there are no or few concave portions such as die lines on the film surface of the present invention. It is ideal that there are no concave portions such as die lines. However, in practice, it is difficult to completely eliminate such portions, and occasionally, quite a few portions remain. In cases; in which concave portions are present on the surface and when Δd represents the depth of the concave portion, Δd is preferably at most 0.5 μm, is more preferably at most 0.3 μm, but is most preferably at most 0.01 μm.

As described below, it is preferable that the optical film of the present invention is stretched in the width direction or in the cast direction.

The stretched film is subjected to slitting of both edges and then wound. It is preferable that slit edge portions are recycled as raw material. The ratio of the recycled materials incorporated in melt materials is preferably 10-90 percent, is more preferably 20-80 percent, but is still more preferably 30-70 percent. It is preferable that the slit edge portions are cut into small pieces of 1-30 mm and are employed to prepare a melt composition. If desired, after re-drying, the resulting materials are recycled as a part of raw materials. The slit portions may be converted into pellets and employed to prepare a melt composition. Further, it is preferable that slit portions are stored until re-melt so that no moisture absorption occurs. In order to achieve the above, it is preferable that processes such as conveying of film edge portions from the slitting section, the cutting process and storage process are performed in ambience of low humidity or in the absence of water and under ddehumidified air. Further, it is preferable that oxygen concentration is lowered. The oxygen concentration is commonly at most 10 percent, is preferably at most 5 percent, is more preferably at most 1 percent, but is most preferably at most 0.1 percent. For example, it is preferable that processes are performed in an ambience of dehumidified nitrogen. It is preferable that the processes from melt-extrusion to slitting are conducted at a low humidity or at an ambience of no moisture. Further, it is preferable that oxygen concentration is lowered. It is particularly preferable that the ambience of the melt-extrusion section is maintained at a combination of low humidity and lowered oxygen concentration.

In cases in which in a stretching process, stretching is performed while exposed to steam, or treated returning materials are recycled, it is preferable that the returning materials, of which moisture has been removed, is recycled as a part of the raw material.

It is also possible to prepare a laminated cellulose ester film by co-extruding compositions incorporating cellulose ester resins in which the concentration of the above plasticizers, UV absorbents, and minute particles differ. For example, it is possible to prepare a cellulose ester film having a constitution of a skin layer/a core layer/a skin layer. For example, minute particles are incorporated in the skin layer in an greater amount or only in the skin layer. It is possible to incorporate plasticizers and UV absorbents in a greater amount in the core layer than the skin layer or incorporate them only in the core layer. Further, it is possible to change the types of plasticizers and UV absorbents in the core layer and skin layer. For example, it is possible to incorporate low volatile plasticizers and/or UV absorbents in the skin layer and to incorporate excellent plasticizers or excellent UV absorbs in the core layer. Tg of the skin layer may be, different from that of the core layer, but Tg of the core layer is preferably lower than that of the skin layer. Further, the viscosity of the skin layer of the melt material during melt extrusion may be different from that of the core layer and it is acceptable that the viscosity of the skin layer>the viscosity of the core layer or the viscosity of the core layer≧the viscosity of the skin layer.

By employing a co-extrusion method, it is possible to result in distribution of the concentration of additives such as a plasticizer in the thickness direction and to decrease their content in the surface. On the other hand, by performing single layer extrusion, it is possible to obtain a uniform film in which the concentration of additives decreases in the thickness direction, whereby it is preferably employed.

The film width of the present invention is preferably 1-4 m, is more preferably 1.3-4 m, but is still more preferably 1.4-2 m. The thickness is preferably 10-500 μm, is more preferably 20-200 μm, is still more preferably 30-150 μm, but is most preferably 60-120 μm. The length per roll is preferably 300-6,000 m, is more preferably 500 -5,000 m, but is more preferably 1,000-4,000 m. When wound, knurling is applied to at least one edge and preferably both edges. The width is commonly 3-50 mm, but is preferably 5-30 mm, while the height is commonly 5-500 μm, but is preferably 8-200 μm. One sided or double-sided knurling may be employed.

(Stretching Operation)

The preferred stretching operation of the optical film of the present invention will now be described.

It is preferable that the optical film of the present invention is subjected to phase difference control employing the stretching operation described below, whereby it is possible to achieve the phase difference in the preferred range by stretching 1.0-2.0 times in one direction of the cast cellulose ester and 1.01-2.5 times in the direction at right angles to it in the interior of the film surface.

For example, it is possible to successively or simultaneously perform stretching in the longitudinal direction and the direction at right angles to it in the interior of the film surface, namely across the width of the film. During the above stretching, when the stretching ratio in one direction is excessively small, it is not possible to achieve sufficient phase difference, while when it is excessively large, it becomes difficult to perform stretching, whereby breakage occasionally occurs.

In cases in which stretching is performed in the melt cast direction, when width-wise contraction is excessively large, the refractive index of the film in the thickness direction becomes excessively large. In this case, improvement is achieved by minimizing the width-wise contraction of the film or by performing width-wise stretching. In cases in which width-wise stretching is performed, a distribution of the resulting index occasionally results width-wise. This occasionally occurs in the use of the tenter method. This is phenomenon which is formed in such a manner that by performing width-wise stretching, contraction force is generated in the central portion of the film, while the edge portion is fixed and is assumed to be so-called boing phenomenon. Even in this case, it is possible to retard the boing phenomenon by performing the above casting direction stretching and to minimize the width-wise phase difference distribution.

Further, by stretching in the biaxial directions, being at right angles to each other, it is possible to decrease the thickness variation of the resulting film. When the thickness variation of an optical film is excessively large, uneven phase difference results, and when employed in liquid crystal displays, problems of non-uniformity such as coloration occasionally occur.

It is preferable that the thickness variation of the optical film of the present invention is controlled in the range of ±3 percent and further ±1 percent. To achieve the above purposes, a method is effective in which stetching is performed in the biaxial directions which are in right angles to each other. It is preferable that stretching magnification in the biaxial directions which are in right angles to each other is finally preferably in the range of 1.0-2.0 times in the cast direction and in the range of 1.01-2.5 times in the width direction and more preferably in the range of 1.01-1.5 times in the cast direction and in the range of 1.05-2.0 times in the width direction.

As a phase different film, in order to control retardation in the plane or thickness direction, it may be possible to perform free edge uniaxial stretching in the cast direction or the width direction, or unbalanced biaxial stretching in which stretching is performed in the width direction while contraction is performed in the cast direction. The stretching magnification in the contraction direction is preferably at a factor of 0.7-1.0.

In the case of use of cellulose ester resulting in positive birefringence for stress, by performing width-wise stretching, it is possible to provide delayed phase axis of the optical film in the width direction. In this case, in the present invention, in order to enhance listed quality, it is preferable that the delayed phase axis of the optical film is in the width direction and to satisfy (stretching magnification in the width direction)>(stretching magnification in the cast direction).

A film, which has been formed by extruding a melt resinous composition and subsequently cooling the resulting extruded material employing a cooling roller, is subjected to preliminary heat treatment prior to stretching, preferably at 50-180° C., more preferably 60-160° C., but most preferably at 70-150° C., and preferably for 5 seconds-3 minutes, more preferably for 10 seconds-2 minutes, but most preferably for 15-90 seconds. It is preferable that the above heat treatment is performed between just prior to holding a film employing a tenter and just prior to the start of stretching. It is particularly preferable that the heat treatment is performed between holding the film employing the tenter and just prior to the start of film stretching.

It is possible to stretch the optical film of the present invention which incorporates moisture in an amount of at most 2 percent by weight, but it is also possible to control the content of moisture prior to stretching. For example, it is possible to stretch the film, which has incorporated water, via immersion into water and/or exposure to steam. In this case, the moisture content of the film is controlled to be 2-10 percent by weight. When immersed in water, the temperature of water is preferably 60-100° C., but is more preferably 80-100° C. By conveying the film prior to stretching into heated water for 0.1-20 minutes, it is possible to incorporate water into the film. Alternatively, by exposing the film into steam at 60-150° C. and 70-100 percent RH for 0.1-20 minutes, it is possible to incorporate water into the film.

If desired, it is possible to stretch the cellulose ester film whose water content has been controlled to be 2.0-10 percent by weight employing the above methods.

Stretching is preferably performed at 5-300 percent/minute, more preferably at 10-200 percent/minute, but still more preferably at 14-150 percent/minute. Such stretching is preferably performed at 80-180° C., more preferably at 90-160° C., but still more preferably at 100-150° C. It is preferable that stretching is performed employing a tenter while both ends of the film are held.

The stretching angle is preferably 2° -10°, more preferably 3°-7°, but most preferably 3°-5°. The stretching rate may be constant or may vary.

It is preferable that the ambient temperature during the tenter process exhibits minimal distribution. Variation across the width is preferably within ±5° C., more preferably within ±2° C., still more preferably within ±1° C., but most preferably within ±0.5° C. It is preferable that in the tenter process, a heat treatment is performed preferably in the range of a heat conductivity of 20-130×10³ J/m²hr, more preferably in the range of 40-130×10³ J/m²hr, but most preferably in the range of 42-84×10³ J/m²hr.

During film casting, the conveyance rate in the longitudinal direction is preferably 10-200 m/minute, but is more preferably 20-120 m/minute.

The film conveying tension during the casting process in the tenter varies depending on temperature, but is preferably 120-200 N/m, is more preferably 140-200 N/m, but is most preferably 140-160 N/m.

In order to minimize undesired film elongation during the casting process, it is preferable to arrange a tension reduction roller prior to or after the tenter.

It is preferable that biaxial stretching in the present invention is performed by applying tension in the conveying direction during roll conveyance. It is preferable that as a method to apply tension in the conveying direction, conveying rollers which differ in their peripheral rate are employed, or two paired nipping rollers are employed and tension is applied between them.

It is preferable that one or both of the above nipping rollers are covered with rubber. When the moisture content of stretched film is relatively high, the film tends to slip, whereby it is preferable to use nipping rollers covered with rubber. Listed as rubber materials are natural rubber and synthetic rubber (such as neoprene rubber, styrene-butadiene rubber, silicone rubber, urethane rubber, butyl rubber, nitrile rubber, or chloroprene rubber). The thickness of the rubber covering is preferably 1-50 mm, is more preferably 2-40 mm, but is most preferably 3-30 mm. The diameter of a nipping roller is preferably 5-100 cm, is more preferably 10-50 cm, but is most preferably 15-40 cm. A preferred nip roller is such that its interior is hollow so that it is possible to regulate the temperature from its interior.

When two paired nipping rollers are employed, it is preferable that stretching is performed in such a manner that the temperature in the span of the two paired nipping rollers is 5-50° C. higher than the temperature of the nipping roller on the inlet side. It is preferable that the distance of the span of two paired nipping rollers is 1-10 times the film width prior to stretching but is preferably 2-8 times. It is preferable to employ two paired nipping rollers arranged as above and to perform stretching in such a manner that the temperature at both edges is 5-50° C. higher than in the central portion.

Further, in this case, it is preferable to perform stretching so that stretching rate S per second preferably satisfies 0.2WL1≦S≦2WL1, more preferably 0.3 WL1≦S≦1.8WL1, but still more preferably 0.4WL1 <S <1.5WL1, wherein WL1 represents the width of the film with respect to the conveying direction prior to stretching. By setting the span distance in the above range and controlling the stretching rate, it is possible to obtain a stretched film of minimal uneven film thickness and uneven retardation. It is desired to maintain the stretching temperature between the spans of two paired nipping rollers at specified temperature. To achieve the above, it is preferable that the space between two paired nipping rollers is placed in a thermostat so that during film stretching, the specified temperature is maintained. It is preferable to control the temperature of the film by feeding temperature-controlled air from the upper and lower sides of the film. In this case, it is possible to make the width-wise temperature uniform, but the temperature at both edges is preferably 1-50° C. higher than the central portion, but more preferably 5-40° C. higher. It is still more preferable that stretching is performed so that the temperature of both edges is 10-35° C. higher than in the central portion. By performing stretching while width-wise temperature distribution is achieved, it is possible to decrease the distribution of the width-wise retardation (Ro and Rt). It is possible to achieve the temperature increase of the edge portions employing a method in which a heat radiating source, such as an infrared heater or a halogen lamp is employed or slits which feed heated air are locally arranged. Incidentally, the temperature at the stretching portions is preferably 100-180° C. at the central portion in the film width direction, is more preferably 110-170° C., but is still more preferably 120-160° C. It is particularly preferable that the central potion between nipping rollers is at the temperature in the above range.

Stretching is performed so that the temperature between two paired nipping rollers is 5-50° C. higher than the temperature on the nipping rollers of the inlet side, more preferably 7-40° C., but still more preferably 10-30° C. Temperature between two paired nipping rollers, as described herein, refers to the average temperature of the ½ part of the central portion of the nipping roller span. During typical stretching, the temperature in the longitudinal direction is maintained to be uniform during stretching, but it is possible to provide the above temperature distribution. Namely, when the entire interior of a stretching zone is uniformly maintained, stretching is achieved over the entire portion of the stretching zone. Namely, stretching is initiated from the nipping roller on the inlet side. However, the film is fixed on the nipping roller, whereby it is not possible to perform width-wise neck-in. However, when removed from that, neck-in is rapidly initiated. In such a manner, width-wise stress varies discontinuously, whereby width-wise stress marks tend to be generated, resulting in thickness marks and Re marks. In the present invention, by making the temperature higher than that of the nipping roller on the inlet side, it is possible to set backward the stretching initiation point from the nipping rollers. As a result, the stretching initiation point is not restricted by the nipping rollers, whereby discontinuous stress variation, as described above, does not occur to minimize Re marks and thickness marks due to stress marks. It is preferable that such a temperature distribution in the longitudinal direction is provided to the central portion across the width and at least one of edge portions. It is possible to easily control the temperature of the inlet nipping rollers in such a manner that at least one nipping roller is modified to a temperature controlling roller. For example, a hollow roller is employed and temperature-controlled liquid is re-circulated in the interior, or a heat source is placed in the interior and its output is controlled.

The nip pressure of nipping rollers is preferably 0.5-20 t per meter, more preferably 1-10 t, but is still more preferably 2-7 t. In the present invention, stretching is performed preferably in the temperature range of 50-150° C., more preferably in the range of 60-140° C., but is still more preferably in the range of 70-130° C. It is common that temperature is uniformly maintained in the width direction and in the longitudinal direction, but in the present invention, it is preferable that a temperature difference is provided for one of them. The above temperature difference is preferably 1-20° C., is more preferably 2-17° C., but is still more preferably 2-25° C. The glass transition point (Tg) of a moisture containing film is lowered, whereby it is possible to perform stretching employing weak stress. However, neck-in tends to occur to result in uneven stretching. In order to minimize such a drawback, it is effective to provide the temperature distribution described below.

(Temperature Distribution in the Longitudinal Direction)

In nipping roller stretching, stress tends to concentrate in the outlet (namely, a stretching initiation point) of the nipping roller on the upstream side, whereby stretching is mainly performed there and uniform stretching is hardly performed. In order to perform uniform stretching over the entire region, it is preferable that the temperature just after the upstream nipping rollers is controlled to be lower by the above temperature than the average temperature (namely the temperature at the center of the stretching portion in the longitudinal direction). It is possible to achieve such a temperature distribution as follows. A nip roller on the upstream side is modified to a temperature controlling roller and the temperature of the modified roller is lowered. Alternatively, it is possible o employ divided heat sources (heat radiating sources such as an IR heater or a plurality of heated air blowing apertures).

(Temperature Distribution in the Width Direction)

In the case of stretching at a small aspect ratio, uneven stretching in the width direction tends to result. Namely, both edges are more easily stretched than the central portion. Accordingly, it is preferable that the temperature of both edges is the above temperature higher than the central portion in the width direction. It is possible to achieve such temperature distribution employing divided heat sources (being heat radiating sources such as an IR heater or a plurality of heated air blowing apertures) arranged along the width direction.

The above stretching is performed preferably within 1-30 seconds, more preferably within 2-25 seconds, but still more preferably within 3-20 seconds.

After stretching, it is preferable that residual distortion is relaxed employing a heat treatment. The heat treatment is commonly performed at 80-200° C., preferably at 100-180° C., but still more preferably at 130-160° C. In the above case, the heat treatment is performed preferably in the range of a heat conductivity of 20-130×10³ J/m²hr; more preferably in the range of 40-130×10³ J/m²hr, but most preferably in the range of 42-84×10³ J/m²hr. By doing so, the residual distortion is eliminated, whereby dimensional stability at high temperature such as 90° C., or high temperature and high humidity such as 80° C. and 90 percent RH is improved.

After stretching, the film is cooled to room temperature. It is preferable that the stretched film is cooled while it is subjected to width holding by the tenter. Relaxation is preferably performed in such a manner that the width hold by the tenter is reduced preferably by 1-10 percent, more preferably by 2-9 percent, but still more preferably by 2-8 percent with respect to the film width after stretching. A practical cooling rate is preferably 10-300° C. per minute, more preferably 30-250° C. per minute, but still more preferably 50-200° C. per minute. Cooling to room temperature may be performed under tenter holding. However, it is preferable that on the way, holding is terminated and roll conveying is employed. Thereafter, roll winding is performed.

The optical film of the present invention, produced as above, exhibits the following characteristics.

(Optical Characteristics)

In the optical film of the present invention, it is preferable that retardation value Ro, defined by Formula (I) below, is in the range of 0-300 nm and retardation value Rt, defined by Formula (II) below, is in the range of −600 to 600 nm. Further, value Ro is more preferably in the range of 0 to 80. nm and value Rt is more preferably in the range of −400 to 400 nm, while value Ro is most preferably in the range of 0 to 40 nm and value Rt is most preferably on the range of −200 to 200 nm.

In cases in which the optical film of the present invention is employed as a phase difference film, especially as a λ/4 plate, birefringence in the wavelength range ◯ 400 to 700 nm increases as the wavelength increases, the retardation value (R450) in the plane direction determined at a wavelength of 450 nm is 80-125 nm, and the retardation value (R590) in the plane direction determined at a wavelength of 590 nm is 120-160 nm. In this case, it is more preferable that R590-R450≦5 nm, while it is most preferable that R590-R450≧10 nm. It is preferable that R450 is 100-120 nm; retardation value R550 in the in-plane direction determined at a wavelength of 550 m is 125-142 nm; R590 is 130-152; and R590-R550≧2 nm. It is more preferable that R590-R550≧5 nm, while it is most preferable that R590-R550≧10 nm. Further, it is also preferable that R550-R450≧10 nm.
Ro=(nx−ny)×d Formula (I)
Rt={(nx+ny)/2−nz}×d Formula (II)
wherein nx represents the refractive index in the direction in which the refractive index in the film plane is maximum, ny represents the refractive index in the film plane in the direction in right angles to nx, nz represents the refractive index in the thickness direction of film, and d represents the film thickness.

By controlling the retardation value to the above range, it is possible to sufficiently satisfy optical performance of phase difference film for polarizing plates.

It is preferable that refractive index nx in the delayed phase axis direction in the plane determined at a wavelength of 590 of the film of the present invention, refractive index ny in the direction in right angles to the delayed phase axis in the plane, and refractive index nz in the thickness direction satisfy the relationship of 0.3≦(nx−nz)/(nx−ny)≦2, but it is more preferably that they satisfy the relationship of 1≦(nx−nz)/(nx−ny)≦2.

Further, the difference between refractive index nx in the delayed phase axis direction and refractive index ny in the advanced phase direction in the film plane of the cellulose film of the present invention is preferably 0-0.0050, but is more preferably 0.0010-0.0030. Further, the absolute value of (Nx+Ny)/2−Nz is preferably at most 0.005, wherein Nx represents the refractive index in the delayed phase axis direction in the film plane, Ny represents the refractive index in the advanced phase axis direction, and Nz represents the refractive index of the thickness direction.

Ratio Rt/Ro is preferably −10 to 10, is more preferably −2 to 2, is still more preferably −1.5 to 1.5, but is most preferably −1 to 1. The more preferred range is selected depending on utilization and then employed. For example, in cases for using compensation of VA liquid cells, 2-10 is preferably employed, while 2-4 is more preferably employed.

Moisture dependence of value Ro and value Rt of cellulose ester film determined at a wavelength of 590 n is preferably 2%/% RH and 3%/% RH in terms of the absolute value, respectively, in the range of 30° C. 15% RH to 30° C. 85% RH.

It is preferable that value Rt (Rt450) determined at a wavelength of 450 nm and value Rt (Rt650) determined at a wavelength of 650 nm satisfy the relationship of the following formula.
0≦|Rth450−Rth650|≦35 (nm)

Temperature dependence of value Ro and value Rt in the range of 5-85° C. is at most 5%/° C. and at most 6%/° C. in terms of the absolute value, respectively.

In the cellulose ester film of the present invention, moisture dependence of value Ro and value Rt in the range of 30° C. 15% RH −30° C. 85% RH is at most 2%/% RH and 3%/% RH in terms of the absolute value, respectively.

Humidity dependence of value Ro and value Rt from 15% RH to 85% RH from 15° C. to 40° C. is preferably as small as possible. For the value of each temperature at 50% RH, humidity dependence is preferably at most 2%/% RH and 3%/% RH in terms of the absolute value, respectively. Specifically, humidity dependence from 30° C. 15% RH to 30° C. 85% RH is preferably at most 2%/% RH and at most 3%/% RH in terms of the absolute value, respectively, but is most preferably at most 5%/% RH and 2.5%/% RH, respectively.

It is preferable that these exhibit smaller difference of the equilibrium moisture content at the different moisture conditions. For example, at two moisture ambiences of 30° C., 15% RH and 30° C., 85% RH, difference WH of the equilibrium moisture content, represented by the formula below, is preferably. at most 2.5%, is more preferably at most 2%, is still more preferably at most 1.5%, is further more preferably at most 1%, but is most preferably at most 0.5%.

WH=equilibrium moisture content at 30° C. and 85% RH—equilibrium moisture content at 30° C. and 15% RH In order to minimize variation of the equilibrium moisture. content, the following methods are effective; the content of plasticizers is increased, additives such as hydrophobic plasticizers or resins incorporating an aromatic ring, a cycloalkyl ring, or a norbornene ring, and relatively high heat treatment temperature after stretching is set (for example 110-180° C.)

Further, temperature dependence of value Ro and value Rt from 5° C. to 85° C. from 15% to 85% is preferably as small as possible. For the value at 30° C., the variation of value Ro is preferably within ±5%/° C., while the variation of value Rt is preferably within ±6%/° C. Between 5° C. 55% RH and 85° C. 55% RH, the variation of value Ro is preferably within ±3%/° C. and the variation of value Rt is preferably within ±4%/° C., the variation of value Ro is more preferably within ±1%/° C. and the variation of value Rt is more preferably within ±2%/° C., while the variation of value Ro is most preferably within ±0.5%/° C. and the variation of value Rt is most preferably within ±1%/° C.

In the cellulose ester film of the present invention, with respect to Ro which is determined by allowing the above film to stand at 55% RH and 23° C. for 24 hours, value Ro which is determined by allowing the above film to stand at 23°° C. and 55% RH for 24 hours after being allowed to stand at −30 to 80° C. and 10 to 80% RH for 600 hours is preferably within ±10% but is more preferably within ±3%. In the same manner, with respect to Rt which is determined by allowing the above film to stand at 55% RH and 23° C. for 24 hours, value Rt which is determined by allowing the above film to stand at 23° C. and 55% RH for 24 hours after being allowed to stand at −30 to 80° C. and 10 to 80% RH for 600 hours is preferably within ±10% but is more preferably within ±3%. It is more preferable that even after allowing the above film to stand over a long period such as at least 1,000 hours, the variation is within the above range.

It is preferable that the optical film of the present invention exhibits increasing phase difference in the range of wavelength of 400-700 nm, as the wavelength increases. Specifically, when retardation in the film plane determined at each wavelength of 450 nm, 590 nm, and 650 nm is R450, R590, and R650, respectively, it is preferable that the following relationship is satisfied.

0.5<R450/R590<1.0

1.0<R650/R590<1.5

It is more preferable that the following relationship is satisfied.

0.7<R450/R590<0.95

1.01<R650/R590<1.2.

It is most preferable that the following relationship is satisfied.

0.8<R450/R590<0.93

1.02<R650/R590<1.1

Birefringence at wavelengths of 450, 590, and 650 nm at an ambience of 23° C. and 55% RH was determined employing an automatic birefringence meter KOBURA-21ADH (produced by. Oji Keisoku Co.), and the resulting values were designated as R450, R590, or R650, respectively.

Retardation values (Ro and Rt) and each distribution were determined as follows. Wavelength 590 nm birefringence of a sample at intervals of one centimeter in the width direction was automatically determined at 23° C. and 55% RH, employing an automatic birefringence meter KOBURA-21ADH (produced by Oji Keisoku Co.). The standard deviation of the resulting retardation in the in-plane direction and the thickness direction was obtained employing the (n-1) method. The variation coefficient (CV) of the retardation distribution was obtained and used as an index. In practical measurement, 130-140 were set as n.

Variation coefficient (CV)=standard deviation/retardation average

When C (md) represents a photoelastic coefficient in the longitudinal direction of a cellulose ester film and C (td) represents a photoelastic coefficient in the width direction of the same, each value is preferably in the range of 1×10⁻⁸-1×10⁻¹⁴ Pa⁻¹, but is particularly preferably in the range of 1×10⁻⁹-1×10⁻¹³ Pa⁻¹. The photoelastic coefficient is determined as follows. While applying load to a film, retardation (Ro) in the film plane is determined, and Δn (=R/d) is obtained by dividing the resulting retardation by film thickness (d). While varying applied load, Δn is determined. Subsequently, a load versus Δn curve is prepared and the resulting slope is designated as the photoelastic coefficient. By applying Load to a film in the longitudinal direction or in the width direction, it is possible to obtain each value. Retardation (R) in the film plane was determined at a wavelength of 590 nm, employing a retardation measurement instrument (KOBURA 31PR, produced by Oji Keisokuki Co., Ltd.).

It is preferable that photoelastic coefficient C (md) is nearly equal to C (td), or C (td) is greater than C (md).

The delayed phase axis or advanced phase axis of the optical film of the present invention exists in the film plane. Angle θ1 to the casting direction is preferably −1° to +1°, but is more preferably −0.5° to +0.5°. It is possible to define above θ1 as the orientation angle. It is possible to determine θ1 employing an automatic birefringence meter KOBURA-21ADH (produced by Oji Keisokuki Co., Ltd.).

By allowing θ1 to satisfy the above relationship, it is possible to contribute to achieve high luminance of displayed images and to retard or prevent light leakage, as well as to further achieve faithful color reproduction in color liquid crystal display devices.

Other physical properties of the optical film of the present invention will now be described.

(Moisture Vapor Transmittance)

The moisture vapor transmittance of the cellulose ester film of the present invention is preferably 1-250 g/m²·24 hours at 25° C. and 90% RH, is more preferably 10-200 g/m²·24 hours, but is most preferably 20-180 g/m²·24 hours. It is possible to determine the above moisture vapor transmittance employing the method described in JIS Z 0208.

(Equilibrium Moisture Content)

The equilibrium moisture content of cellulose ester film is preferably 0.1-3 percent at 25° C. and 60 percent relative humidity, is more preferably 0.3-2 percent, but is most preferably 0.5-1.5 percent.

It is possible to determine the equilibrium moisture content employing the Carl Fischer method measurement instruments (such as Carl Fischer moisture measurement instrument CA-05, produced by Mitsubishi Chemical Co., Ltd.; water-vaporizing device: VA-05, internal liquid: AQUAMICRON CXμ, external liquid: AQUAMICRON AX, nitrogen flow rate: 200 ml/minute, and heating temperature 150° C.). In practice, a sample which has been rehumidified at 25° C. and relative humidity 60 percent for at least 24 hours is accurately weighed in an amount of 0.6-1.0 g and is subjected to determination employing a measurement instrument. Subsequently, it is possible to obtain the equilibrium moisture content based on the resulting weight of water.

In order to secure adhesion to polyvinyl alcohol (being a polarizer), the moisture content of the cellulose ester film of the present invention is preferably 0.3-15 g/m², but is more preferably 0.5-10 g/m². When it is at least 15 g/m², retardation variation tends to increase due to temperature and humidity variations.

(Dimensional Stability)

One of the features of the cellulose ester film according to the present invention is excellent dimensional stability. By employing the measurement method below, length variation (contraction) as a variation ratio respect to the original length is determined and then evaluated. The dimensional variation ratio is preferably 0 to −0.06 percent.

(Dimensional Variation Ratio of Cellulose Ester Film in the Width Direction and Longitudinal Direction)

When cellulose ester film is stretched in the width direction, it is preferable that stretching is conducted at conditions to control the resulting dimensional variation ratio within a certain range.

When dimensional variation ratio in the TD direction and the MD direction prior to and after the treatment at a dry condition of 90° C. for 24 hours is represented by Std and Smd, respectively, −0.4%<Std or Smd<0.4% is preferred; −0.2%<Std or Smd<0.2% is more preferred; −0.1%<Std or Smd<0.1% is further more preferred; and −0.05%<Std or Smd<0.05% is particularly preferred.

When dimensional variation ratio in the TD direction and the MD direction prior to and. after treatment at high temperature and high humidity conditions of 80° C. and 90% RH for 24 hours is represented by Std and Smd, respectively, in the same manner as above, −0.4%<Std or Smd<0.4% is preferred; −0.2%<Std or Smd<0.2% is more preferred; −0.1%<Std or Smd<0.1% is further more preferred; and −0.05%<Std or Smd<0.05% is particularly preferred.

(Determination of Dimensional Variation Ratio)

After rehumidifying the film in the room conditioned at 23° C. and 55 percent relative humidity for 24 hours, marks were made at about 10 cm intervals in the width direction and the longitudinal direction employing a cutter, and distance (L1) was determined. Subsequently, the resulting film was stored in a thermostat conditioned at the specified temperature and humidity for 24 hours. After rehumidifying the film in a room conditioned at 23° C. and relative humidity 55 percent for 24 hours, the marked distance (L2) was determined. The dimensional variation ratio was evaluated based on the formula below.

Dimensional variation ratio (%)={(L2-L1)/L1}×100

(Hygroscopic Expansion Coefficient)

It is preferable that the hygroscopic expansion coefficient of the cellulose ester film of the present invention is in the specified range. The hygroscopic expansion coefficients in the width direction (TD) and the longitudinal direction (MD) may be the same or different. Specifically, the hygroscopic expansion coefficient at 60° C. and 90 percent relative humidity is preferably in the range of −1 to 1 percent, is more preferably in the range of −0.5 to 0.5 percent, is still more preferably in the range of −0.2 to 0.2 percent, but is most preferably 0 to 0.1 percent.

<Determination of Hygroscopic Expansion Ratio>

After rehumidifying the film in a room conditioned at 23° C. and 55 percent relative humidity for 24 hours, marks were:made at about 20 cm intervals in the width direction and the longitudinal direction employing a cutter, and distance (L3) was determined. Subsequently, the resulting film was stored in a thermostat conditioned at 60° C. and 90% for 24 hours. After removing the film from the thermostat, the marked distance (L4) was determined within two minutes. The hygroscopic expansion coefficient was evaluated based on the formula below.

$$Hygroscopic expansion coefficient ( \% ) = \{ ( L4 - L3 ) / L3 \} \times 100$$

(Thermal Contraction Initiating Temperature)

The thermal contraction initiating temperature of the film of the present invention is preferably in the range of 130-220° C., is more preferably 135-200° C., but is still more preferably 140-190° C. It is possible to determine the thermal contraction initiating temperature employing TMA (a thermal mechanical analyzer). In practice, while heating a film sample, the length of the sample is determined and the temperature is recorded when the sample is subjected to contraction by two percent. The thermal contraction initiating temperature varies depending on the stretching factor. However, it is preferable that a sample in the higher stretching ratio direction exhibits a thermal contraction initiating temperature within the above range.

The higher the thermal contraction initiating temperature becomes, the more preferable due to minimal dimensional change caused by heat. However, when the thermal contraction initiating temperature becomes excessively high, melt temperature during casting becomes higher. As a result, it occasionally becomes difficult to maintain smoothness of the film surface due to decomposition of resins during melting and an increase in melt viscosity. The thermal contraction initiating temperature varies depending on film Tg and distortions remaining in the cast film, whereby it is possible to adjust the thermal contraction initiating temperature by controlling those. Particularly, in order to minimize distortions remained in film, it is preferable to control stretching conditions (such as a stretching ratio, stretching temperature, or stretching rate), relaxation conditions after stretching, and thermal treatment conditions.

<Determination of Thermal Initiating Temperature>

Film is cut along the direction to be determined to prepare a sample in a size of 35 mm in length and 3 mm in width. Both edges are chucked at 25 mm intervals in the longitudinal direction. By employing a TMA measurement instrument. (THERMOMECHANICAL ANALYZER TYPE TMA2940, produced by TA Instruments Co.) under application of a force of 0.04 N, dimensional change is determined while increasing temperature to 200° C. at a rate of 3° C./minute. The length at 30° C. is taken as a standard and temperature at which contraction of 500 μm from the standard occurs is designated as the contraction initiating temperature.

<Heat Conductivity>

The heat conductivity of the film of the present invention is preferably 0.1-15 W/(m.K), but is more preferably 0.5-11 W/(m.K). It is preferable that in order to control the heat conductivity of film, resins of higher heat conductivity are blended or high heat conductive particles are added. It is also possible to prepare film in such a manner that a high heat conductive layer is applied or coextruded. Listed as high heat conductive particles may be particles composed of aluminum nitride, silicon nitride, boron nitride, magnesium nitride, silicon carbide, aluminum oxide, zinc oxide, magnesium oxide, carbon, diamond, and metals. It is preferable to employ transparent particles so that transparency of film is maintained. In cases in which cellulose acetate film is employed as a polymer film, the content of high heat conductive particles is preferably in the range of 5-100 parts by weight with respect to 100 parts by weight of cellulose acetate. When the content is less than 5 parts by weight, heat conductivity is not sufficiently enhanced, while exceeding 50 parts by weight results in difficulty in production aspect and brittle film. Further, the average diameter of high heat conductive particles is preferably 0.1-10 μm. The shape of the employed particles may be either spherical or acicular.

(Tear Strength)

The tear strength of the cellulose ester film according to the present invention is preferably 2-55. g at 30° C. and 85 percent relative humidity so that ease of handling in the casting process employing melt extrusion is not deteriorated.

When cellulose ester film is stretched in the width direction, it is preferable that stretching is performed at conditions to control the ratio of the tear strength in the machine conveying direction (hereinafter referred to as MD direction) and the width direction (hereinafter referred to as TD direction) in a certain range. When Htd and Hmd each represent tear strength in the TD direction and the MD direction, respectively, their ratio is preferably 0.5<Htd/Hmd<2, is more preferably 0.6<Htd/Hmd<1, is still more preferably, 0.8<Htd/Hmd<1, but is most preferably 0.9<Htd/Hmd<1.

<Determination of Tear Strength>

After rehumidifying cellulose ester film in a room conditioned at 23° C. and 55 percent relative humidity, the resulting film was cut into 50×64 mm pieces. Subsequently, the tear strength was determined based on ISO 6383/2-1983.

(Dynamic Friction Coefficient)

The dynamic friction coefficient of the film surface of the present invention is preferably at most 1.0, is more preferably at most 0.8, is still more preferably at most 0.4, is still more preferably at most 0.35, is further still more preferably at most 0.30, but is most preferably at most 0.25. As noted above, minute unevenness is formed by adding minute particles to a resinous film and by providing a minute particle containing layer, whereby it is possible to decrease the dynamic friction coefficient.

(Elastic Modulus)

When cellulose ester film is stretched in the width direction, it is preferable to perform stretching under conditions to control the elastic modulus of the resulting film within a certain range. The elastic modulus in the width direction (TD) and the longitudinal direction (MD) may be the same or different. Specifically, the elastic modulus is preferably in the range of 1.5-5 GPa, is more preferably in the range of 1.8.-4 GPa, but is particularly preferably in the range of 1.9-3 GPa.

(Stress at Break)

It is preferable that the stress at break of the optical film of the present invention is maintained in the range of 50-200 MPa. By maintaining the stress at beak in the above range, dimensional stability and flatness are improved. It is possible to control the stress at break utilizing stretching ratio and stretching temperature.

It is preferable to control the stress at break within the range of 70-150 MPa, but it is more preferable to control it within the range of 80-100 MPa.

(Elongation at Break)

The elongation at break of the film of the present invention is preferably 10-120 percent. Particularly, in a film prior to stretching, in any direction in the film plane, elongation at break is preferably in the range of 40-100 percent, is more preferably in the range of 50-100 percent, is further more preferably in the range of 50-100 percent, but is most preferably in the range of 60-90 percent. It is possible to control the elongation at break by controlling the content of additives, resin blending, addition of polymer plasticizers such as polyester and urethane, stretching temperature, stretching ratio, thermal treatments after stretching, and relaxation conditions.

Elongation at break in the stretching direction tends to decrease compared to that prior to stretching, while as the stretching factor increases, it decreases. In the direction at right angles to the stretching direction at a maximum factor on the film plane, it is preferable to maintain the elongation at break prior to film stretching.

The elongation at break of the cellulose ester film in the direction at right angles to the stretched direction at the maximum factor on the film plane is preferably 20-120 percent, but is more preferably 30-100 percent. The elongation at break of the film of the present invention in the stretched direction at the maximum factor is preferably 10-100 percent, is more preferably 12-60 percent, but is further more preferably 15-30 percent.

By controlling the elongation at break within the above range, it is possible to obtain a film exhibiting excellent flatness and to improve dimensional stability.

Elongation at break is the ratio (in percent) of the magnitude of elongation prior to the break due to elongation. It is possible to determine elongation at break employing a tensile strength tester. A cut sample of a length of 15 cm and a width of 1 cm is prepared with respect to the direction to be determined. The sample which has been rehumidified at 25° C. and 60 percent relative humidity for 24 hours is elongated at the same conditions and elongation at break is determined. In a tensile strength tester, the distance between the chucks is set at 10 cm while the pulling rate is set at 10 mm/minute. The ratio (expressed in percent) of the magnitude of elongation at break to the length of the sample prior to elongation is designated as elongation at break (percent).

<Determination Method of Elastic Modulus, Elongation at Break, and Stress at Break of Film>

Determination was conducted at 23° C. and 55 percent relative humidity based on the method described in JIS K 7127. A sample was cut into pieces of a width of 10 mm and a length of 130 mm. Tests were performed in such a manner that at optional temperature, the distance between the chucks was set at 100 mm and the pulling rate was set at 100 mm/minute and above values were determined.

(Center Line Mean Roughness (Ra))

High flatness is required for the optical film of the present invention. Its center line mean roughness (Ra) is preferably at most 0.1 μm, is more preferably at most 0.01 μm, but is most preferably at least 0.001 μm. Center line mean roughness (Ra) is the numerical value specified by JIS B 0601 and is determined employing methods, such as a needle contacting method or an optical method.

Center line mean roughness (Ra) was determined employing a non-contact surface micro-shape measurement instrument WYKO NT-2000.

(Thickness)

The thickness of the cellulose ester film of the present invention is commonly in the range of 5-500 μm. When employed as a polarizing plate protective film, in view of dimensional stability of polarizing plates and water barrier properties, the thickness is preferably 20-200 μm. Further, as a roll film, the distribution in the longitudinal direction and the width direction is preferably within ±3 percent, is more preferably within ±1 percent, but is most preferably within ±0.1 percent.

(Layer Thickness Distribution)

After rehumidifying a sample film for 4 hours in the room conditioned at 23° C. and 55 percent relative humidity, the layer thickness was determined at 10 mm intervals in the width direction. Based on the resulting layer thickness distribution data, layer thickness distribution R (in percent) was calculated based on the formula below.
R (percent)={R(max)−R(min)}×100/R(ave),
wherein R(max) represents the maximum layer thickness, R(min) represents the minimum layer thickness, and R(ave) represents the average layer thickness.
(Curling)

In the film of the present invention, eaves-shaped curl. (curl in the width direction) is preferably at most 30 m⁻¹, is more preferably 25 m⁻¹, but is further more preferably 20 m⁻¹. The curl value, as described herein, is represented by a reciprocal of radius (determined utilizing m units) of curvature of curl, whereby as the value increases, curl is more pronounced. A curl determination method is described below. In the case of large curl, a polymer film is not subjected to an eaves shape but is subjected to a cylindrical shape. Even after the film is subjected to a heat treatment, it is preferable that the resulting curl is within the above range. It is possible to increase or decrease the eaves-shaped curl by providing coating layers. Alternatively, by coating solvents which swell or dissolve film, it is possible to result in curl on the interior side with respect to the coating side, whereby it is possible to control curl within the specified range via a counterbalancing curl.

(Curl Determination Method)

After allowing the film sample of the present invention to stand at 25° C. and 55 percent relative humidity for three days, the resulting film sample was cut into a piece of 50 mm in the width direction and 2 mm in the longitudinal direction. After rehumidifying the above film piece at an ambience of 23° C.±2° C. and 55 percent relative humidity for 24 hours, it is possible to determined the curl value of the above film employing a curvature scale. Degree of curl was determined based on A Method of JIS K 7619-1988.

Curl values are expressed by 1/R, wherein R is the radius of curvature, while using m units.

(Luminescent Spots Due to Foreign Matter)

In the present invention, preferably employed are cellulose resins or melt compositions, which result in minimal luminescent spots due to foreign matter. Luminescent spots due to foreign matter, as described herein, refer to spots which are viewed as a lighting spot due to the light transmission of a light source when a cellulose resinous film sample is placed between cross-nicol arranged polarizing plates and while one side is exposed to light, the other side is viewed. Desired as an optical film for display devices is one which results in minimal luminescent spots due to foreign matter. The number of luminescent spots due to foreign matter at a size of at least 10 μm is preferably at most 100/cm², and is most preferably zero, while the number of the spots at a size of 5-10 μm is preferably at most 200/cm², is more preferably at most 50/cm², but is most preferably zero. It is also preferable that luminescent spots due to foreign matter at a size of less than 5 μm are minimized. It is possible to decrease luminescent spots due to foreign mater of optical film by selecting cellulose resins as a raw material which incorporate minimal foreign matter or by filtering cellulose resin solutions or cellulose resinous melt compositions.

<Determination Method of Luminescent Spots due to Foreign Matter>

A film sheet was interposed by two polarizing plates in an orthogonal state (being a cross-nicol state), and light was exposed to the exterior side of one of the polarizing plates and the exterior side of the other plate was observed employing a microscope (at a magnification factor of 30). Subsequently, the number of lighting spots (luminescent spots due to foreign matter) per 25 mm² was determined. The resulting luminescent spots due to foreign matter are foreign substances, which are viewed as a lighting spot by being transmitted through spots in which foreign substances are present. Determination was preformed at 10 areas and the number of luminescent spots due to foreign matter per total 250 mm² was determined and the number/cm² was obtained and employed for evaluation.

(Image Definition)

Image definition is defined in JIS K 7105. When determined employing a 1 mm slit, at least 90 percent is preferred, at least 95 percent is more preferred, but at least 99 percept is most preferred.

A functional layer which may be formed on the surface of the optical film of the present invention will now be described.

(Formation of Functional Layers)

During production of the optical film of the present invention, prior to/after stretching, coated may be functional layers such as a transparent conductive layer, a hard coatinging layer, an antireflection layer, a lubricating layer, an adhesion aiding layer, a glare shielding layer, a barrier layer, or an optical compensating layer. Specifically, it is preferable to arrange at least one layer selected from the group consisting of a transparent conductive layer, an antireflection layer, an adhesion aiding layer, a glare shielding layer, and an optical compensating layer. In such a case, if desired, it is possible to conduct various surface treatments such as a corona discharge treatment, a plasma treatment, or a chemical treatment.

<Transparent Conductive Layer>

In the film of the present invention, it is preferable to provide a transparent conductive layer, employing surface active agents or minute conductive particles. The film itself may be made to be conductive or a transparent conductive layer may be provided. In order to provide antistatic properties, it is preferable to provide a transparent conductive layer. It is possible to provide the transparent conductive layer employing methods such as a coating method, an atmospheric pressure plasma treatment, vacuum deposition, sputtering, or an ion plating method. Alternatively, by employing a co-extrusion method, a transparent conductive layer is prepared by incorporating minute conductive particles into the surface layer or only into the interior layer. The transparent conductive layer may be provided on one side of the film or on both sides. Minute conductive particles may be employed together with matting agents resulting in lubrication or may be employed as a matting agent.

Preferred as examples of metal oxides are ZnO, TiO₂, SnO₂, Al₂O₃, In₂O₃, SiO₂, MgO, BaO, MoO₂, and V₂O₅ or composite oxides thereof. Of these, Zn, TiO₂, and SnO₂ are particularly preferred. As an example of incorporating a different type of atom, it is effective that Al and In are added to ZnO, Nb and Ta are added to TiO₂, or Sb, Nb and halogen elements are added to SnO₂. The addition amount of these different types of atoms is preferably in the range of 0.01-25 mol percent, but is most preferably in the range of 0.1-15 mol percent.

Further, the volume resistivity of these conductive metal oxide powders is preferably at most 1×10⁷ Ωcm, but most preferably at most 1×10⁵ Ωcm. It is preferable that powders exhibiting the specified structure at a primary particle diameter of 100 ∈-0.2 μm, and a major diameter of higher order structure of 300 Å-6 μm is incorporated in the conductive layer at a volume ratio of 0.01-20 percent.

In the present invention, the transparent conductive layer may be formed in such a manner that minute conductive particles are dispersed into binders and provided on a substrate, or a substrate is subjected to a subbing treatment onto which minute conductive particles are applied.

Further, it is possible to incorporate the ionen conductive polymers represented by Formulas (I)-(V), described in paragraph 0038-0055 of JP-A No. 9-203810, and quaternary ammonium cationic polymers represented by Formula (1) or (2), described in paragraphs 0056-0145 of the above patent.

Further, to result in a matted surface and to improve layer quality, heat resistant agents, weather resistant agents, inorganic particles, water-soluble resins, and emulsions may be incorporated into the transparent conducive layer composed of metal oxides within the amount range which does not adversely affect the effects of the present invention.

Binders employed in the transparent conductive layer are not particularly limited as long as they exhibit film forming capability. Listed as binders may, for example, be proteins such as gelatin or casein; cellulose compounds such as carboxymethyl cellulose, hydroxyethyl cellulose, acetyl cellulose, diacetyl cellulose, or triacetyl cellulose; saccharides such as dextran, agar, sodium alginates, or starch derivatives; and synthetic polymers such as polyvinyl alcohol, polyvinyl acetate, polyacrylates, polymethacrylates, polystyrene, polyacrylamides, poly-N-vinylpyrrolidone, polyester, polyvinyl chloride, or polyacrylic acid.

Particularly preferred are gelatin (such as alkali process gelatin, acid process gelatin, oxygen decomposition gelatin, phthalated gelatin, or acetylated gelatin), acetyl cellulose, diacetyl cellulose, triacetyl cellulose, polyvinyl acetate, polyvinyl alcohol, butyl polyacrylate, polyacrylamide, and dextran.

<Antireflection Film>

It is preferable that a hard coatinging layer and an antireflection layer are provided on the surface of the optical film of the present invention to be an antireflection film.

Preferably employed as the hard coatinging layer is an actinic radiation curable resinous layer or heat curable resinous layer. The hard coatinging layer may be provided directly onto the support or on the other layer such as an antistatic layer or a subbing layer.

In cases in which an actinic radiation curable resinous layer is provided as a hard coatinging layer, it is preferable to incorporate actinic radiation curable resins which are subjected to curing by exposure to ultraviolet radiation.

In view of optical design, the refractive index of the hard coatinging layer is preferably in the range of 1.45-1.65. Further, in view of providing the antireflection film with sufficient durability, impact resistance, and appropriate flexibility, as well as economics during production, the thickness of the hard coatinging layer is preferably in the range of 1-20 μm, but is more preferably 1-20 μm.

The actinic radiation curable resinous layer, as described herein, refers to the layer incorporating, as a main component, resins which undergo crosslinking reaction via exposure to actinic radiation (“actinic radiation”, as described in the present invention, includes all electromagnetic waves such as electron beams, neutron beams, X-rays, alpha rays, ultraviolet rays, visible rays, or infrared rays) and are cured. Listed as actinic radiation curable resins are ultraviolet radiation curable resins and electron beam curable resins as representative ones. However, resins may be employed which are subjected to curing via exposure to radiation other than ultraviolet rays or electron beams. Listed as ultraviolet radiation curable resins may, for example, be ultraviolet radiation curable acryl urethane based resins, ultraviolet radiation curable polyester acrylate based resins, ultraviolet radiation curable epoxy acrylate based resins, ultraviolet curable polyol acrylate based resins, or ultraviolet radiation curable epoxy resins.

It is also possible to list ultraviolet radiation curable acryl urethane based resins, ultraviolet radiation curable polyester acrylate based resins, ultraviolet radiation curable epoxy acrylate resins, ultraviolet radiation curable polyol acrylate based resins, or ultraviolet radiation curable epoxy resins.

Further, it is possible to incorporate photoreaction initiators and photosensitizers. Specifically listed are acetophenone, benzophenone, hydroxybenzophenone, Michler's ketone, α-amiloxim ester, and thioxanthone, as well as derivatives thereof. Further, when photoreaction agents are employed in the synthesis of epoxy acrylate based resins, it is possible to employ sensitizers such as n-butylamine, triethylamine, and tri-n-butylphosphine. The content of photoreaction initiators or photosensitizers incorporated in an ultraviolet radiation curable resin composition, from which solvent components which volatilize after coating and drying are removed, is preferably 2.5-6 percent by weight with respect to the composition.

Resin monomers include, for example, as a monomer having one unsaturated double bond, common monomers such as methyl acrylate, ethyl acrylate, butyl acrylate, vinyl acetate, benzyl acrylate, cyclohexyl acrylate, or styrene. Further, listed as monomers having at least two unsaturated double bonds may be ethylene glycol diacrylate, propylene glycol diacrylate, divinylbenzene, 1,4-cyclohexane diacrylate, and 1,4-cyclohexyldimethyl acrylate, as well as trimethylolpropane triacrylate and pentaerythritolpropane acrylate, described above.

Further, UV absorbents may be incorporated in an ultraviolet radiation curable resin composition in the amount which does not hinder actinic radiation curing of the above ultraviolet radiation curable resin composition.

In order to enhance heat resistance of cured layers, antioxidants which do not retard actinic radiation curing reaction are selected and then employed. For example, listed may be hindered phenol derivatives, thiopropionic acid derivatives, and phosphite derivatives. Specific examples include 4,4′-thiobis(6-t-3-methylphenol), 4,4′-bytylidenebis(6-t-butyl-3-methylphenol), 1,3,5-tris(3,5-di-t-butyl-4-hydroxybenzyl)isocyanurate, 2,4,6-tris(3,5-di-t-butyl-4-hydroxybenzyl)mesitylene, and d-octadecyl-4-hydroxy-3,5-di-butylbenzyl phosphate.

Selected and employed as ultraviolet radiation curable resins may, for example, be ADEKA OPTOMER KR and BY Series such as KR-400, KR-410, KR-550, KR-566, KR-567, or BY-320B (all produced by Asahi Denka Kogyo Co., Ltd.); EIKOHARD such as A-101-KK, A-101-WS, C-302, C-410-N, C-501, M-101, M-102, T-102, D-102, NS-101, FT-102Q8, MAG-1-P20, AG-106, or M-101-C (all produced by Koei Chemical Industry Co., Ltd.); SEKABEAM such as PHC2210(S), PHCX-9 (K-3), PHC2213, DP-10, DP-20, DP-30, P1000, P1100, P1200, P1300, P1400, P1500, P1600, or SCR900 (all produced by Dainichi Seika Industry Co., Ltd.); KRM7033, KRM7039, KRM7130, KRM7131, UVECRYL29201, and UVECRYL29202 (all produced by Daicel UCB Co., Ltd.); RC-5015, RC-5016, RC-5020, RC-5031, RC-5100, RC-5102, RC-5120, RC-5122, RC-5152, RC-5171, RC-5180, and RC-5181 (all produced by Dainippon Ink & Chemicals Co., Ltd.); ORLEX No. 340 CLEAR (produced by Chugoku Paint Co., Ltd.); SUNRAD H-601 (produced by Sanyo Chemicla Industry Co., Ltd.); SP-1509 and SP-1507 (both produced by Showa Polymer Co., Ltd.); RCC-15C (produced by Grace Japan Co., Ltd.); ARONIX M-6100, M-8030, and M-8060 (all produced by Toa Gosei Co., Ltd.), as well as any other commercially available products.

In the coating compositions of the actinic radiation curable resinous layer, the solid concentration is preferably 10-95 percent by weight, and suitable concentration is selected based on coating methods.

Employed as a radiation source to form a cured layer via the actinic radiation curing reaction of actinic radiation curable resins may be any of the radiation sources which generate ultraviolet radiation. Practically, it is possible to employ the radiation sources described in the above radiation item. Exposure conditions vary depending on each of the lamps. Exposure amount is preferably in the range of 20-10,000 J/cm², but is more preferably in the range of 50-2,000 J/cm². From the near infrared region to the visible region, it is possible to use sensitizers which exhibit the maximum absorption in the above range.

Solvents which are employed during coating of the actinic radiation curable resinous layer are suitably selected, for example, from hydrocarbons (toluene and xylene); alcohols (methanol, ethanol, isopropanol, butanol, and cyclohexanol); ketones (acetone, methyl ethyl ketone, and methyl isobutyl ketone); ketone alcohols (diacetone alcohol); esters (methyl acetate, ethyl acetate, and methyl lactate); glycol ethers, and other organic solvents, and then employed. It is possible to blend these and to use the resulting mixture. It is preferable to employ the above solvents which incorporate propylene glycol monoalkyl ether (the number of carbon atoms of the alkyl group being 1-4) or propylene glycol monoalkyl ether acetate (the number of carbon atoms of the alkyl group being 1-4) in an amount of preferably at least 5 percent by weight or more preferably 5-80 percent by weight.

Employed as a coating method of an actinic radiation curable resinous composition coating liquid are prior art methods employing coaters such as a gravure coater, a spinner coater, a wire bar coater, a roller coater, a reverse coater, an extrusion coater, or an air-doctor coater. The coated amount is suitably 0.1-30 μm in terms of wet layer thickness, but is preferably 0.5-15 μm. The coating rate is preferably in the range of 10-60 m/minute.

The actinic radiation curable resinous composition is coated and subsequently dried, and then is exposed to ultraviolet radiation. Exposure time is preferably 0.5 second—5 minutes, but is more preferably 3 seconds—2 minutes in view of the curing efficiency of ultraviolet radiation curable resins and operation efficiency.

Thus, it is possible to obtain a cured coating layer. In order to provide glare shielding properties with the panel surface of liquid crystal display devices, to minimize adhesion to other substances, and to enhance abrasion resistance, it is possible to incorporate minute inorganic or organic particles into the curable layer coating composition.

For example, listed as minute inorganic particles may be those composed of silicon oxide, zirconium oxide, titanium oxide, aluminum oxide, tin oxide, zinc oxide, calcium carbonate, barium sulfate, talc, kaolin, and calcium sulfate.

Further listed as minute organic particles may be polymethacrylic acid methyl acrylate resin powder, acryl styrene based resinous powder, polymethyl methacrylate resinous powder, silicone based resinous powder, polystyrene based resinous powder, polycarbonate resinous powder, benzoguanamine based resinous powder, melamine based resinous powder, polyolefin based resinous powder, polyester based resinous powder, polyamide based resinous powder, polyimide based resinous powder, or fluorinated ethylene based resinous powder. It is possible to incorporate these into ultraviolet radiation curable resinous compositions and then to employ them. The average particle diameter of these minute particle powders is commonly 0.01-10 μm. The used amount is preferably 0.1-20 parts by weight with respect to 100 parts by weight of the ultraviolet radiation curable resin composition. In order to provide glare shielding properties, it is preferable that minute practices of an average particle diameter of 0.1-1 μm are employed in an amount of 1-15 parts by weight with respect to 100 pars by weight of the ultraviolet radiation curable resin composition.

By incorporating such minute particles into ultraviolet radiation curable resins, it is possible to form a glare shielding layer exhibiting the preferred unevenness of center line mean surface roughness Ra of 0.05-0.5 μm. Further, when the above minute particles are not incorporated into ultraviolet radiation curable resin compositions, it is possible to form a hard cost layer exhibiting the desired smooth surface of a center line means roughness Ra of less than 0.05 μm, but preferably 0.002-0.04 μm.

Other than these, as a material to result in a blocking prevention function, it is possible to employ microscopic particles of a volume average particle diameter of 0.005-0.1 mm which are the same components as above in an amount of 0.1-5 parts by weight with respect to 100 parts by weight of the resin composition.

Anantireflection layer is provided on the above hard coatinging layer. The providing methods are not particularly limited, and a common coating method, a sputtering method, a deposition method, CVD (chemical vapor deposition) method and an atmospheric pressure plasma method may be employed individually or in combination. In the present invention, it is particularly preferable to provide the antireflection layer employing a common coating method.

Listed as methods to form the antireflection layer via coating are a method in which metal oxide powder is dispersed into binder resins dissolved in solvents and the resulting dispersion is coated and subsequently dried, and a method in which ethylenic unsaturated monomers and photopolymerization initiators are incorporated and a layer is formed via exposure to actinic radiation.

In the present invention, it is possible to provide an antireflection layer on the cellulose ester film provided with an ultraviolet radiation curable resinous layer. In order to decrease reflectance, it is preferable to form a low refractive index layer on the uppermost layer of optical film and then to provide between them a metal oxide layer which is a high refractive index layer, and further to provide a medium refractive index layer (being a metal oxide layer of which refractive index has been controlled by varying the metal oxide content, the ratio to the resinous binders, or the kind of metal). The refractive index of the high refractive index layer is preferably 1.55-2.30, but is more preferably 1.57-2.20. The refractive index of the medium refractive index layer is controlled to the intermediate value between the refractive index (approximately 1.5) of cellulose ester film as a substrate and the refractive index of the high refractive index layer. The refractive index of the medium refractive index layer is preferably 1.55-1.80. The thickness of each layer is preferably 5 nm −0.5 μm, is more preferably 10 nm −0.3 μm but is most preferably 30 nm −0.2 μm. The haze of the metal oxide layer is preferably at most 5 percent, is more preferably at most 3 percent, but is most preferably at most 1 percent. The strength of the metal oxide layer is preferably at least 3H in terms of pencil strength of 1 kg load, but is most preferably at least 4H. In cases in which the metal oxide layer is formed employing a coating method, it is preferable that minute inorganic particles and binder polymers are incorporated.

It is preferable that the medium and high refractive index layers in the present invention are formed in such a manner that a liquid coating composition incorporating monomers or oligomers of organic titanium compounds represented by Formula (14) below, or hydrolyzed products thereof are coated and subsequently dried, and the resulting refractive index is 1.55-2.5.
Ti(OR¹)₄ Formula (14)
wherein R¹ is an aliphatic hydrocarbon group having 1-8 carbon atoms, but is preferably an aliphatic hydrocarbon group having 1-4 carbon atoms. Further, in monomers or oligomers of organic titanium compounds or hydrolyzed products thereof, the alkoxide group undergoes hydrolysis to form a crosslinking structure via reaction such as —Ti—O—Ti, whereby a cured layer is formed.

Listed as prefered examples of monomers and oligomers of organic titanium compounds employed in the present invention are dimers—decamers of Ti(OCH₃)₄, Ti(OC₂H₅)₄, Ti(O-n-C₃H₇)₄, Ti(O-i-C₃H₇)₄, Ti(O-n-C₄H₉)₄, and Ti(O-n-C₃H₇)₄, and dimers—decamers of Ti(O-n-C₄H₉)₄. These may be employed individually or in combinations of at least two types. Of these, particularly preferred are dimers—decamers of Ti(O-n-C₃H₇)₄, Ti(O-i-C₃H₇)₄, Ti(O-n-C₄H₉)₄, and Ti(O-n-C₃H₇)₄.

In the course of preparation of the medium and high refractive index layer liquid coating compositions in the present invention, it is preferable that the above organic titanium compounds are added to the solution into which water and organic solvents, described below, have been successively added. In cases in which water is added later, hydrolysis/polymerization is not uniformly performed, whereby cloudiness is generated or the layer strength is lowered. It is preferable that after adding water and organic solvents, the resulting mixture is vigorously stirred to enhance mixing and dissolution has been completed.

Further, an alternative method is employed. A preferred embodiment is that organic titanium compounds and organic solvents are blended, and the resulting mixed solution is added to the above solution which is prepared by stirring the mixture of water and organic solvents.

Further, the amount of water is preferably in the range of 0.25-3 mol per mol of the organic titanium compounds. When the amount of water is less than 0.25 mol, hydrolysis and polymerization are not sufficiently performed, whereby layer strength is lowered, while when it exceeds 3 mol, hydrolysis and polymerization are excessively performed, and coarse TiO₂ particles are formed to result in cloudiness. Accordingly, it is necessary to control the amount of water within the above range.

Further, the content of water is preferably less than 10 percent by weight with respect to the total liquid coating composition. When the content of water exceeds 10 percent by weight with respect to the total liquid coating composition, stability during standing of the liquid coating composition is degraded to result in cloudiness. Therefore, it is not preferable.

Organic solvents employed in the present invention are preferably water-compatible. Preferred as water-compatible solvents are, for example, alcohols (for example, methanol, ethanol, propanol, isopropanol, butanol, isobutanol, secondary butanol, tertiary butanol, pentanol, hexanol, cyclohexanol, and benzyl alcohol; polyhydric alcohols (for example, ethylene glycol, diethylene glycol, triethylene glycol, polyethylene glycol, propylene glycol, dipropylene glycol, polypropylene glycol, butylenes glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamthyldiethylenetriamine, and tetramethylpropylenediamine); amides (for example, formamide, N,N-dimethylfromamide, and N,N-dimethylacetamide); heterocycles (for example, 2-pyrrolidone, N-methyl-2-pyrrolidone, cyclohexylpyrrolidone, 2-oxazolidone, 1,3-dimethyl-2-imidazolidinone); and sulfoxides (for example, dimethylsulfoxide); sulfones (for example, sulfolane); as well as urea, acetonitrile, and acetone. Of these, particularly preferred are alcohols, polyhydric alcohols, and polyhydric alcohol ethers. As noted above, the used amount of these organic solvents may be controlled so that the content of water is less than 10 percent by weight with respect to the total liquid coating composition by controlling the total used amount of water and the organic solvents.

The content of monomers and oligomers of organic titanium compounds employed in the present invention, as well as hydrolyzed products thereof is preferably 50.0-98.0 percent by weight with respect to solids incorporated in the liquid coating composition. The solid ratio is more preferably 50-90 percent by weight, but is still more preferably55-90 percent by weight. Other than these, it is preferable to incorporate polymers of organic titanium compounds (which are subjected to hydrolysis followed by crosslinking) in a liquid coating composition, or to incorporate minute titanium oxide particles.

The high refractive index and medium refractive index layers in the present invention may incorporate metal oxide particles as minute particles and further may incorporate binder polymers.

In the above method of preparing liquid coating compositions, when hydrolyzed/polymerized organic titanium compounds and metal oxide particles are combined, both strongly adhere to each other, whereby it is possible to obtain a strong coating layer provided with hardness and uniform layer flexibility.

The refractive index of metal oxide particles employed in the high and medium refractive index layers is preferably 1.80-2.80, but is more preferably 1.90-2.80. The weight average diameter of the primary particle of metal oxide particles is preferably 1-150 nm, is more preferably 1-100 nm, but is most preferably 1-80 nm. The weight average diameter of metal oxide particles in the layer is preferably 1-200 nm, is more preferably 5-150 nm, is still more preferably 10-100 nm, but is most preferably 10-80 nm. Metal oxide particles at an average particle diameter of at least 20-30 nm are determined employing a light scattering method, while the particles at a diameter of at most 20-30 nm are determined employing electron microscope images. The specific surface area of metal oxide particles is preferably 10-400 m²/g as a value determined employing the BET method, is more preferably 20-200 m²/g, but is most preferably 30-150 m²/g.

Examples of metal oxide particles are metal oxides incorporating at least one element selected from the group consisting of Ti, Zr, Sn, Sb, Cu, Fe, Mn, Pb, Cd, As, Cr, Hg, Zn, Al, Mg, Si, P, and S. Specifically listed are titanium dioxide, (for example, rutile, rutile/anatase mixed crystals, anatase, and amorphous structures), tin oxide, indium oxide, zinc oxide, and zirconium oxide. Of these, titanium oxide, tin oxide, and indium oxide are particularly preferred. Metal oxide particles are composed of these metals as a main component of oxides and are capable of incorporating other metals. Main component, as described herein, refers to the component of which content (in percent by weight) is the maximum in the particle composing components. Listed as examples of other elements are Ti, Zr, Sn, Sb, Cu, Fe, Mn, Pb, Cd, As, Cr, Hg, Zn, Al, Mg, Si, P and S.

It is preferable that metal oxide particles are subjected to a surface treatment. It is possible to perform the surface treatment employing inorganic or organic compounds. Listed as examples of inorganic compounds used for the surface treatment are alumina, silica, zirconium oxide, and iron oxide. Of these, alumina and silica are preferred. Listed as examples of organic compounds used for the surface treatment are polyol, alkanolamine, stearic acid, silane coupling agents, and titanate coupling agents. Of these, silane coupling agents are most preferred.

Specific examples of silane coupling agents include methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-glycidyloxypropyltrimethoxysilane, γ-glycidyloxypropyltriethoxysilane, γ(β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyltrimethoxysilane, γ-methacryloyloxypropyltrimethoxysilane, γ-aminopropyltrimethoxysilane, γ-aminopropyltriethoxysilane, γ-mercaptopropyltriethoxysilane, N-β-(aminoethyl)-γ-aminopropyltrimethoxysilane, and β-cyanoethyltriethoxysilane.

Further, examples of silane coupling agents having an alkyl group of 2-substitution for silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxyprbpylphenyldiethoxysilane, γ-chloropropylmethyldiethoxysilane, dimethyldiacetoxysilane, γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylmethyldimethoxysilane, γ-aminopropyldiethoxysilane, methylvinyldimethoxysilane, and methylvinyldiethoxysilnae.

Of these, preferred are vinyltrimethoxysilane, vinyltriethoxysilane, vinylacetoxysilane, vinyltrimethoxethoxyysilane, γ-acryloyloxypropylmethoxysilane, and γ-methacryloyloxypropylmethoxysilane which have a double bond in the molecule, as well as γ-acryloyloxypropylmethyldimethoxysilane, γ-acryloyloxypropyldiethoxysilane, γ-methacryloyloxypropylmethyldimethoxysilane, γ-methacryloyloxypropylmethyldiethjoxysilane, methylvinyldimethoxysilane, and methylvinyldiethaoxysilane which have an alkyl group having γ-substitution to silicon.

Of these, particularly preferred are γ-acryloyloxypropyltrimethoxysilane, γ-methacryloyloxypropyltrimethoxysilane, γ-acryloyloxypropylmethyldimethoxysilane, γ-acryloyloxypropylmethyldiethoxysilane, γ-methacryloyloxypropylmethyldimethoxysilane, and γ-methacryloyloxypropylmethyldiethoxysilane.

At least two types of coupling agents may simultaneously be employed in addition to the above silane coupling agents, other silane coupling agents may be employed. Listed as other silane coupling agents are alkyl esters of ortho-silicic acid (for example, methyl orthosilicate, ethyl orthosilicate, n-propyl orthosilicate, i-propyl orthosilicate, n-butyl orthosilicate, sec-butyl orthosilicate, and t-butyl orthosilicate) and hydrolyzed products thereof.

It is possible to practice a surface treatment employing coupling agents in such a manner that coupling agents are added to a minute particle dispersion and the resulting dispersion is allowed to stand at room temperature—60° C. for several hours—10 days. In order to promote the surface treatment reaction, added to the above dispersion may be inorganic acids (for example, sulfuric acid, hydrochloric acid, nitric acid, chromic acid, hypochlorous acid, boric acid, orthosilicic acid, phosphoric acid, and carbonic acid), and organic acids (for example, acetic acid, polyacrylic acid, benzenesulfonic acid, phenol, and polyglutamic acid), or salts thereof (for example, metal salts and ammonium salts).

It is preferable that these coupling agents have been hydrolyzed employing water in a necessary amount. When the silane coupling agent is hydrolyzed, the resulting coupling agent easily react with the above organic titanium compounds and the surface of metal oxide particles, whereby a stronger layer is formed. Further, it is preferable to previously incorporate hydrolyzed silane coupling agents into a liquid coating composition. It is possible to use the water employed for hydrolysis to perform hydrolysis/polymerization of organic titanium compounds.

In the present invention, a treatment may be performed by combining at least two types of surface treatments. It is preferable that the shape of metal oxide particles is rice grain-shaped, spherical, cubic, spindle-shaped, or irregular. At least two types of metal oxide particles may be employed in the high refractive index layer and the medium refractive index layer.

The content of metal oxide particles in the high refractive index and medium refractive index layers is preferably 5-90 percent by weight, is more preferably 10-85 percent by weight, but is still more preferably 20-80 percent by weight. In cases in which minute particles are incorporated, the ratio of monomers or oligomers of the above organic titanium compounds or hydrolyzed products thereof is commonly 1-50 percent by weight with solids incorporated in the liquid coating composition, is preferably 1-40 percent by weight, but is more preferably 1-30 percent by weight.

The above metal oxide particles are dispersed into a medium and fed to liquid coasting compositions to form a high refractive index layer and a medium refractive index layer. Preferably employed as dispersion medium of metal oxide particles is a liquid at a boiling point of 60-170° C. Specific examples of dispersion media include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formatel propyl formate and butyl formate), aliphatic hydrocarbons (for example, hexane and cyclohexanone), halogenated hydrocarbons (for example, methylene chloride, chloroform, and carbon tetrachloride), aromatic hydrocarbons (for example, benzene, toluene, and xylene), amides (for example, dimethylformamide, diethylacetamide, and n-methylpyrrolidone), ethers (for example, diethyl ether, dioxane, and tetrahydrofuran), and ether alcohols (for example, 1-methoxy-2-propanol). Of these, particularly preferred are toluene, xylene, methyl ethyl ketone, methyl isobutyl ketone, cyclohexane and butanol.

Further, it is possible to disperse metal oxide particles into a medium employing a homogenizer. Listed as examples of homogenizers are a sand grinder mill (for example, a bead mill with pins), a high speed impeller mill, a pebble mill, a roller mill, an attritor, and a colloid mill. Of these, particularly preferred are the sand grinder and the high speed impeller mill. Preliminary dispersion may be performed. Listed as examples which are used for the preliminary dispersion are a ball mill, a three-roller mill, a kneader, and an extruder.

It is preferable to employ polymers having a crosslinking structure (hereinafter referred to as a crosslinking polymer) as a binder polymer in the high refractive index and medium refractive index layers. Listed as examples of the crosslinking polymers are crosslinking products (hereinafter referred to as polyolefin) such as polymers having a saturated hydrocarbon chain such as polyolefin, polyether, polyurea, polyurethane, polyester, polyamine, polyamide, or melamine resins. Of these, crosslinking products of polyolefin, polyether, and polyurethane are preferred, crosslinking products of polyolefin and polyether are more preferred, and crosslinking products of polyolefin are most preferred. Further, it is more preferable that crosslinking polymers have an anionic group. The anionic group exhibits a function to maintain the dispersion state of minute inorganic particles and the crosslinking structure exhibits a function to strengthen layers by providing a polymer with layer forming capability. The above anionic group may directly bond to a polymer chain or may bond to a polymer chain via a linking group. However, it is preferable that the anionic group bonds to the main chain via a linking group as a side chain.

Listed as examples of the anionic group are a carboxylic acid group (carboxyl), a sulfonic acid group (sulfo), and phosphoric acid group (phsphono). Of these, preferred are the sulfonic acid group and the phosphoric acid group. Herein, the anionic group may be in the form of its salts. Cations which form salts with the anionic group are preferably alkali metal ions. Further, protons of the anionic group may be dissociated. The linking group which bond the anionic group with a polymer chain is preferably a bivalent group selected from the group consisting of —CO—, —O—, an alkylene group, and an arylene group, and combinations thereof. Crosslinking polymers which are binder polymers are preferably copolymers having repeating units having an anionic group and repeating units having a crosslinking structure. In this case, the ratio of the repeating units having an anionic group in copolymers is preferably 2-96 percent by weight, is more preferably 4-94 percent by weight, but is most preferably 6-92 percent by weight. The repeating unit may have at least two anionic groups.

In crosslinking polymers having an anionic group, other repeating units (an anionic group is also a repeating unit having no crosslinking structure) may be incorporated. Preferred as other repeating units are repeating units having an amino group or a quaternary ammonium group and repeating units having a benzene ring. The amino group or quaternary ammonium group exhibits a function to maintain a dispersion state of minute inorganic particles. The benzene ring exhibits a function to increase the refractive index of the high refractive index layer. Incidentally, even though the amino group, quaternary ammonium group and benzene ring are incorporated in the repeating units having an anionic group and the repeating units having a crosslinking structure, identical effects are achieved.

In crosslinking polymers incorporating as a constituting unit the above repeating units having an amino group or a quaternary ammonium group, the amino group or quaternary ammonium group may directly bond to a polymer chain or may bond to a polymer chain via a side chain. But the latter is preferred. The amino group or quaternary ammonium group is preferably a secondary amino group, a tertiary amino group or a quaternary ammonium group, but is more preferably a tertiary amino group or a quaternary ammonium group. A group bonded to the nitrogen atom of a secondary amino group, a tertiary amino group or a quaternary ammonium group is preferably an alkyl group, is more preferably an alkyl group having 1-12 carbon atoms, but is still more preferably an alkyl group having 1-6 carbon atoms. The counter ion of the quaternary ammonium group is preferably a halide ion. The linking group which links an amino group or a quaternary ammonium group with a polymer chain is preferably a bivalent group selected from the group consisting of —CO—, —NH—, —O—, an alkylene group and an arylene group, or combinations thereof. In cases in which the crosslinking polymers incorporate repeating units having an amino group or an quaternary ammonium group, the ratio is preferably 0.06-32 percent by weight, is more preferably 0.08-30 percent by weight, but is most preferably 0.1-28 percent t by weight.

It is preferable that high and medium refractive index layer liquid coating compositions composed of monomers to form crosslinking polymers are prepared and crosslinking polymers are formed via polymerization reaction during or after coating of the above liquid coating compositions. Each layer is formed along with the formation of crosslinking polymers. Monomers having an anionic group function as a dispersing agent of minute inorganic particles in the liquid coating compositions. The used amount of monomers having an anionic group is preferably 1-50 percent by weight with respect to the minute inorganic particles, is more preferably 5-40 percent by weight, but is still more preferably 10-30 percent by weight. Further, monomers having an amino group or a quaternary ammonium group function as a dispersing aid in the liquid coating compositions. The used amount of monomers having an amino group or a quaternary ammonium group is preferably 3-33 percent by weight with respect to the monomers having an anionic group. By employing a method in which crosslinking polymers are formed during or after coating of a liquid coating composition, it is possible to allow these monomers to effectively function prior to coating of the liquid coating compositions.

Most preferred as monomers employed in the present invention are those having at least two ethylenic unsaturated groups. Listed as those examples are esters of polyhydric alcohols and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol (meth)acrylate, pentaerythritol hexa(meth)acrylate, 1,2,3-cyclohexane tetramethacrylate, polyurethane polyacrylate, and polyester polyacrylate); vinylbenzne and derivatives thereof (for example, 1,4-divinylbenzene, 4-vinyl-benzoic acid-2-acryloylethyl ester, and 1,4-divinylcyclohexane); vinylsulfones (for example, divinylsulfone); acrylamides (for example, methylenebisacrylamide); and methacrylamides. Commercially available monomers having an anionic group and monomers having an amino group or a quaternary ammonium group may be employed. Listed as commercially available monomers having an anionic group which are preferably employed are KAYAMAR PM-21 and PM-2 (both produced by Nihon Kayaku Co., Ltd.); ANTOX MS-60, MS-2N, and MS-NH4 (all produced by Nippon Nyukazai Co., Ltd.), ARONIX M-5000, M-6000, and M-8000 SERIES (all produced by Toagosei Chemical Industry Co., Ltd.); BISCOAT #2000 SERIES (produced by Osaka Organic Chemical Industry Ltd.); NEW FRONTIER GX-8289 (produced by Dai-ichi Kogyo Seiyaku Co., Ltd.); NK ESTER CB-1 and A-SA (produced by Shin-Nakamura Chemical Co., Ltd.); and AR-100, MR-100, and MR-200 (produced by Diahachi Chemical Industry Co., Ltd.). Listed as commercially available monomers having an amino group or a quaternary ammonium group which are preferably employed are DMAA (produced by Osaka Organic Chemical Industry Ltd.); DMAEA and DMAPAA (produced by Kojin Co., Ltd.); BLENMER QA (produced by NOF Corp.), and NEW FRONTIER C-1615 (produced by Dia-ichi Kogyo Seiyaku Co., Ltd.).

It is possible to perform polymer polymerization reaction employing a photopolymerization reaction or a thermal polymerization reaction. The photopolymerization reaction is particularly preferred. It is preferable to employ polymerization initiators to perform the polymerization reaction. For example, listed are thermal polymerization initiators and photopolymerization imitators described below which are employed to form binder polymers of the hard coatinging layer.

Employed as the polymerization initiators may be commercially available ones. In addition to the polymerization initiators, employed may be polymerization promoters. The added amount of polymerization initiators and polymerization promoters is preferably in the range of 0.2-10 percent by weight of the total monomers. Polymerization of monomers (or oligomers) may be promoted by heating a liquid coating composition (being an inorganic particle dispersion incorporating monomers). Further, after the photopolymerization reaction after coating, the resulting coating is heated whereby the formed polymer may undergo additional heat curing reaction.

It is preferable to use relatively high refractive index polymers in the medium and high refractive index layers. Listed as examples of polymers exhibiting a high refractive index are polystyrene, styrene copolymers, polycarbonates, melamine resins, phenol resins, epoxy resins, and urethanes which are obtained by allowing cyclic (alicyclic or aromatic) isocyanates to react with polyols. It is also possible to use polymers having another cyclic (aromatic, heterocyclic, and alicyclic) group and polymers having a halogen atom other than fluorine as a substituent due to their high refractive index.

Low refractive index layers usable in the present invention include a low refractive index layer which is formed by crosslinking of fluorine containing resins (hereinafter referred to as “fluorine containing resins prior to crosslinking) which undergo crosslinking by heat or ionizing radiation, a low refractive index layer prepared employing a sol-gel method, and a low refractive index layer composed of minute particles and binder polymers in which voids exist among minute particles or in the interior of the minute particle. In the present invention, preferred is the low refractive index layer mainly employing minute particles and binder polymers. The low refractive index layer having voids in the interior of the particle (also called the minute hollow particle) is preferred since it is possible to lower the refractive index. However, a decrease in the refractive index of the low refractive index layer is preferred due to an improvement ofantireflection performance, while it becomes difficult to provide desired strength. In view of the above compatibility, the refractive index of the low refractive index layer is preferably at most 1.45, is more preferably 1.30-1.50, is still more preferably 1.35-1.49, but is most preferably 1.35-1.45.

Further, the above preparation methods of the low refractive index layer may be suitably combined.

Preferably listed as fluorine containing resins prior to coating are fluorine containing copolymers which are formed employing fluorine containing vinyl monomers and crosslinking group providing monomers. Listed as specific examples of the above fluorine containing vinyl monomer units are fluoroolefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (for example, BISCOAT 6FM (produced by Osaka Organic Chemical Industry Ltd.) and M-2020 (produced by Daikin Industries, Ltd.), and completely or partially fluorinated vinyl ethers. Listed as monomers to provide a crosslinking group are vinyl monomers previously having a crosslinking functional group in the molecule, such as glycidyl methacrylate, vinyltrimethoxysilane, γ-methacryloyloxypropyltrimethoxysilane, or vinyl glycidyl ether, as well as vinyl monomers having a carboxyl group, a hydroxyl group, an amino group, or a sulfone group (for example, (meth)acrylic acid, methylol(meth)acrylate, hydroxyalkyl(meth)acrylate, allyl acrylate, hydroxyalkyl vinyl ether, and hydroxyalkyl allyl ether). JP-A Nos. 10-25388 and 10-147739 describe that a crosslinking structure is introduced into the latter by adding compounds having a group which reacts with the functional group in the polymer and at least one reacting group. Listed as examples of the crosslinking group are a acryloyl, methacryloyl, isocyanate, epoxy, aziridine, oxazoline, aldehyde, carbonyl, hydrazine, carboxyl, methylol or active methylene group. When fluorine containing polymers undergo thermal crosslinking due to the presence of a thermally reacting crosslinking group or the combinations of an ethylenic unsaturated group with thermal radical generating agents or an epoxy group with a heat generating agent, the above polymers are of a heat curable type. On the other hand, in cases in which crosslinking undergoes by exposure to radiation (preferably ultraviolet radiation and electron beams) employing combinations of an ethylenic unsaturated group with photo-radical generating agents or an epoxy group with photolytically acid generating agents, the polymers are of an ionizing radiation curable type.

Further, employed as a fluorine containing resins prior to coating may be fluorine containing copolymers which are prepared by employing the above monomers with fluorine containing vinyl monomers, and monomers other than monomers to provide a crosslinking group in addition to the above monomers. Monomers capable being simultaneously employed are not particularly limited. Those examples include olefins (ethylene, propylene, isoprene, vinyl chloride, and vinylidene chloride); acrylates(methyl acrylate, ethyl acrylate, and 2-ethylhexyl acrylate); methacrylates(methyl methacrylate, ethyl methacrylate, butyl methacrylate, and ethylene glycol dimethacrylate); styrene derivatives (styrene, divinylbenzene, vinyltoluene, and α-methylstyrene); vinyl ethers(methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives. Further, in order to provide desired lubricating properties and antistaining properties, it is also preferable to introduce a polyorganosiloxane skeleton or a perfluoropolyether skeleton into fluorine containing copolymers. The above introduction is performed, for example, by polymerization of the above monomers with polyorganosiloxane and perfluoroether having, at the end, an acryl group, a methacryl group, a vinyl ether group, or a styryl group and reaction of polyorganosiloxane and perfluoropolyether having a functional group.

The used ratio of each monomer to form the fluorine containing copolymers prior to coating is as follows. The ratio of fluorine containing vinyl monomers is preferably 20-70 mol percent, but is more preferably 40-70 mol percent; the ratio of monomers to provide a crosslinking group is preferably 1-20 mol percent, but is more preferably 5-20 mol percent, and the ratio of the other monomers simultaneously employed is preferably 10-70 mol percent, but is more preferably 10-50 mol percent.

It is possible to obtain the fluorine containing copolymers by polymerizing these monomers employing methods such as a solution polymerization method, a block polymerization method, an emulsion polymerization method or a suspension polymerization method.

The fluorine containing resins prior to coating are commercially available and it is possible to employ commercially available products. Listed as examples of the fluorine containing resins prior to coating are SAITOP (produced by Asahi Glass Co., Ltd.), TEFLON (a registered trade name) AD (produced by Du Pont), vinylidene polyfluoride, RUMIFRON (produced by Asahi Glass Co., Ltd.), and OPSTAR (produced by JSR).

The dynamic friction coefficient and contact angle to water of the low refractive index layer composed of crosslinked fluorine containing resins are in the range of 0.03-0.15 and in the range of 90-120 degrees, respectively.

In view of controlling the refractive index, it is preferable that the low refractive index layer composed of crosslinked fluorine containing resins incorporates minute inorganic particles described below. Further, it is preferable that minute inorganic particles are subjected to a surface treatment. Surface treatment methods include physical surface treatments such as a plasma discharge treatment and a corona discharge treatment, and a chemical surface treatment employing coupling agents. It is preferable to use the coupling agents. Preferably employed as coupling agents are organoalkoxy metal compounds (for example, a titanium coupling argent and a silane coupling agent). In cases in which minute inorganic particles are composed of silica, the treatment employing the silane coupling agent is are particularly effective.

Further, preferably employed as components for the low refractive index layer may be various types of sol-gel components. Preferably employed as such sol-gel components may be metal alcolates (being alcolates of silane, titanium, aluminum, or zirconium, and organoalkoxy metal compounds and hydrolysis products thereof. Particularly preferred are alkoxysilane, and hydrolysis products thereof. It is also preferable to use tetraalkoxysilane(tetramethoxysilane and tetraethoxysilane), alkyltrialkoxysilane(methyltrimethoxysilane, and ethyltrimethoxysilane), aryltrialkoxysilane(phenyltrimethoxysilane, dialkyldialkoxysilane, diaryldialkoxysilane. Further, it is also preferable to use organoalkoxysilanes having various type of functional group (vinyltrialkoxysilane, methylvinyldialkoxysilane, γ-glycidyloxypropyltrialkoxysilane, γ-glycidyloxyoropylmethyldialkoxysilane, β-(3,4)epoxycyclohexyl)ethyltrialkoxysilane, γ-merthacryloyloxypropyltrialkoxysilane, γ-aminopropyltrialkoxysilane, γ-mercaptopropyltrialkoxysilane, and γ-chloropropyltrialkoxysilane), perfluoroalkyl group containing silane compounds (for example, (heptadecafluoro1,1,2,2-tetradecyl)triethoxysilane, 3,3,3-trifluoropropyltrimethoxy silane). In view of decreasing the refractive index of the layer and providing water repellency and oil repellency, it is preferable to particularly use fluorine containing silane compounds.

As a low refractive index layer, it is preferable to employ a layer which is prepared in such a manner that minute inorganic or organic particles are employed and micro-voids are formed among minute particles or in the minute particle. The average diameter of the minute particles is preferably 0.5-200 nm, is more preferably 1-100 nm, but is most preferably 5-40 nm. Further, it is preferable that the particle diameter is as uniform (monodispersion) as possible.

Minute inorganic particles are preferably non-crystalline. The minute inorganic particles are preferably composed of metal oxides, nitrides, sulfides or halides, are more preferably composed of metal oxides or metal halides, but are most preferably composed of metal oxides or metal fluorides. Preferred as metal atoms are Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Ob and Ni. Of these, more preferred are Mg, Ca, B and Si. Inorganic compounds incorporating two types of metal may be employed. Specific examples of preferred inorganic compounds include SuO₂ or MgF₂, and SiO₂ is particularly preferred.

It is possible to form particles having micro-voids in the interior of an inorganic particle, for example, by crosslinking silica molecules. When silica molecules undergo crosslinking, the resulting volume decreases whereby a particle becomes porous. It is possible to directly synthesize micro-void containing (porous) inorganic particles as a dispersion, employing the sol-gel method (described in JP-A Nos. 53-112732 and 57-9051) and the deposition method (described in Applied Optics, Volume 27, page 3356 (1988)). Alternatively, it is also possible to obtain a dispersion in such a manner that powder prepared by a drying and precipitation method is mechanidally pulverized. Commercially available minute porous inorganic particles (for example, SiO₂ sol) may be employed.

In order to form a low refractive index layer, it is preferable that these minute inorganic particles are employed in the state dispersed in a suitable medium. Preferred as media are water, alcohol (for example, methanol, ethanol, and isopropyl alcohol), and ketone (for example, methyl ethyl ketone and methyl isobutyl ketone).

It is also preferable that minute organic particles are non-crystalline and are minute polymer particles which are synthesized by the polymerization reaction (for example, an emulsion polymerization method) of monomers. It is preferable that the polymers of minute organic particles incorporate fluorine atoms. The ratio of fluorine atoms in polymers is preferably 35-80 percent by weight, but is more preferably 45-75 percent by weight. Further, it is preferable that micro-voids are formed in the minute organic particle in such a manner that particle forming polymers undergo crosslinking so that a decrease in the volume forms micro-voids. In order that particle forming polymers undergo crosslinking, it is preferable that at least 20 mol percent of monomers to synthesize a polymer are multifunctional monomers. The ratio of the multifunctional monomers is more preferably 30-80 mol percent, but is most preferably 35-50 mol percent. Listed as examples of fluorine containing monomers employed to synthesize the above fluorine containing polymers are fluorolefins (for example, fluoroethylene, vinylidene fluoride, tetrafluoroethylene, hexafluoropropylene, and perfluoro-2,2-dimethyl-1,3-dioxol), as well as fluorinated alkyl esters of acrylic acid or methacrylic acid and fluorinated vinyl ethers. Copolymers of monomers with and without fluorine atoms may be employed. Listed as examples of monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, ethyl methacrylate and butyl methacrylate), styrenes (for example, styrene, vinyltoluene, and a-methylstyrene), vinyl ethers (for example, methyl vinyl ether), vinyl esters (for example, vinyl acetate and vinyl propionate), acrylamides (for example, N-tert-butylacrylamide and N-cyclohexylacrylamide), methacrylamides, and acrylonitriles. Listed as examples of multifunctional monomers are dienes (for example, butadiene and pentadiene), esters of polyhydric alcohol with acrylic acid (for example, ethylene glycol diacrylate, 1,4-cyclohexane diacrylate, and dipentaerythritol hexaacrylate), esters of polyhydric alcohol with methacrylic acid (for example, ethylene glycol dimethacrylate, 1,2,4-cyclohexane tetramethacrylate, and pentaerythritol tetramethacrylate), divinyl compounds (for example, divinylcyclohexane and 1,4-divinylbenzene), divinylsulfone, and bisacrylamides (for example, methylenebisacrylamide) and bismethacrylamides.

It is possible to form micro-voids among particles by piling at least two minute particles. Incidentally, when minute spherical particles (completely monodispersed) of an equal diameter are subjected to closest packing, micro-voids at a 26 percent void ratio by volume are formed among minute particles. When spherical particles of an equal diameter are subjected to simple cubic packing, micro-voids at 48 percent void ratio by volume are formed among minute particles. In a practical low refractive index layer, the void ratio significantly shifts from the theoretical value due to the distribution of diameter of the minute particles and the presence of voids in the particle. As the void ratio increases the refractive index of the low refractive index layer decreases. When micro-voids are formed by piling minute particles, it is possible to easily control the size of micro-voids among particles to an appropriate value (being a value minimizing scattering light and resulting in no problems of the strength of the low refractive index layer) by adjusting the diameter of minute particles. Further, by making the diameter of minute particles uniform, it is possible to obtain an optically uniform low refractive index layer of the uniform size of micro-voids among particles. By doing so, though the resulting low refractive index layer is microscopically a micro-void containing porous layer, optically or macroscopically, it is possible to make it a uniform layer. It is preferable that micro-voids among particles are confined in the low refractive index layer employing minute particles and polymers. Confined voids exhibits an advantage such that light scattering on the surface of a low refractive index layer is decreased compared to the voids which are not confined.

By forming micro-voids, the macroscopic refractive index of the low refractive index layer becomes lower than the total refractive index of the components constituting the low refractive index layer. The refractive index of a layer is the sum of the refractive indexes per volume of layer constituting components. The refractive index value of the constituting components such as minute particles or polymers of the low refractive index lay is larger than 1, while the refractive index of air is 1.00. Due to that, by forming micro-voids, it is possible to obtain a low refractive index layer exhibiting significantly lower refractive index.

Further, in the present invention, an embodiment is also preferred in which minute hollow SiO₂ particles are employed.

Minute hollow particles, as described in the present invention, refer to particles which have a particle wall, the interior of which is hollow. An example of such particles includes particles which are formed in such a manner that the above SiO₂ particles having voids in the interior of particles are further subjected to surface coating employing organic silicon compounds (being alkoxysilanes such as tetraethoxysilane) to close the pores. Alternatively, voids in the interior of the wall of the above particles may be filled with solvents or gases. For example, in the case of air, it is possible to significantly lower the refractive index (at 1.44-1.34) of minute hollow particles compared to common silica at a refractive index of 1.46). By adding such minute hollow SiO₂ particles, it is possible to further lower the refractive index of the low refractive index layer.

Making particles having micro-voids in the above minute inorganic particle hollow may be achieved based on the methods described in JP-A Nos. 2001-167637 and 2001-233611. Further, it is possible to use commercially available minute hollow SiO₂ particles. Listed as a specific example of commercially available particles is P-4 produced by Shokubai Kasei Kogyo Co.

It is preferable that the low refractive index layer incorporates polymers in an amount of 5-50 percent by weight. The above polymers exhibit functions such that minute particles are subjected to adhesion and the structure of the above low refractive index layer is maintained. The used amount of the polymers is controlled so that without filing voids, it is possible to maintain the strength of the low refractive index layer. The amount of the polymers is preferably 10-30 percent by weight of the total weight of the low refractive index layer. In order to achieve adhesion of minute particles employing polymers, it is preferable that (1) polymers are combined with surface processing agents of minute particles, (2) a polymer shell is formed around a minute particle used as a core, or (3) polymers are employed as a binder among minute particles. The polymers which are combined with the surface processing agents in (1) are preferably the shell polymers of (2) or binder polymers of (3). It is preferable that the polymers of (2) are formed around the minute particles employing a polymerization reaction prior to preparation of the low refractive index layer liquid coating composition. It is preferable that the polymers of (3) are formed employing a polymerization reaction during or after coating of the low refractive index layer while adding their monomers to the above low refractive index layer coating composition. It is preferable that at least two of (1), (2), and (3) or all are combined and employed. Of these, it is particularly preferable to practice the combination of (1) and (3) or the combination of (1), (2), and (3). (1) surface treatment, (2) shell, and (3) binder will now successively be described in that order.

(1) Surface Treatments

It is preferable that minute particles (especially, minute inorganic particles) are subjected to a surface treatment to improve affinity with polymers. These surface treatments are classified into a physical surface treatment such as a plasma discharge treatment or a corona discharge treatment and a chemical surface treatment employing coupling agents. It is preferable that the chemical surface treatment is only performed or the physical surface treatment and the chemical surface treatment are performed in combination. Preferably employed as coupling agents are organoalkoxymetal compounds (for example, titanium coupling agents and silane coupling agents). In cases in which minute particles are composed of SiO₂, it is possible to particularly effectively affect a surface treatment employing the silane coupling agents. As specific examples of the silane coupling agents, preferably employed are those listed above.

The surface treatment employing the coupling agents is achieved in such a manner that coupling agents are added to a minute particle dispersion and the resulting mixture is allowed to stand at room temperature—60° C. for several hours—10 days. In order to accelerate a surface treatment reaction, added to a dispersion may be inorganic acids (for example, sulfuric acid, hydrochloric acid, nitric acid, chromic acid, hypochloric acid, boric acid, orthosilicic acid, phosphoric acid, and carbonic acid), or salts thereof (for example, metal salts and ammonium salts).

(2) Shell

Shell forming polymers are preferably polymers having a saturated hydrocarbon as a main chain. Polymers incorporating fluorine atoms in the main chain or the side chain are preferred, while polymers incorporating fluorine atoms in the side chain are more preferred. Acrylates or methacrylates are preferred and esters of fluorine-substituted alcohol with polyacrylic acid or methacrylic acid are most preferred. The refractive index of shell polymers decreases as the content of fluorine atoms in the polymer increases. In order to lower the refractive index of a low refractive index layer, the shell polymers incorporate fluorine atoms in an amount of preferably 35-80 percent by weight, but more preferably 45-75 percent by weight. It is preferable that fluorine containing polymers are synthesized via the polymerization reaction of fluorine atom containing ethylenic unsaturated monomers. Listed as examples of fluorine atom containing ethylenic unsaturated monomers are fluorolefins (for example, fluoroethylene, vinylidene fluoride, tetrafluoroethylene, hexafluoropropylene, perfluoro-2,-dimethyl-1,3-dixol), fluorinated vinyl ethers and esters of fluorine substituted alcohol with acrylic acid or methacrylic acid.

Polymers to form the shell may be copolymers having repeating units with and without fluorine atoms. It is preferable that the units without fluorine atoms are prepared employing the polymerization reaction of ethylenic unsaturated monomers without fluorine atoms. Listed as examples of ethylenic unsaturated monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, butyl methacrylate, and ethylene glycol dimethacrylate), styrenes and derivatives thereof (for example, styrene, divinylbenzene, vinyltoluene, and a-methylstyrene), vinyl ethers (for example, methyl vinyl ether), vinyl esters (for example, vinyl acetate, vinyl propionate, and vinyl cinnamate), acrylamides (for example, N-tetrabutylacrylamide and N-cyclohexylacrylamide), as well as methacrylamide and acrylonitrile.

In the case of (3) in which binder polymers described below are simultaneously used, a crosslinking functional group may be introduced into shell polymers and the shell polymers and binder polymers are chemically bonded via crosslinking. Shell polymers may be crystalline. When the glass transition temperature (Tg) of the shell polymer is higher than the temperate during the formation of a low refractive index layer, micro-voids in the low refractive index layer are easily maintained. However, when Tg is higher than the temperature during formation of the low refractive index layer, minute particles are not fused and occasionally, the resulting low refractive index layer is not formed as a continuous layer (resulting in a decrease in strength). In such a case, it is desirous that the low refractive index layer is formed as a continuous layer simultaneously employing the binder polymers of (3). A polymer shell is formed around the minute particle, whereby a minute core/shell particle is obtained. A core composed of a minute inorganic particle is incorporated preferably 5-90 percent by volume in the minute core/shell particle, but more preferably 15-80 percent by volume. At least two types of minute core/shell particle may be simultaneously employed. Further, inorganic particles without a shell and core/shell particles may be simultaneously employed.

(3) Binders

Binder polymers are preferably polymers having saturated hydrocarbon or polyether as a main chain, but is more preferably polymers having saturated hydrocarbon as a main chain. The above binder polymers are subjected to crosslinking. It is preferable that the polymers having saturated hydrocarbon as a main chain is prepared employing a polymerization reaction of ethylenic unsaturated monomers. In order to prepare crosslinked binder polymers, it is preferable to employ monomers having at least two ethylenic unsaturated groups. Listed as examples of monomers having at least two ethylenic unsaturated groups are esters of polyhydric alcohol with (meth)acrylic acid (for example, ethylene glycol di(meth)acrylate, 1,4-dicyclohexane diacrylate, pentaerythritol tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides. It is preferable that polymers having polyether as a main chain are synthesized employing a ring opening polymerization reaction. A crosslinking structure may be introduced into binder polymers employing a reaction of crosslinking group instead of or in addition to monomers having at least two ethylenic unsaturated groups. Listed as examples of the crosslinking functional groups are an isocyanate group, an epoxy group, an aziridine group, an oxazoline group, an aldehyde group, a carbonyl group, a hydrazine group, a carboxyl group, a methylol group, and an active methylene group. It is possible to use, as a monomer to introduce a crosslinking structure, vinylsulfonic acid, acid anhydrides, cyanoacrylate derivatives, melamine, ether modified methylol, esters and urethane. Functional groups such as a block isocyanate group, which exhibit crosslinking properties as a result of the decomposition reaction, may be employed. The crosslinking groups are not limited to the above compounds and include those which become reactive as a result of decomposition of the above functional group. Employed as polymerization initiators used for the polymerization reaction and crosslinking reaction of binder polymers are heat polymerization initiators and photopolymerization initiators, but the photopolymerization initiators are more preferred. Examples of photopolymerization initiators include acetophenones, benzoins, benzophenones, phosphine oxides, ketals, antharaquinones, thioxanthones, azo compounds, peroxides, 2,3-dialkyldiones, disulfide compounds, fluoroamine compounds, and aromatic sulfoniums. Examples of acetophenones include 2,2-diethoxyacetophenone, p-dimethylacetophenone, 1-hydroxydimethyl phenyl ketone, 1-dihydroxycyclohexyl phenyl ketone, 2-methyl-4-methylthio-2-morpholinopropiophene, and 2-benzyl-2-dimethylamino-1-(4-morpholinophenyl)-butanone. Examples of benzoins include benzoin ethyl ether and benzoin isopropyl ether. Examples of benzophenones include benzophenone, 2,4-dichlorobenzophenone, 4,4-dichlorobenzophenone, and p-chlorobenzophenone. An example of phosphine oxides includes 2,4,6-trimethylbenzoyldiphenylphosphine oxide.

It is preferable that binder polymers are formed in such a manner that monomers are added to a low refractive index layer liquid coating composition and the binder polymers are formed during or after coating of the low refractive index layer utilizing a polymerization reaction (if desired, further crosslinking reaction). A small amount of polymers (for example, polyvinyl alcohol, polyoxyethylene, polymethyl methacrylate, polymethyl acrylate, diacetyl cellulose, triacetyl cellulose, nitrocellulose, polyester, and alkyd resins) may be added to the low refractive index layer liquid coating composition.

Further, it is preferable to add slipping agents to the low refractive index layer or other refractive index layers. By providing desired slipping properties, it is possible to improve abrasion resistance. Preferably employed as slipping agents are silicone oil and wax materials. For example, preferred are the compounds represented by the formula below.
R₁COR₂ Formula

In the above formula, R₁ represents a saturated or unsaturated aliphatic hydrocarbon group hang at least 12 carbon atoms, while R₁ is preferably an alkyl group or an alkenyl group but is more preferably an alkyl group or an alkenyl group having at least 16 carbon atoms. R₂ represents —OM₁ group (M₁ represents an alkaline metal such as Na or K), —OH group, —NH₂ group, or —OR₃ group (R₃ represents a saturated or unsaturated aliphatic hydrocarbon group having at least 12 carbon atoms and is preferably an alkyl group or an alkenyl group). R₂ is preferably —OH group, —NH₂ group or —OR₃ group. In practice, preferably employed may be higher fatty acids or derivatives thereof such as behenic acid, stearic acid amide, or pentacosanoic acid or derivatives thereof and natural products such as carnauba wax, beeswax, or montan wax, which incorporate a large amount of such components. Further listed may be polyorganosiloxane disclosed in Japanese Patent Publication No. 53-292, higher fatty acid amides discloses in U.S. Pat. No. 4,275.146, higher fatty acid esters (esters of a fatty acid having 10-24 carbon atoms and alcohol having 10-24 carbon atoms) disclosed in Japanese Patent Publication No. 58-35341, British Patent No. 927,446, or JP-A Nos. 55-126238 and 58-9o633, higher fatty acid metal salts disclosed in U.S. Pat. No. 3,933,516, polyester compounds composed of dicarboxylic acid having at least 10 carbon atoms and aliphatic or alicyclic diol disclosed in JP-A No. 51-37217, and oligopolyesters composed of dicarboxylic acid and diol disclosed in JP-A No. 7-13292.

For example, the added amount of slipping agents employed in the low refractive index layer is preferably 0.01-10 mg/m₂.

Added to each of the antireflection layers or the liquid coating compositions thereof may be polymerization inhibitors, leveling agents, thickeners, anti-coloring agents, UV absorbents, silane coupling agents, antistatic agents, and adhesion providing agents, other than metal oxide particles, polymers, dispersion media, polymerization initiators, and polymerization accelerators.

It is possible to form each layer of the antireflection films employing coating methods such as a dip coating method, an air-knife coating method, a curtain coating method, a roller coating method, a wire bar coating method, a gravure coating method, or an extrusion coating method (U.S. Pat No. 2,681,294). At least two layers may be simultaneously coated. Simultaneous coating methods are described in U.S. Pat. Nos. 2,761,791, 2,941,898, 3,508,947, and 3,526,528, as well as Yuji Harazaki, Coating Kogaku (Coating Engineering), page 253, Asakura Shoten (1973).

In the present invention, in the production of an antireflection film, after applying the above liquid coating composition onto a support, drying is performed preferably at 60° C. or higher, but more preferably at 80° C. or higher. Further, drying is performed preferably at a dew point of 20° C. or lower, but is more preferably at a dew point of 15° C. or lower. It is preferable that drying is initiated within 10 seconds after coating onto a support. Combining the above conditions results in the preferred production method to achieve the effects of the present invention.

As noted above, the optical film of the present invention is preferably employed as an antireflection film, a hard coating film, a glare shielding film, a phase different film, an antistatic film, and a luminance enhancing film.

(Polarizing Plates)

The polarizing plates of the present invention will be described.

It is possible to prepare the polarizing plates employing common methods. It is preferable that the reverse side of the cellulose ester film of the present invention is subjected to an alkali saponification treatment and the resulting cellulose ester film is adhered, employing an aqueous completely-saponified polyvinyl alcohol solution, to at least one surface of a polarizing film which has been prepared by being immersed into an iodine solution and subsequently being stretched. The cellulose ester film of the present invention or another polarizing plate protective film may be employed on the other surface. Employed as a polarizing plate protective film employed on the other surface, instead of the cellulose ester film of the present invention, may be commercially available cellulose ester film. For example, preferably employed as commercially available cellulose ester films are KC8UX2M, KC4UX, KC5Ux, KC4Uy, KC8Uy, KC12UR, KV8UCR-3, and KC8UCR-4 (all produced by Konica Minolta Opt, Inc.). Alternatively, it is preferable to use a polarizing plate protective film, also functioning as an optical compensating film having an optical anisotropic layer, which is prepared by orienting liquid crystal compounds such as a discotic liquid crystal, a rod-shaped liquid crystal, or a cholesteric liquid crystal. It is possible to form the optical anisotropic layer employing the method described in JP-A No. 2003-98348. By employing the combination of the antireflection film of the present invention, it is possible to obtain polarizing plates which exhibit excellent flatness and viewing angle increasing effects.

The polarizing film which is a major constituting component of polarizing plates, as described herein, refers to the element which only transmits the light of a polarized wave in the definite direction. The representative polarizing film, which is presently known, is a polyvinyl alcohol based polarizing film which is classified to one prepared by dying polyvinyl alcohol based film with iodine and the other prepared by dying the same with dichroic dyes. The polarizing film is prepared in such a manner that an aqueous polyvinyl alcohol solution is cast and the resulting cast film is subjected to uniaxial orientation and dying, or is subjected to dying and uniaxial orientation and subsequently to a durability treatment employing preferably boron compounds. One side of the cellulose ester film of the present invention is adhered to the surface of the above polarizing film, whereby a polarizing plate is formed. Adhesion is performed employing preferably water based adhesives employing completely-saponified polyvinyl alcohol as a major component.

A polarizing film is subjected to uniaxial orientation (commonly in the longitudinal direction). When a polarizing plate is allowed to stand at high temperature and high humidity, the length in the orientation direction (commonly in the longitudinal direction) decreases, while the length in the perpendicular direction (commonly the width direction) increases. As the thickness of a polarizing plate protective film decreases, elongation and shrinkage ratio increases, while a degree of contraction in the orientation direction of the polarizing film particularly increases. Generally, adhesion of a polarizing film to a polarizing plate protective film so that the orientation direction of the polarizing film is at the fright angles to the casting direction (being the MD direction) of the polarizing plate protective layer. Consequently, it is critical that when the thickness of the polarizing plate protective film decreases, it is important that elongation and shrinkage ratio in the casting direction exhibit no significant change. The optical film of the present invention is suitably applied to such a polarizing plate protective film due to excellent dimensional stability.

Namely, in a durability test at 60° C. and 90% RH, wavy unevenness does not increase. After the durability test, the polarizing plate having an optical compensating film on the reverse side results in no variation of viewing angle characteristics whereby it is possible to provide excellent visibility.

It is possible to constitute a polarizing plate further by adhering a protect film onto one side of the polarizing plate and a separate film onto the opposite side. The protect film and separate film are employed to protect the polarizing plate at its shipping and product inspection. In this case, the protect film is adhereed to protect the surface of the polarizing plate and is employed on the side opposite the side to adhere the polarizing plate to a liquid crystal plate. Further, the separate film is employed to cover the adhesion layer to adhere to the liquid crystal plate and is employed on the side to adhere the polarizing plate to a liquid-cell.

(Display Devices)

By incorporating the polarizing plate of the present invention into a display device, it is possible to prepare the various display devices of the present invention, which exhibit excellent visibility. The antireflection film of the present invention is preferably employed in a reflection type, transmission type, and a semi-transmission type LCD or LCD of various driving systems such as a TN type, an STN type, an OCB type an HAN type, a VA type (a PVA type and an MVA type), and an IPS type. Further, the cellulose ester film of the present invention exhibits excellent flatness and is employed to various display devices such as a plasma display, a field emission display, an organic EL display, an inorganic EL display, an electrons paper. Particularly, in a large image screen display device, uneven color and wavy unevenness were minimized, resulting in effects of minimal eye fatigue even for viewing of an extended period.

### EXAMPLES

The present invention will now be described with reference to examples, however the present invention is not limited thereto.

Initially are described determination methods and components.

(Retardation Ro and Rt)

A film sample was allowed to stand at 23° C. and 55% RH for 24 hours. The retardation of the resulting film sample at a wavelength of 590 nm was determined at the same ambience as above employing automatic birefringence meter KOBURA-21ADH (produced by Oji Keisoku Co.). The average refractive index of film constituting materials determined employing an Abbe refractometer and film thickness d were inputted and in-plane retardation (Ro) and thickness direction retardation (Rt) were obtained. Further, by employing the above instrument, three dimensional refractive indexes nx, ny, and nz were, calculated.
Ro=(nx−ny)×d Formula (I)
Rt={(nx+ny)/2−nz}×d Formula (II)
wherein nx represents the refractive index in the delayed phase axis direction in the plane, ny represents the refractive index of the advanced phase axis direction in the plane, nz represents the refractive index of the film in the thickness direction, and d represents the thickness of the film.
(Haze)

Determination was performed employing a haze meter (T-2600DA, produced by Tokyo Denshoku Kogyo Co., Ltd).

(Components)

<Cellulose Resin: 90 Parts by Weight>

Cellulose Resin 1: triacetylcellulose at a degree of substitution of the acetyl group of 2.95 and a residual content (as a sulfur element) of sulfuric acid of 16 ppm)
Cellulose Resin 2: cellulose acetate propionate at a degree of substitution of the propionyl group of 0.65 and a residual content (as a sulfur element) of sulfuric acid of 50 ppm)
Cellulose Resin 3: cellulose acetate propionate at a degree of substitution of the acetyl group of 1.90 and the propionyl group of 0.70 and a residual content (as a sulfur element) of sulfuric acid of 25 ppm)
Cellulose Resin 4: cellulose acetate propionate at a degree of substitution of the acetyl group of 2.10 and the propionyl group of 0.70 and a residual content (as a sulfur element) of sulfuric acid of 45 ppm)

Cellulose Resin 5: cellulose acetate butyrate at a degree of substitution of the acetyl group of 2.0 and the butyryl group of 0.70 and a residual content (as a sulfur element) of sulfuric acid of 12

<Plasticizers>

| | |
|---|---|
| Plasticizer 1: trimethylolpropane | 10 parts by Weight |
| tribenzoate | |
| Plasticizer 2: triphenyl phosphate | 10 parts by weight |
| Plasticizer 3: Polyester Based Plasticizer | 10 parts by weight |
| Sample 3 (being an ester sample having | |
| an aromatic end) | |
| Plasticizer 4: citrate ester plasticizer, | 10 parts by weight |
| Compound PL-11 described in JP-A No. | |
| 2002-62430 | |
| Plasticizer 5: Compound 1, phthalate ester | 10 parts by weight |
| based plasticizer | |

Compound 1

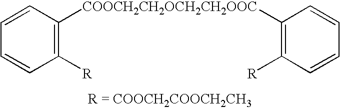

<UV absorbents>

| | | |
|---|---|---|
| UV-1: | Tinuvin 109 (at a weight average | 2 parts by weight |
| | molecular weight of 486 and a molar | |
| | absorption coefficient of 6780, | |
| | produced by Ciba Specialty Chemicals | |
| | Co., Ltd.) | |
| UV-2: | Polymer UV Agent P-1 synthesized | 2 parts by weight |
| | as below | |
| UV-3: | Polymer UV Agent P-2 synthesized | 2 parts by weight |
| | as below | |

### Synthesis Example of Polymer UV Agent P-1

Exemplified Compound MUV-19, 2(2′-hydroxy-5′-t-butyl-phenyl)-5-carboxylic acid -(2-methacryloyloxy)ethylester-2H-benzotriazol was synthesized based on the method described below.

Dissolved in 160 ml of water was 20.0 g of 3-nitro-4-amino-benzoic acid followed by the addition of 43 ml of concentrated hydrochloric acid. After adding 8.0 g of sodium nitrite which was dissolved in 20 ml of water to the above solution at 20° C., the resulting mixture was stirred for two hours while maintained at 0° C. Into the resulting solution dripped was a solution prepared by dissolving 17.3 g of 4-t-butylphenol in 50 ml of water and 100 ml of methanol at 0° C. while maintained to be alkaline employing potassium carbonate. The resulting solution was stirred at 0° C. for one hour and stirred at room temperature for an additional one hour. The reaction liquid composition was acidified by the addition of hydrochloric acid. The formed precipitates were collected via filtration and were well washed with water.

The precipitates collected by filtration were dissolved in 500 ml of a 1 mol/L aqueous NaOH solution. After adding 35 g of zinc powder to the-resulting solution, 110 g of a 40 percent aqueous NaOH solution was dripped. After dripping, stirring was performed for approximately two hours. The resulting mixture was filtered and washed with water. The resulting filtrate was neutralized by the addition of hydrochloric acid. Deposited precipitates were collected by filtration, washed with water and dried. Thereafter recrystallization was performed employing a mixed solvent of ethyl acetate and acetone, whereby 2(2′-hydroxy-5′-t-butyl-phenyl)-5-carboxylic acid -2H-benzotriazole was obtained.

Subsequently added to 100 ml of toluene were 10.0 g of 2(2′-hydroxy-5′-t-butyl-phenyl)-5-carboxylic acid-2H-benzotriazole, 0.1 g of hydroquinone, 4.6 g of 2-hydroxyethyl methacrylate, and 0.5 g of p-toluenesulfonic acid, the resulting mixture underwent thermal refluxing for 10 hours in a reaction vessel fitted with an ester tube. The reaction solution was poured to water, and deposited crystals were collected via filtration, washed with water, dried, and recrystallized employing ethyl acetate, whereby 2(2′-hydroxy-5′-t-butyl-phenyl)-5-carboxylic acid-(2-methacryloyloxy)ethylester-2H-benzotriazole which was Exemplified Compound MUV-19 was obtained.

Subsequently, the copolymer (Polymer UV Agent P-1) of 2(2′-hydroxy-5′-t-butyl-phenyl)-carboxylic acid-(2-methacryloyloxy)ethylester-2H-benzotriazole with methyl methacrylate was synthesized employing the method described below.

Added to 80 ml of tetrahydrofuran were 4.0 g of 2(2′-hydroxy-5′-t-butyl-phenyl)-5-carboxylic acid-(2-methacryloyloxy)ethylester-2H-benzotriazole, which was synthesized in above Synthesis Example 3, and 6.0 g of methyl methacrylate, and then 1.14 g of azoisobutyronitrile. The resulting mixture underwent thermal refluxing in an ambience of nitrogen for 6 hours. After distilling out tetrahydrofuran under vacuum, the resulting products were re-dissolved in 20 ml of tetrahydrofuran, and the resulting solution was dripped into an excessive amount of methanol. The deposited precipitates were collected via filtration and was dried under vacuum at 40° C., whereby 9.1 g of Polymer UV Agent P-1 in the form of gray powders. It was confirmed that the weight average molecular weight of the resulting copolymer was 9,000, employing GPC analysis in which the standard polystyrene was used as a standard. Further, the molar absorption coefficient of the monomer component at 380 nm was 7,320.

The above copolymer was identified as a copolymer of 2(2′-hydoxy-5′-t-butyl-phenyl)-5-carbocylic acid-(2-methacryloyloxy)ethylester-2H-benzotriazol with methyl methacrylate, based on NMR spectra and UV spectra. The composition of the above copolymer was that 2(2′-hydoxy-5′-t-butyl-phenyl)-5-carbocylic acid-(2-methacryloyloxy)ethylester-2H-benzotriazol methyl methacrylate was nearly 40:60.

### Synthesis Example of Polymer UV Agent P-2

Polymer UV Agent P-2 was synthesized in the same manner as above Polymer UV Agent P-1, excerpt that 6.0 g of methyl methacrylate was replaced with 5.0 g of a mixture of methyl methacrylate and 1.0 g of hydroxyethyl methacrylate. The weight average molecular weight of Polymer UV Agent P-2 was 9,000, while the molar absorption coefficient of the monomer component at 380 nm was 7320.

The composition of the above copolymer was that 2(2′-hydoxy-5′-t-butyl-phenyl)-5-carbocylic acid-(2-methacryloyloxy)ethylester-2H-benzotriazol:methyl methacrylate:hydroxyethyl methacrylate was nearly 40:50 10.

| | |
|---|---|
| UV-4: RUVA-100 (at a weight average molecular | 1 part by weight |
| weight of 494.5 and a molar absorption | |
| coefficient at 380 nm of 4,340, | |
| produced by Otsuka Chemical Co., Ltd.) | |
| 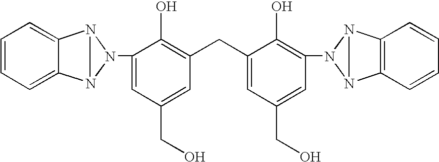 | |
| UV-5: LA-31 (at a weight average molecular | 1.6 parts by weight |
| weight of 658.9 and a molar absorption | |
| coefficient at 380 nm of 8,250, | |
| produced by Asahi Denka Kogyo Co., Ltd.) | |
| 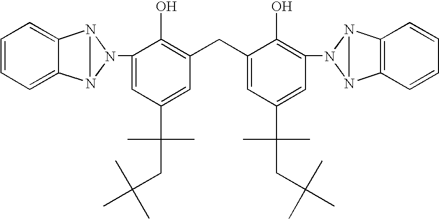 | |
| UV-6: PUVA-30M (at a weight average molecular | 2 parts by weight |
| weight of 9,000 and a molar absorption | |
| coefficient at 380 nm of 600, copolymer of | |
| 3-(2H-1,2,3-benzotriazole-2-yl)-4hydroxyphenetyl | |
| methacrylate and methyl methacrylate at a | |
| composition ratio of 30:70, produced by Otsuka | |
| Chemical Co., Ltd.) | |

Further, in cases in which two types of UV absorbents are simultaneously employed, the total added amount was controlled to two parts by weight and the simultaneously employed amount ratio was controlled to be 1:1 (In Table 1, 2/3 means that UV-2 and UV-3 were simultaneously employed, and the above description is applied to 2/4, 3/5, 4/5, or 5/6).

<Additives>

| | | |
|---|---|---|
| Additive 1: | IRGANOX 1010 (produced | 0.2 part by weight |
| | by Ciba Specialty Chemicals Co., | |
| | Ltd.) | |
| Additive 2: | Epoxidized Tall Oil | 0.2 part by weight |
| | (acid capturing agent) | |
| Additive 3: | HALS-1 | 0.2 part by weight |
| Additive 4: | Rod-shaped compound | 1 part by weight |
| | (Exemplified Compound (10) | |
| | 1-trans | |

### Example 1

(Preparation of Optical Films 1-29)

The aforesaid cellulose resins were subjected to a heat treatment at 120° C. for one hour in dry air and were allowed to stand in the dry air to cool to room temperature. Under the constitution in Table 1, plasticizers and additives in the amount described above were added to 90 parts by weight of the dried cellulose resins, and the resulting mixture was blended employing a Henschel mixer. Thereafter, pellets were produced employing an extruder while heated and the resulting pellets were allowed to stand to cool.

After drying at 120° C., pellets were thermally melted at the melting temperature described in Table 1, employing an extruder, and the melt was immediately extruded and cast employing a T type die. The cast film heated at 158° C. via a take-up roller was stretched 1.05 times in the longitudinal direction, subsequently stretched 1.2 times in the width direction employing a tenter, and was subjected to relaxation. While cooling, both edge portions across the width were removed by slitting and the resulting film was cooled to room temperature. Thereafter, both edge portions were subjected to knurling at a height of 10 μm and a width of 1.5 cm, and the resulting film was wound, whereby Optical Film 1 at a thickness of 80 μm, Ro of 5 nm and Rt of 60 nm was obtained in the form of a roll.

Optical Films 2-29 were prepared in the same manner as Optical Film 1, except that each of the compositions and the melt temperature was changed as described in Table 1. Ro and Rt of Polarizing Plate Protective Films 2-17 and 19-29 were 4-5 nm and 55-65 nm, respectively. Optical Film 18 was stretched 1.2 times in the longitudinal direction at the same temperature and subsequently was stretched 1.4 times in the width direction employing a tenter, resulting in Ro of 55 nm and Rt of 130 nm.

(Evaluation)

The haze and uneven whitening of the prepared optical films were evaluated as described above.

<Determination of Haze>

The haze of a film sample sheet was determined based on ASTM-D1003-52, employing T-2600DA, produced by Tokyo Denshoku Kogyo Co., Ltd. and evaluated based on the rank of haze classified as below.
A: haze was less than 0.1 percent
B: haze was 0.1-0.5 percent
C: haze was 0.5-1 percent
D: haze was at least 1 percent
   <White Unevenness>
A: no white unevenness was noted
B: weak white unevenness was noted
C: weak white unevenness was noted on the entire surface
D: white unevenness was easily noted

Table 1 show the results.

TABLE 1

| Optical | Cellulose | Plasticizer | UV Absorbent | Additive | Melt Temperature | | White | |
|---|---|---|---|---|---|---|---|---|
| Film No. | Resin No. | No. | No. | No. | (° C.) | Haze | Unevenness | Remarks |
| 1 | 1 | 1 | UV-1 | — | 230 | D | D | Comp. |
| 2 | 1 | 1 | UV-2 | — | 230 | C | C | Comp. |
| 3 | 1 | 2 | UV-3 | — | 230 | D | D | Comp. |
| 4 | 2 | 1 | UV-1 | — | 230 | D | C | Comp. |
| 5 | 2 | 2 | UV-2 | 1 | 230 | C | D | Comp. |
| 6 | 3 | 1 | UV-1 | 1 | 230 | C | C | Comp. |
| 7 | 3 | 1 | UV-2 | 1 | 230 | A | A | Inv. |
| 8 | 3 | 1 | UV-3 | 1 | 230 | A | A | Inv. |
| 9 | 3 | 1 | UV-2/3 | 1 | 230 | A | A | Inv. |
| 10 | 3 | 2 | UV-2 | 1, 2 | 230 | B | B | Inv. |
| 11 | 3 | 1 | UV-2 | 2 | 230 | A | A | Inv. |
| 12 | 3 | 1 | UV-2 | 3 | 230 | A | A | Inv. |
| 13 | 4 | 2 | UV-2 | 1, 2 | 230 | B | B | Inv. |
| 14 | 4 | 1 | UV-2 | 1, 2 | 230 | A | A | Inv. |
| 15 | 4 | 1 | UV-2/3 | 1 | 230 | A | A | Inv. |
| 16 | 5 | 1 | UV-2 | 1 | 230 | A | A | Inv. |
| 17 | 5 | 1 | UV-2/3 | 1 | 230 | A | A | Inv. |
| 18 | 3 | 1 | UV-2 | 1, 4 | 240 | A | B | Inv. |
| 19 | 3 | 1 | UV-2/4 | 1 | 230 | B | B | Inv. |
| 20 | 3 | 1 | UV-2/5 | 1 | 230 | B | B | Inv. |
| 21 | 3 | 1 | UV-3/4 | 1 | 230 | A | A | Inv. |
| 22 | 3 | 1 | UV-3/5 | 1 | 230 | A | A | Inv. |
| 23 | 3 | 1 | UV-4/5 | 1 | 230 | B | B | Inv. |
| 24 | 3 | 1 | UV-4 | 1 | 230 | B | B | Inv. |
| 25 | 3 | 1 | UV-5 | 1 | 230 | B | B | Inv. |
| 26 | 3 | 1 | UV-6 | 1 | 230 | B | B | Inv. |
| 27 | 3 | 1 | UV-3/6 | 1 | 230 | A | A | Inv. |
| 28 | 3 | 1 | UV-4/6 | 1 | 230 | B | B | Inv. |
| 29 | 3 | 1 | UV-5/6 | 1 | 230 | B | B | Inv. |

Comp.: Comparative Example,
Inv.: Present Invention

It is found that Optical Films 7-29 of the present invention resulted in more desired haze and white unevenness than Comparative Examples.

Further, it is found that Optical Films 10 and 13 of the present invention, in which triphenyl phosphate was employed as a phosphoric acid ester based plasticizer, resulted in slight degradation of the effects of the present invention.

### Example 2

<<Preparation of Polarizing Plates>>

Antireflection Films 1-17 and 19-29 coated with a hard coating layer were prepared by applying a hard coating layer and an antireflection layer onto one side of Optical Films 1-17 and 19-29 prepared in. Example 1. Subsequently, by employing those, Polarizing Plates 1-17 and 19-29 were prepared.

<Hard Coating Layer>

The hard coating layer composition describe below was applied onto each of Antireflection Films 1-17 and 19-29 to result in a dried layer thickness of 5 μm and subsequently dried at 80° C. for one minute. Subsequently, Curing was conducted at the condition of 150 mJ/cm² employing a high pressure mercury lamp, whereby a hard coating film incorporating a hard coating layer was prepared. The refractive index of the hard coating layer was 1.50.

<Hard Coating layer Composition (C-1)>

| | | |
|---|---|---|
| Dipentaerythritol hexaacrylate | 108 | parts by weight |
| (incorporating approximately 20 | | |
| percent of polymers greater than | | |
| dimmers) | | |
| IRUGACURE 184 (produced by Ciba | 2 | parts by weight |
| Specialty Chemicals Co., Ltd.) | | |
| Propylene glycol monomethyl ether | 180 | parts by weight |
| Ethyl acetate | 120 | part by weight |

<Medium Refractive Index Layer>

The medium refractive index layer composition, described below, was applied onto the hard coating layer of the above hard coating film, employing an extrusion coater and subsequently dried at conditions of 80° C. and 0.1 m/second for one minute. Until finger touch drying completion (such a state that a finger touch results in completion of drying), a non-contact floater was employed. Employed as a non-contact floater was a horizontal floater type air tambar, produced by Bellmatic Co. The star tic pressure in the floater was maintained at 9.8 kPa and conveyance was performed via uniform floating up by approximately 2 mm in the width direction. After drying, curing was performed via exposure to an ultraviolet radiation of 130 mJ/cm² employing a high pressure mercury lamp (80 W), whereby a medium refractive index film exhibiting a medium refractive index was prepared. The thickness and refractive index of the medium refractive index layer of the resulting medium refractive index film were 84 nm and 1.66, respectively.

<Medium Refractive Index Layer Composition>

| | |
|---|---|
| 20% minute ITO particle dispersion (an average particle | 100 g |
| dimmer of 70 nm and an isopropyl alcohol solution) | |
| Dipentaerythritol hexaacrylate | 6.4 g |
| IRUGACURE 184 (produced by Ciba Specialty Chemicals | 1.6 g |
| Co., Ltd.) | |
| Tetrabutoxytitanium | 4.0 g |
| 10% FZ-2207 (a propylene glycol monomethyl ether | 3.0 g |
| solution) | |
| Isopropyl alcohol | 530 g |
| Methyl ethyl ketone | 90 g |
| Propylene glycol monomethyl ether | 265 g |

<High Refractive Index Layer>

The high refractive index layer composition, described below, was applied onto the above medium refractive index layer employing an extrusion coater and subsequently dried at conditions of 80° C. and 0.1 m/second for one minute. During this operation, until finger touch drying completion (such a state that a finger touch results in completion of drying), a non-contact floater was employed. The conditions of the non-contact floater were set to be the same as for the formation of the medium refractive index layer. After drying, curing was performed via exposure to an ultraviolet radiation of 130 mJ/cm² employing a high pressure mercury lamp (80 W), whereby a high refractive index film incorporating a high refractive index layer was prepared.

<High Refractive Index Layer Composition>

| | | |
|---|---|---|
| Tetrabutoxytitanium | 95 | parts by weight |
| Dimethylpolysiloxane (KF-96-1000CS, | 1 | part by weight |
| produced by Shin-Etstu Chemical Co., Ltd.) | | |
| γ-methacryloxypropyltrimethoxysilane | 5 | parts by weight |
| (KBM503, produced by Shin-Etsu Chemical | | |
| Co., Ltd.) | | |
| Propylene glycol monomethyl ether | 1750 | parts by weight |
| Isopropyl alcohol | 3450 | parts by weight |
| Methyl ethyl ketone | 600 | parts by weight |

Incidentally, the thickness and refractive index of the refractive index layer of the resulting high refractive index film were 50 μm and 1.82, respectively.

<Low Refractive Index Layer>

At first, minute silica based particles (hollow particles) were prepared.

(Preparation of Minute Silica Based Particles P-1)

A mixture of 100 g of an average particle diameter 5 nm silica sol at a SiO₂ concentration of 20 percent by weight and 1,900 g of pure water was heated to 80° C. The pH of the above reaction mother liquid composition was 10.5. Simultaneously added to the above composition were 9,000 g of a 98 percent by weight aqueous sodium silicate solution as SiO₂ and 9,000 g of a 1.02 percent by weight aqueous sodium aluminate solution as Al₂O₃. During the above addition, the temperature of the reaction liquid composition was-maintained at 80° C. The pH of the above reaction liquid composition increased to 12.5 immediately after the above addition and resulted in almost no variation thereafter. After the addition, the reaction liquid composition was cooled to room temperature and washed employing an ultrafiltration membrane, whereby a solid concentration 20 percent by weight SiO₂.Al₂O₃ nucleolus particle dispersion was prepared (Process (a)).

Added to the resulting nucleolus particle dispersion was 1,700 g of pure water, and the resulting mixture was heated to 98° C. Whiled maintaining the above temperature, added was 3,000 g of a silicic acid solution (at a SiO₂ concentration of 3.5 percent by weight) which was prepared by dealkalizing an aqueous sodium silicate solution employing an cation exchange resins, whereby a nucleolus particle dispersion, which had been subjected to the formation of the first silica coating layer, was obtained (Process (b)).

Subsequently, added to 500 g of the nucleolus particle dispersion which had formed the fist silica coating layer which had been washed employing an ultrafiltration membrane to result in a solid concentration of 13 percent by weight was 1125 g of pure water. Further, the pH of the resulting mixture was adjusted to 1.0 by dripping concentrated hydrochloric acid (at 35.5 percent) and a treatment to remove aluminum was then performed. While adding 10 L of a hydrochloric acid solution at a pH of 3 and 5 L of pure water, the dissolved aluminum salts were separated employing an ultrafiltration membrane, whereby a SiO₂.Al₂O₃ porous particle dispersion, in which a part of the components forming the first silica coating layer constituting had been removed, was prepared (Process (c)). After heating to 35° C. a mixture of 1,500 g of the above porous particle dispersion, 500 g of pure water, 1,750 g of ethanol, and 626 g of ammonia water, 104 g of ethyl silicate (at 28 percent by weight of SiO₂) was added, whereby the second silica coating layer was formed in such a manner that the surface of the porous particles which had formed the first silica coating layer was coated with the hydrolysis polycondensation products of ethyl silicate. Subsequently, the solvents were replaced with ethanol employing an ultrafiltration membrane, whereby a minute silica based particle dispersion at a solid concentration of 10 percent by weight was prepared.

Table 2 shows the thickness of the first silica coating layer, average particle diameter, MOₓ/SiO₂ (at a mol ratio) and refractive index of the above minute silica based particles. The average particle diameter was determined employing a dynamic light scattering method. The refractive index was determined employing the method below, while employing Series A, and AA, produced by CARGILL as a standard refractive liquid.

<Determination Method of Refractive Index of Particles>

(1) A particle dispersion was placed in an evaporator and the dispersion media are vaporized.
(2) The resulting materilas were dried and pulverized to powder.
(3) A few droplets of a refractive index known standard refractive liquid were dripped onto a glass plate, with which the above powder was mixed.

(4) The above (3) operation was performed employing various types of standard refractive liquid. When a mixture became transparent, the refractive index of the standard refractive liquid was designated as refractive index of the colloid particles.

TABLE 2

| | Nucleolus Particle | | Silica Coating Layer | | | Minute Silica Based Particles | | |
|---|---|---|---|---|---|---|---|---|
| | | MOₓ/SiO₂ | First Layer | Second Layer | Outer Shell | MOₓ/SiO₂ | Average Particle | Refractive |
| No. | Type | mol ratio | Thickness (nm) | Thickness (nm) | Thickness (nm) | mol ratio | Diameter (nm) | Index |
| P-1 | Al/Si | 0.5 | 3 | 5 | 8 | 0.0017 | 47 | 1.28 |

(Formation of Low Refractive Index Layer)

Added to a matrix prepared by mixing 95 mol percent of Si(OC₂H₅) and 5 mol percent of C₃F₇—(OC₃F₆)₂₄—O—(CF₂)₂—C₂H₄—O—CH₂Si(OCH₃)₃ was 35 percent by weight of aforesaid Minute Silica Based Particles P-1 at an average particle diameter of 60 nm. Subsequently, a low refractive index coating composition was prepared in such a manner that employing 1.0 N HCl as a catalyst, the above particles were diluted employing solvents. The liquid coating composition was applied onto the foresaid actinic radiation curable resinous layer or high refractive index layer at a coating thickness of 100 nm, employing a die coating method. After drying at 120° C. for one minute, ultraviolet radiation was exposed, whereby a low refractive index layer at a refractive index of 1.37 was formed.

Antireflection Films 1-17 and 19-29 were prepared as described above.

Subsequently, a 120 μm thick polyvinyl alcohol film was subjected to uniaxial stretching (at 110° C. and at a factor of 5). The resulting film was immersed for 60 seconds in an aqueous solution consisting of 0.075 g of iodine, 5 g of potassium iodide, and 100 g of water and subsequently immersed in an aqueous solution consisting of potassium iodide and 7.5 g of boric acid, and 100 g of water at 68° C. The resulting film was washed with water and dried whereby a polarizing film was obtained.

Thereafter, in accordant with Processes 1-5 described below, a polarizing plate was prepared by allowing the polarizing film, each of-above Antireflection Films 1-17 and 19-29, and the cellulose ester film on the reverse side to adhere to each other Konica Minolta TAC KC8UCR-4 (produced by Konica Minolta Opto, Inc.) which was a commercially available cellulose ester film was used as a polarizing plate protective film on the reverse side. The resulting plates were designated as Polarizing Plates 1-17 and 19-29.

Process 1: A film was immersed in a 2 mol/L sodium hydroxide solution at 60° C. for 90 seconds, washed with water and subsequently dried, whereby the above antireflection film which underwent saponification on the side which was allowed to adhere to a polarizer was obtained.
Process 2: The above polarizing film was immersed in a 2 percent by weight solid polyvinyl alcohol adhesive tank for 1-2 seconds.
Process 3: The adhesive which was allowed to excessively adhere to the polarizing film was softly wiped off, and the resulting film was piled on the optical film processed in Process 1 and laminated.
Process 4: The antireflection film sample, the polarizing film, and the cellulose ester film, laminated in Process 3, were allowed to adhere to each other at a pressure 20-30 N/cm² and a conveying rate of approximately 2 m/minute.
Process 5: The sample which was prepared by allowing the polarizing film, the cellulose ester film and the antireflection film in Process 4 was dried in a drier at 80° C. for two minutes, whereby a polarizing plate was prepared.
   <<Preparation of Liquid Crystal Display Devices>>

A liquid crystal panel to determine a viewing angle was prepared as described below, and characteristics as a liquid crystal display device were evaluated.

Polarizing plates on both sides which had been allowed to adhere to 15 type display VL-150, produced by FUJITSU LTD. were peeled off and each of Polarizing Plates 1-17 and 19-29, prepared as above, was allowed to adhere to the glass surface of the liquid crystal cell.

During the above operation, the adhesion of the resulting polarizing plate was performed in such a manner that the plane of the above antireflection film was on the viewing plane side of the liquid crystal and the absorption axis is directed to the same direction as that of the previously adhered polarizing plate, whereby each Liquid Crystal Display Devices 1-17 and 19-29 was produced.

(Evaluation)

<Uneven Hardness>

Employing different hardness pencils, a hardness test was performed at a load of 1 kg, based on the test method described in JIS K 5400. Each of the antireflection films was subjected to 10-division in the width direction. At each division, the pencil harness was determined and evaluated based on the criteria below.
A: no uneven hardness was noted on the surface
B: slight uneven hardness was noted on the surface
C: uneven hardness was somewhat noted on the surface
D: uneven hardness was clearly noted
   <Line-shaped Defects>

Line-shaped defects generated at the edge portions across the width of the antireflection film was visually evaluated as described below.
A: no line-shaped defects at a length of at least 100 m in the longitudinal direction were visually noted
B: weak line-shaped defects were noted at every several 10 m in the portion about 10 cm from the edge
C: line-shaped defects were intermittently noted in the portion 10 cm from the edge
D: marked line-shaped defects was intermittently noted in the portion 10 cm from the edge.
   <Evaluation of Visibility>

Each liquid crystal display device, prepared as above was allowed to stand at 60° C. and 90% RH for 100 hours and the ambience was returned to 23° C. and 55% RH. When the surface of the display device was observed, it was found that the devices employing the antireflection film of the present invention exhibited excellent flatness. On the other hand, minute wavy unevenness was noted on the comparative polarizing plates, whereby eyes tended to be tired.
A: no wavy unevenness was noted on the surface
B: slight wavy unevenness was noted on the surface
C: minute wavy unevenness was somewhat noted
D: minute wavy unevenness was noted on the surface
   <Evaluation of Reflection Color Unevenness>

In each liquid crystal device, the image area was subjected to black display, and the surface reflection color unevenness was evaluated.
A: no color unevenness of reflected light was noted and black was crisp
B: slight color unevenness of reflected light was noted
C: color unevenness of reflected light was noted, however Resulting in no problems for commercial viability
D: color unevenness of reflected light was fairly annoying

Table 3 shows the results.

TABLE 3

| Antireflection | Uneven | Line-Shaped | Polarizing Plate/Liquid | | Reflection | |
|---|---|---|---|---|---|---|
| Film No. | Hardness | Defect | Crystal Display Device No. | Visibility | Color Unevenness | Remarks |
| 1 | D | D | 1 | D | D | Comp. |
| 2 | C | C | 2 | C | C | Comp. |
| 3 | D | D | 3 | D | D | Comp. |
| 4 | D | D | 4 | D | D | Comp. |
| 5 | C | C | 5 | C | C | Comp. |
| 6 | C | C | 6 | C | C | Comp. |
| 7 | A | A | 7 | A | A | Inv. |
| 8 | A | A | 8 | A | A | Inv. |
| 9 | A | A | 9 | A | A | Inv. |
| 10 | B | B | 10 | B | B | Inv. |
| 11 | A | A | 11 | A | A | Inv. |
| 12 | A | A | 12 | A | A | Inv. |
| 13 | B | B | 13 | B | B | Inv. |
| 14 | A | A | 14 | A | A | Inv. |
| 15 | A | A | 15 | A | A | Inv. |
| 16 | A | A | 16 | A | A | Inv. |
| 17 | A | A | 17 | A | A | Inv. |
| 19 | B | B | 19 | B | B | Inv. |
| 20 | B | B | 20 | B | B | Inv. |
| 21 | A | A | 21 | A | A | Inv. |
| 22 | A | A | 22 | A | A | Inv. |
| 23 | B | B | 23 | B | B | Inv. |
| 24 | B | B | 24 | B | B | Inv. |
| 25 | B | B | 25 | B | B | Inv. |
| 26 | B | B | 26 | B | B | Inv. |
| 27 | A | A | 27 | A | A | Inv. |
| 28 | B | B | 28 | B | B | Inv. |
| 29 | B | B | 29 | B | B | Inv. |

Comp.: Comparative Example,
Inv.: Present Invention

Antireflection Films 7-17 and 19-29 of the present invention resulted in minimal uneven hardness and minimal line-shaped defects, and the polarizing plates and liquid crystal display devices using the same resulted in no problems of reflection color unevenness and exhibited excellent visibility.

### Example 3

A polarizing plate and a liquid crystal display device were prepared in the same manner as above, except that instead of KONICA MINOLTA TAC KC8UCR-4 (produced by Konica Minolta Opto, Inc.) which was the polarizing plate protective film on the reverse surface side employed in Example 2, Optical Film 18 was employed as the polarizing plate protective film on the reverse surface side, whereby Example 2 was reproduced, and it was confirmed that the polarizing plate and liquid crystal display device employing the optical film and antireflection film having the constitution of the present invention resulted in no problems of reflection color unevenness and exhibited excellent visibility.

### Example 4

Optical Films 30-35 were prepared in the same manner as Optical Film 22 in Example 1, except that as described in Table 4, 10 parts by weight of Plasticizer 1 were replaced with combinations of Plasticizers 3, 4, 5, and 1. The antireflection layer in Example 2 was applied onto each of these, whereby Antireflection Films 30-35 were prepared. Subsequently, employing the resulting antireflection film, Polarizing Plates 30-35 and Liquid Cryptal Display Devices 30-35 were prepared and were evaluated in the same manner as Examples 1 ad 2.

Incidentally, in cases in which Plasticizers 3, 4, and 5 were employed, the total added amount of each of the plasticizers was controlled to 12 parts by weight with respect to 90 parts by weight of the cellulose resins, while in the cases in which plasticizers were employed in combination, the ratio was controlled to 1:1.

TABLE 4

| Optical | Cellulose | Plasticizer | UV Absorbent | Additive | Melt Temperature | | White | |
|---|---|---|---|---|---|---|---|---|
| Film No. | Resin No. | No. | No. | No. | (° C.) | Haze | Unevenness | Remarks |
| 30 | 3 | 3 | UV-3/5 | 1 | 230 | A | A | Inv. |
| 31 | 3 | 4 | UV-3/5 | 1 | 230 | A | A | Inv. |
| 32 | 3 | 5 | UV-3/5 | 1 | 230 | A | A | Inv. |
| 33 | 3 | 1/3 | UV-3/5 | 1 | 230 | A | A | Inv. |
| 34 | 3 | 1/4 | UV-3/5 | 1 | 230 | A | A | Inv. |
| 35 | 3 | 1/5 | UV-3/5 | 1 | 230 | A | A | Inv. |

Inv.: Present Invention

TABLE 5

| Antireflection | Uneven | Line-shaped | Polarizing Plate/Liquid | | Reflection | |
|---|---|---|---|---|---|---|
| Film No. | Hardness | Defect | Crystal Display Device No. | Visibility | Color Unevenness | Remarks |
| 30 | A | A | 30 | A | A | Inv. |
| 31 | A | A | 31 | A | A | Inv. |
| 32 | A | A | 32 | A | A | Inv. |
| 33 | A | A | 33 | A | A | Inv. |
| 34 | A | A | 34 | A | A | Inv. |
| 35 | A | A | 35 | A | A | Inv. |

Inv.: Present Invention

Based on the evaluation results, it was confirmed that Optical Films 30-35 of the present invention resulted in minimal white unevenness, Antireflection Films 30-35 also resulted in minimal uneven hardness and minimal line-shaped defect, and the polarizing plates and liquid crystal display devices using thereof resulted in no problems of reflection color unevenness and exhibited excellent visibility.

What is claimed is:

1. A method for producing an optical film comprising steps of
mixing a heated and molten cellulose ester having an acylated degree of from 2.5 to 2.9 and at least one of a UV absorbent having at least two benzotriazole skeletons and a UV absorbent having a weight average molecular weight of from 2,000 to 50,000 to form a mixture, and extruding the mixture to form a film.

2. The method for producing an optical film of claim 1, wherein the UV absorbent having at least two benzotriazole skeletons is a compound represented by the following Formula 1.

3. The method for producing an optical film of claim 1, wherein the UV absorbent having a weight average molecular weight of from 2,000 to 50,000 has a repeating unit represented by the following Formula 2.

4. The method for producing an optical film of claim 1, wherein the mixture further contains a plasticizer selected from the group consisting of a poly-valent alcohol type plasticizer, a polyester type plasticizer, a citrate type plasticizer and a phthalate type plasticizer.

5. An optical film produced by the method of claim 1.

6. A polarizing plate, wherein the optical film of claim 5 is employed on at least one side of a polarizing element.

7. An optical film having a hard-coating layer comprising the optical film of claim 5 on which an active radiation hardenable layer is provided.

8. An optical film having an antireflection layer comprising the optical film of claim 5 on which an antireflection layer.

9. A displaying apparatus in which the optical film of claim 5 is employed.
